(19) United States
(12) Patent Application Publication
(10) Pub. No.: US 2025/0392922 A1
(43) Pub. Date: Dec. 25, 2025

(54) METHODS AND APPARATUS FOR WIRELESS NETWORK BASE STATION CATEGORIZATION AND PARAMETER PROFILING

(71) Applicant: Charter Communications Operating, LLC, St. Louis, MO (US)

(72) Inventors: Pareshkumar Panchal, Highlands Ranch, CO (US); Muhib T. Oduwaiye, Aurora, CO (US)

(21) Appl. No.: 18/752,202

(22) Filed: Jun. 24, 2024

(51) Int. Cl. H04W 24/02; H04W 16/18

(52) U.S. Cl. CPC H04W 24/02; H04W 16/18

(57) ABSTRACT

The present invention relates to methods and apparatus for determining wireless base station configuration parameters. An exemplary method includes the steps of: determining a wireless base station type or a wireless base station coverage area type for a first wireless base station based on geographical information corresponding to a coverage area of the first wireless base station; determining a set of operational configuration parameters for the first wireless base station based on the determined wireless base station type or the wireless base station coverage area type; and configuring the first wireless base station using the determined set of operational configuration parameters. In various embodiments, the set of operational configuration parameters is determined from a plurality of sets of operational configuration parameters.

### FIELD OF INVENTION

The present invention relates to methods and apparatus for determining and/or categorizing types of wireless base station(s) and/or configuring wireless base station(s) using wireless base station type parameter profiles. The present invention also relates to methods and apparatus for utilizing geographical information and/or user equipment information corresponding to a wireless base station's coverage area in determining and/or categorizing the wireless base station and/or configuring the wireless base station.

### BACKGROUND OF THE INVENTION

In any given wireless network, performance and/or spectral efficiency depends on, among other things, the locations of the wireless base stations, configuration parameters for the wireless base stations, geography, type of frequencies deployed and/or range of frequencies used by the deployed base stations, integration parameters, and installation quality and conditions. However, the reliability of wireless network communications depends on parameters defined in the network management system (NMS). Usually, these parameters are defined network wide while conditions of the base stations and/or user equipment devices and/or users are ignored. For example, handover parameters defined for a downtown area are not suitable for user equipment devices and base stations located in a rural area due to the type of activity for which the user equipment device is used by its user, movement of the user equipment device, traffic density at the time of user equipment device activity, and location of user equipment devices such as indoor or outdoor or the location with respect to high rise buildings. Similarly, many times base station antenna tilts are kept more or less tilted without logical reason and/or taking into account changes in the environment/surroundings of the base station since installation which lead to poor network performance. Furthermore, trying to manage different configuration parameters for each individual base station of a wireless network can also be very costly and inefficient as it can be problematic from a tracking and management perspective to utilize unique configurations for each base station which is why the same parameters are usually defined network wide while the conditions of the base stations and/or user equipment devices are ignored. Moreover, there are currently no categorization (e.g., dynamic categorizations) and/or base station configuration parameter profiling used by wireless networks for adjusting and/or configuring the wireless base station parameters defined in the NMS of the wireless network based on a base station's determined categorization (e.g., categories based on signaling conditions and/or geographical environmental factors).

From the foregoing, it should be understood that there is a need for new and/or improved methods and apparatus for efficiently and effectively determining and managing the configuration of wireless base stations of a wireless system to improve the wireless base stations and the wireless system's operational performance and spectral efficiency. There is a need for a solution to how to effectively and efficiently solve the problem of configuring wireless base stations of a wireless system while taking into account geographical information and user equipment device information corresponding to the coverage area of a wireless base station. There is a need for new and/or improved methods and apparatus to determine a wireless base station type from a set of wireless base station types based on characteristics and/or properties of the coverage area of the wireless base station and/or wireless device information corresponding to the wireless base station and/or the coverage area of the wireless base station. From the foregoing, it should be understood that there is a need for new and/or improved methods and apparatus for categorizing (e.g., dynamic categorizing) wireless base stations by base station type and/or for use in configuration parameter profiling for adjusting and/or configuring a wireless base station parameters based on a base station's determined categorization (e.g., categories based on signaling conditions, geographical environmental factors, location of wireless devices such as for example user equipment devices being serviced).

### SUMMARY OF THE INVENTION

The present invention provides new and/or improved methods and apparatus for efficiently and effectively determining and managing the configuration of wireless base stations of a wireless system to improve the wireless base stations and the wireless system's operational performance and spectral efficiency. In various embodiments, new and/or improved methods and apparatus are used to determine a wireless base station type from a set of wireless base station types based on characteristics and/or properties of the coverage area of the wireless base station and/or wireless device information corresponding to the wireless base station and/or the coverage area of the wireless base station with the wireless base station type then being used to identify appropriate configuration parameters for the wireless base station. Various embodiments of the present invention provide new and/or improved methods and apparatus for categorizing (e.g., dynamic categorizing) wireless base stations by base station type and then configuring the base stations using a set of configuration parameters which match the determined base station type. In various embodiments, new and/or improved methods and apparatus are provided for base station configuration parameter profiling by type and for adjusting and/or configuring a wireless base station's parameters based on a base station's determined categorization (e.g., categories based on signaling conditions, geographical environmental factors, and/or location of wireless devices such as user equipment devices being serviced). Various embodiments of the present invention also provide new and/or improved methods and apparatus for testing the performance of adjusted base station configurations and determining whether the performance is better or worse since the adjustments. Various embodiments of the present invention provide new and/or improved methods and apparatus for updating wireless base station configurations when environments in which the wireless base station is located change. Various embodiments of the present invention use new and/or improved methods and apparatus for managing a wireless system by utilizing a limited set of base station configuration profiles across all or the majority of base stations of the wireless system to minimize the tracking and management of wireless base stations while still achieving performance advantages over using conventional or uniform configuration parameters for all base stations. Various embodiments of the present invention solve one or more of the problems discussed above.

The present invention relates to methods and apparatus for determining wireless base station configuration parameters. An exemplary method includes the steps of: determining a wireless base station type or a wireless base station coverage area type for a first wireless base station based on geographical information corresponding to a coverage area of the first wireless base station; determining a set of operational configuration parameters for the first wireless base station based on the determined wireless base station type or the wireless base station coverage area type; and configuring the first wireless base station using the determined set of operational configuration parameters. In various embodiments, the set of operational configuration parameters is determined from a plurality of sets of operational configuration parameters. The operational configuration parameters included in each set of operational configuration parameters may, but need not, include all of the configuration parameters for a wireless base station. For example, it can include cell reselection/handoff parameters and base station transmit power parameters while not including antenna tilt parameters.

In some embodiments, the geographical information includes clutter information corresponding to the coverage area of the first wireless base station, said clutter information including terrain information (e.g., elevation and type of terrain such open land, dessert, forest, trees, vegetation, water bodies (e.g., rivers, lakes, streams, ocean), farmland, cliffs, rangeland, snow, ice, etc.) and infrastructure information (e.g., information (e.g., dimensions and/or materials from which infrastructure constructed) on buildings, water towers, bridges, dams, canals, walls, roads, highways, street lamps, etc. located in the coverage area).

In some embodiments, the geographical information includes clutter information corresponding to the coverage area of the first wireless base station, said clutter information including information identifying different locations within the coverage area (e.g., different portions of the coverage area) as corresponding to a particular clutter type from a plurality of clutter types. In some such embodiments, the step of determining a wireless base station type for a first wireless base station based on geographical information corresponding to the coverage area of the first wireless base station includes: using the information identifying different locations within the coverage area as corresponding to a particular clutter type from a plurality of clutter types to determine the wireless base station type from a set of wireless base station types.

In some embodiments, the step of determining a wireless base station type for a first wireless base station based on geographical information corresponding to a coverage area of the first wireless base station includes: categorizing the coverage area of the first wireless base station based on the geographical information corresponding to the coverage area of the first wireless base station. In some such embodiments, the method further includes the additional step of determining the first wireless base station type based on the results of the categorization of the coverage area of the first wireless base station.

In some embodiments, the step or operation of categorizing the coverage area of the first wireless base station based on geographical information corresponding to the coverage area of the first wireless base station includes: determining a category from a set of categories to which the coverage area of the first wireless base station belongs, said set of categories including: urban category, suburban category, and rural category.

In some embodiments, the step of determining the wireless base station type for the first wireless base station based on geographical information corresponding to the coverage area of the first wireless base station includes: determining the wireless base station type from a set of wireless base station types, said set of wireless base station types including the following types: urban type, suburban type and rural type.

In some embodiments, the step of determining the wireless base station type for the first wireless base station is further based on wireless device information corresponding to the coverage area of the first wireless base station. The wireless device information may, and in some embodiments does, include location information identifying the location of wireless devices within the coverage area of the first wireless base station.

In some embodiments, the step of determining the wireless base station type for the first wireless base station based on wireless device information corresponding to the coverage area of the first wireless base station includes: (i) determining a percentage or a number of wireless devices being serviced by the first wireless base station that are located inside of a building; and (ii) determining a percentage or a number of the wireless devices being serviced by the first wireless base station which are not located within a building.

In some embodiments, the step of determining the wireless base station type for the first wireless base station based on geographical information corresponding to the coverage area of the first wireless base station and further based on wireless device information includes: determining the wireless base station type from a set of wireless base station types, said set of wireless base station types including the following types: urban with predominately outdoor users type, urban with predominately indoor users type, suburban with predominately outdoor users type, suburban with predominately indoor users type, rural with predominately outdoor users type, and rural with predominately indoor users type.

In some embodiments, the urban with predominately outdoor users wireless base station type corresponds to a base station with a coverage area wherein a majority of the highest number of wireless devices (e.g., user equipment devices (UEs)) being serviced by the wireless base station are located in an urban area and are not located within one or more buildings. In some embodiments, the urban with predominately indoor users wireless base station type corresponds to a base station with a coverage area wherein a majority of the highest number of wireless devices (e.g., UEs) being serviced by the wireless base station are located in an urban area and are located within one or more buildings. In some embodiments, the suburban with predominately outdoor users wireless base station type corresponds to a base station with a coverage area wherein a majority of the highest number of wireless devices (e.g., UEs) being serviced by the wireless base station are located in a suburban area and are not located within one or more buildings. In some embodiments, the suburban with predominately indoor users wireless base station type corresponds to a base station with a coverage area wherein a majority of the highest number of wireless devices (e.g., UEs) being serviced by the wireless base station are located in a suburban area and are located within one or more buildings. In some embodiments, the rural with predominately outdoor users wireless base station type corresponds to a base station with a coverage area wherein a majority of the highest number of wireless devices (e.g., UEs) being serviced by the wireless base station are located in a rural area and are not located within one or more buildings. In some embodiments, the rural with predominately indoor users wireless base station type corresponds to a base station with a coverage area wherein a majority of the highest number of wireless devices (e.g., UEs) being serviced by the wireless base station are located in a rural area and are located within one or more buildings.

In some embodiments, the determined set of operational configuration parameters include one or more of the following: maximum base station transmit power level parameter, a maximum user equipment device transmit power level parameter, cell reselection parameters, handover parameters, and a wireless base station antenna tilt parameter.

In some embodiments, the step of determining a set of operational configuration parameters for the first wireless base station based on the determined wireless base station type includes: determining the set of operational configuration parameters from a plurality of sets of operational configuration parameters.

In some embodiments, the determined set of operational configuration parameters includes at least: handover parameters, said handover parameters including a hysteresis value, a minimum signal strength value, and a signal offset value.

In some embodiments, the step of configuring the first wireless base station using said determined set of operational configuration parameters includes: sending a message to the first wireless base station indicating the first wireless base station is to operate using the determined set of operational configuration parameters.

The present invention is also applicable to apparatus and system embodiments wherein one or more devices implement the steps of the method embodiments. In some apparatus embodiments each of the wireless base station, user equipment devices, network equipment devices, core network system, Operations Support Systems, Network Management System, Performance Parameter Application Server, Decision Tree Server, Performance Data Feedback Collector Server, Planning and GeoData Server, Statistical Calculation Server, and each of the other apparatus/devices/nodes/servers of the system include one or more processors and/or hardware circuitry, input/output interfaces including receivers and transmitters, and a memory. The memory including instructions when executed by one or more of the processors control the apparatus/device/node/server of the system to operate to perform the steps and/or functions of various method embodiments of the invention.

The present invention is also applicable to and includes apparatus and systems such as for example, apparatus and systems that implement the steps and/or functions of the method embodiments. For example, a system in accordance with one embodiment of the present invention includes: memory and a network management server, said network management server including a first processor that controls the network management server to perform the following operations: determining a wireless base station type for a first wireless base station based on geographical information corresponding to a coverage area of the first wireless base station; determining a set of operational configuration parameters for the first wireless base station based on the determined wireless base station type; and configuring the first wireless base station using said determined set of operational configuration parameters.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an exemplary system in accordance with an embodiment of the present invention.

FIG. 2 illustrates a table mapping clutter types into rural, suburban, and urban categories in accordance with an embodiment of the present invention.

FIG. 3 illustrates a flow diagram of an exemplary method in accordance with an embodiment of the present invention.

FIG. 4 illustrates details of an exemplary wireless base station, in accordance with an embodiment of the present invention.

FIG. 5 illustrates details of an exemplary wireless device that is a user equipment device, e.g., a mobile device, cell phone, smartphone, wireless tablet, laptop, wireless notebook, computer with wireless interfaces in accordance with one embodiment of the present invention.

FIG. 6 illustrates details of an exemplary network equipment device, e.g., Operating Service Systems (OSS), Network Management System, Performance Parameter Application Server, Decision Tree Server, Planning and Geodata Server, Statistical Calculation Server, Performance Data Feedback Collector Server, core network system, in accordance with one embodiment of the present invention.

FIG. 7 illustrates an exemplary assembly of components for a wireless base station in accordance with an embodiment of the present invention.

FIG. 8 illustrates an exemplary assembly of components for a user equipment device in accordance with an embodiment of the present invention.

FIG. 9 illustrates an exemplary assembly of components for a network equipment device in accordance with an embodiment of the present invention.

FIG. 10 comprises FIG. 10A, FIG. 10B, FIG. 10C, FIG. 10D, FIG. 10E, and FIG. 10F.

FIG. 10A is the first part of a flowchart of an exemplary method in accordance with an embodiment of the present invention.

FIG. 10B is the second part of a flowchart of an exemplary method in accordance with an embodiment of the present invention.

FIG. 10C is the third part of a flowchart of an exemplary method in accordance with an embodiment of the present invention.

FIG. 10D is the fourth part of a flowchart of an exemplary method in accordance with an embodiment of the present invention.

FIG. 10E is the fifth part of a flowchart of an exemplary method in accordance with an embodiment of the present invention.

FIG. 10F is the sixth part of a flowchart of an exemplary method in accordance with an embodiment of the present invention.

FIG. 11 illustrates a wireless system coverage area map in accordance with an exemplary embodiment of the present invention which includes wireless base station location information, wireless device (e.g., user equipment device) location information and building location information.

FIG. 12 illustrates an exemplary heat map in accordance with an embodiment of the present invention showing wireless base station locations, wireless device (e.g., UE) locations, building locations, and geographical locations classified by clutter properties/types.

FIG. 13 illustrates a legend for the clutter types illustrated on the heat map illustrated in FIG. 12.

FIG. 14 illustrates an exemplary heat map in accordance with an embodiment of the present invention showing wireless base station locations, wireless device (e.g., UE) locations, building locations, and clutter height properties.

FIG. 15 illustrates a legend for the clutter height properties illustrated on the heat map illustrated in FIG. 14.

FIG. 16 illustrates an exemplary heat map in accordance with an embodiment of the present invention showing wireless base station locations, wireless device (e.g., UE) locations and terrain height.

FIG. 17 illustrates a legend for the terrain height properties illustrated on the heat map illustrated in FIG. 16.

FIG. 18 illustrates an exemplary heat map showing coverage area boundaries of the centroid marked base stations with different colors being used for coverage areas of neighboring base stations.

FIG. 19 illustrates an exemplary heat map showing base station coverage area by signal strength.

FIG. 20 illustrates a legend for the signal strength properties illustrated on the heat map illustrated in FIG. 19.

FIG. 21 illustrates exemplary statistical analysis results of base station A1, A2, A3, A4, A5, A6, A7, A8, A9, A10, and A11 by geographical information corresponding to each base station's coverage area (i.e., clutter type) and the determination of each wireless base station's type based on the clutter type information corresponding to each base station's coverage area.

FIG. 22 illustrates exemplary statistical analysis results of base station A1, A2, A3, A4, A5, A6, A7, A8, A9, A10, and A11 by geographical information corresponding to each base station's coverage area (i.e., clutter type) and wireless device information (e.g., wireless device locations within the coverage area) and the determination of each of the wireless base stations type based on the clutter type information corresponding to the base station's coverage area and wireless device location information corresponding to the base station's coverage area.

FIG. 23 illustrates an exemplary table illustrating base station coverage category/type and base station category/type for the base stations described in FIGS. 21 and 22.

FIG. 24 illustrates an exemplary table of non-categorized base station operational parameters (e.g., conventional or uniform base station operational parameters) wherein regardless of a base station's type or the base station's coverage area type the same base station operational configuration parameters are used.

FIG. 25 illustrates an exemplary table of categorized base station operational parameters in accordance with an embodiment of the present invention.

FIG. 26 illustrates another exemplary table of categorized base station operational parameters in accordance with an embodiment of the present invention.

FIG. 27 illustrates another exemplary table of categorized base station operational parameters in accordance with an embodiment of the present invention.

### DETAILED DESCRIPTION

Various embodiments of the present invention include new and/or improved methods, systems, and apparatus for improving the spectral efficiency of a wireless network by updating operational configuration parameters of one or more wireless base stations of a wireless communications system. The term wireless base station and base station are used interchangeably herein.

The selection and/or determination of the operational configuration parameters with which a wireless base station is updated is based on a determination or categorization of the wireless base station by type from a set of wireless base station types (e.g., a set consisting of or including the following types: rural type, suburban type, and urban type). In various embodiments of the invention, radio frequency propagation modeling, base station location and coverage area information, and geographical information (e.g., clutter and terrain information including clutter and terrain maps) are used to determine and/or categorize a wireless base station's type from the types included in the set of base station types (e.g., rural type, suburban type or urban type).

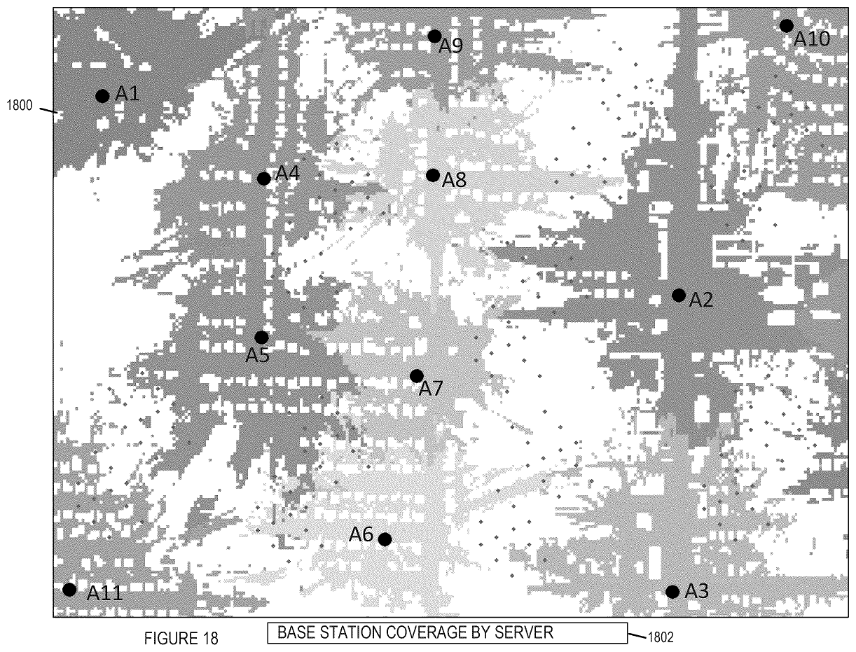

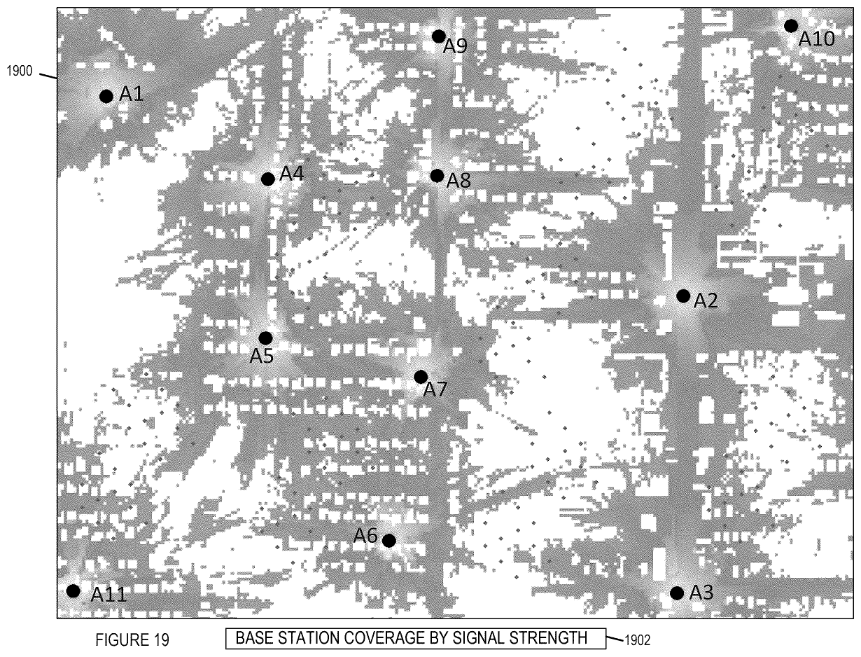

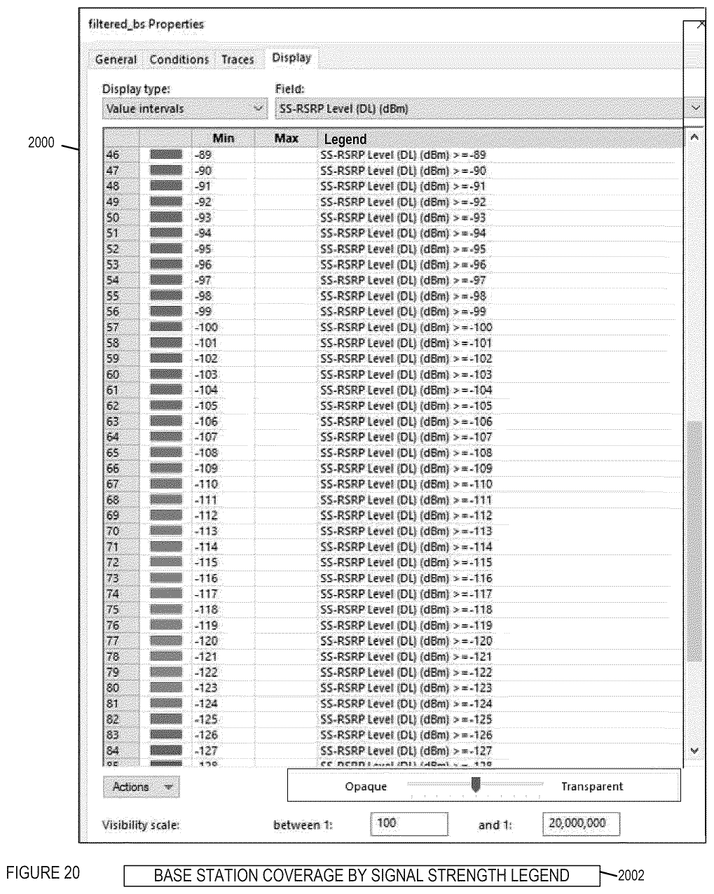

Additionally, in various embodiments, the wireless base station type is further determined using at least some data collected and/or measured and/or generated during the operation of the wireless base station such as for example user equipment device location information reported by user equipment devices and/or signaling information such as for example signal strength information and/or signaling interference information by location reported by the user equipment devices operating in the coverage area. For example, user equipment devices operating within the coverage area of a wireless base station determine their location (e.g., Global Positioning System coordinates) and report the information to a base station of the communications system which forwards it to the network management system of the OSS of the communications system which makes the wireless base station type determination for wireless base stations in the wireless communications system. The user equipment devices also measure and report to the wireless base station signaling metrics information from which signaling strength and interference metrics and information (e.g., Reference Signal Received Power (RSRP) information, Receive Signal Strength Indicator (RSSI) information, Reference Signal Interference Power (RSIP) information, Reference Signal Received Quality (RSRQ) information, Signal-to-Interference-plus-Noise Ratio (SINR) information) can be obtained and/or generated with respect to locations in the wireless coverage area of the base station. Signaling information from one or more of the following may be, and in some embodiments is, used to determine the wireless base station type: RSRP information for the wireless base station's coverage area, RSSI information for the wireless base station's coverage area, RSRQ information, and SINR information for the wireless base station's coverage area. FIG. 18 illustrates an exemplary heat map 1802 showing coverage area boundaries of the centroid marked base stations with different colors being used for coverage areas of neighboring base stations. The title for map 1802 is Base Station Coverage By Server 1802. FIG. 19 illustrates an exemplary heat map 1900 showing base station coverage area by signal strength. The title for the map 1900 is Base Station Coverage By Signal Strength 1902. FIG. 20 illustrates a legend 2000 for the signal strength properties illustrated on the heat map 1900 illustrated in FIG. 19. The title for the legend 2000 is Base Station Coverage By Signal Strength Legend 2002. The title A heat map is a graphical representation of data where values are depicted by color.

The user equipment device reported information including location and signaling information also typically includes timing information indicating when the measurement or information being reported was determined. The timing information can be used to determine signaling coverage maps and user equipment device location maps based not only on location but also time (e.g., time periods) wherein time based metrics can be used in determining a base station's type as well as how changes to a base station's operating parameters affect the overall performance and spectral efficiency of the base station using time based metrics. For example, the OSS may determine that spectral efficiency increases at times during the day when user equipment device activity is low (e.g., at night) but decrease when user activity is high (e.g., during peak commute times (e.g., 7:00 a.m.-9:00 a.m., 5:00 p.m.-7:00 p.m.) or during business hours (e.g., 9:00 a.m.-5:00 p.m.)). This information can then be used to categorize the type of base station (e.g., rural type, suburban type or urban type) based on a time or time period which has the most significant impact on users. In some embodiments, this information can then be used to categorize the type of base station (e.g., rural type, suburban type or urban type) based on a time or time period and dynamically update operational configuration parameters for a base station to increase and/or maximize efficiency (e.g., maximize spectral efficiency, maximize successful completed connections, maximize successfully completed handovers) with respect to time.

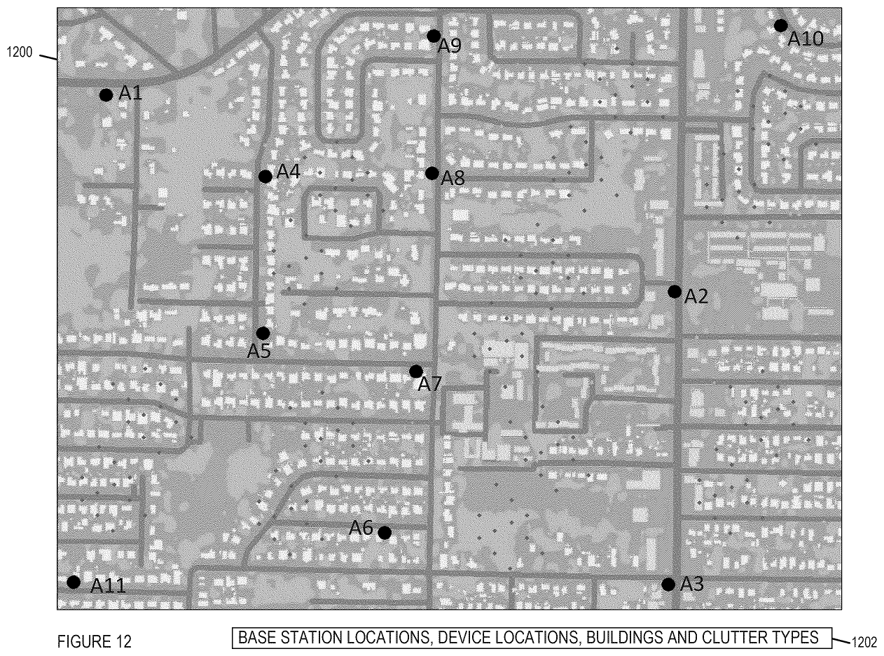

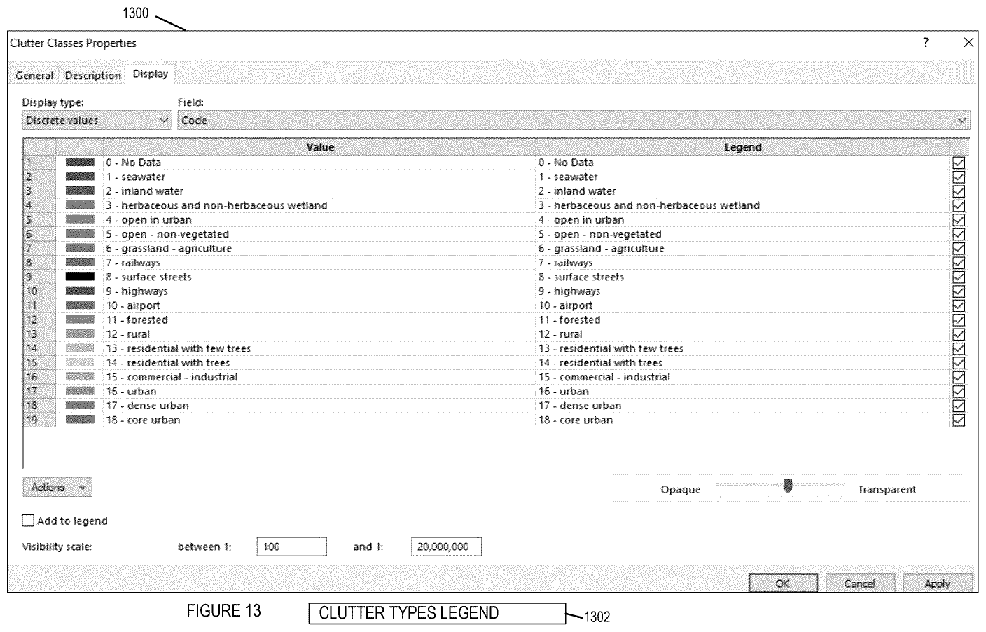

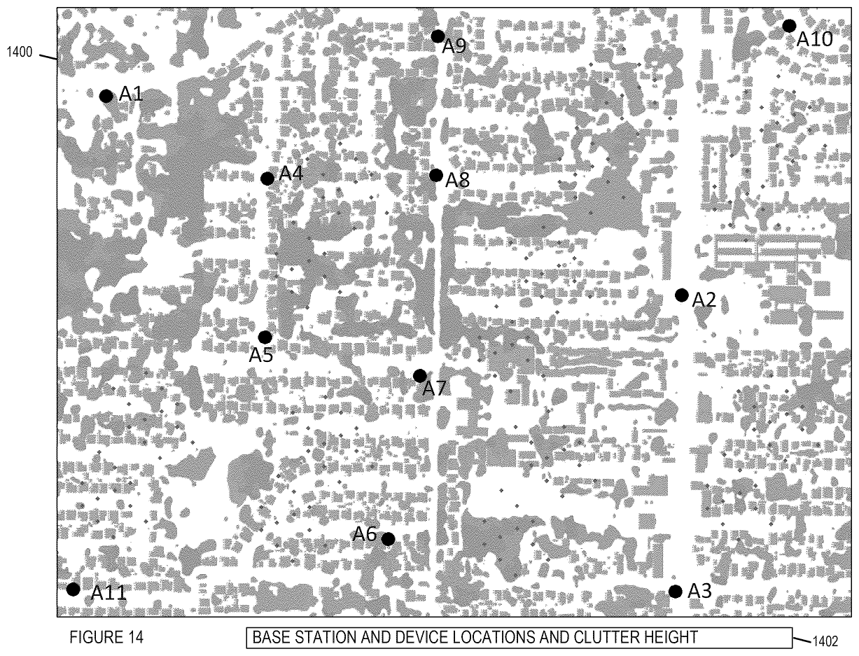

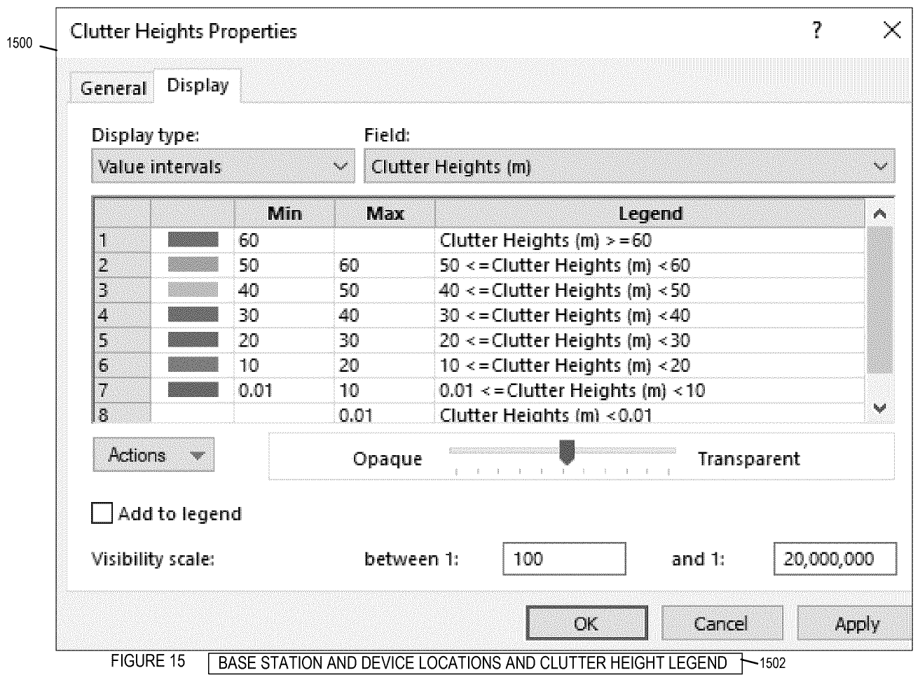

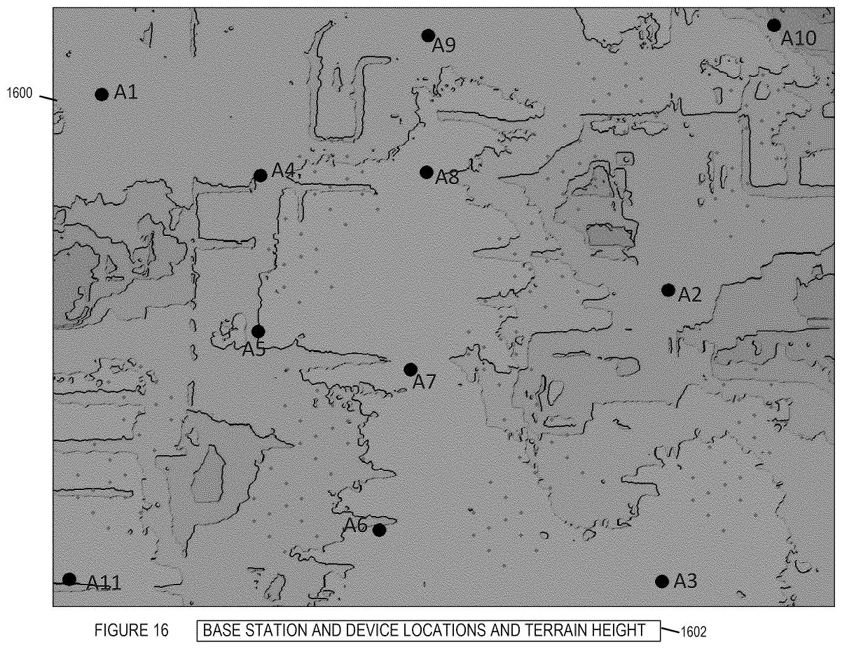

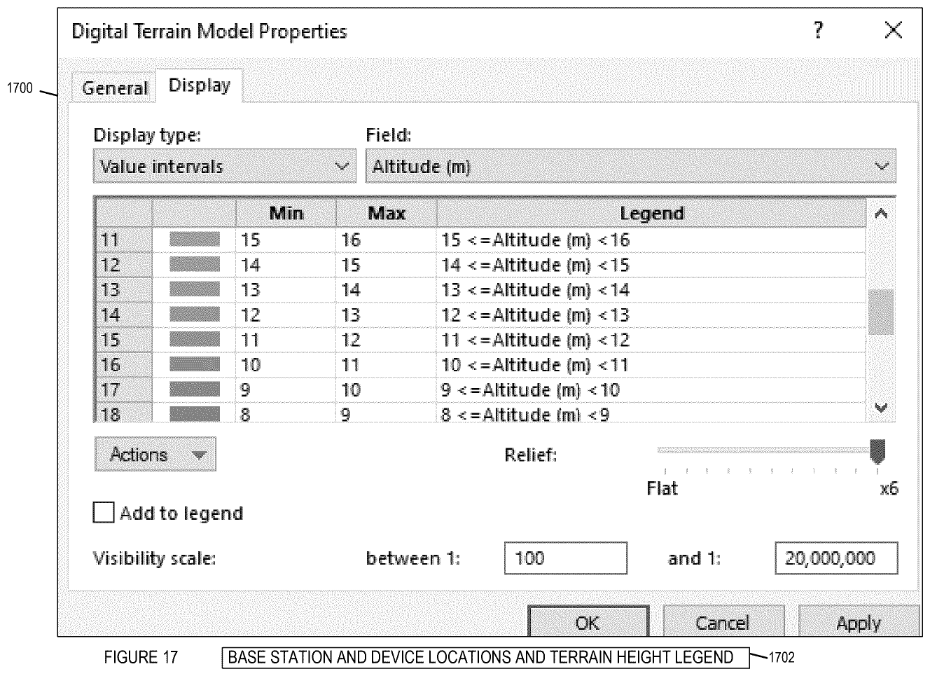

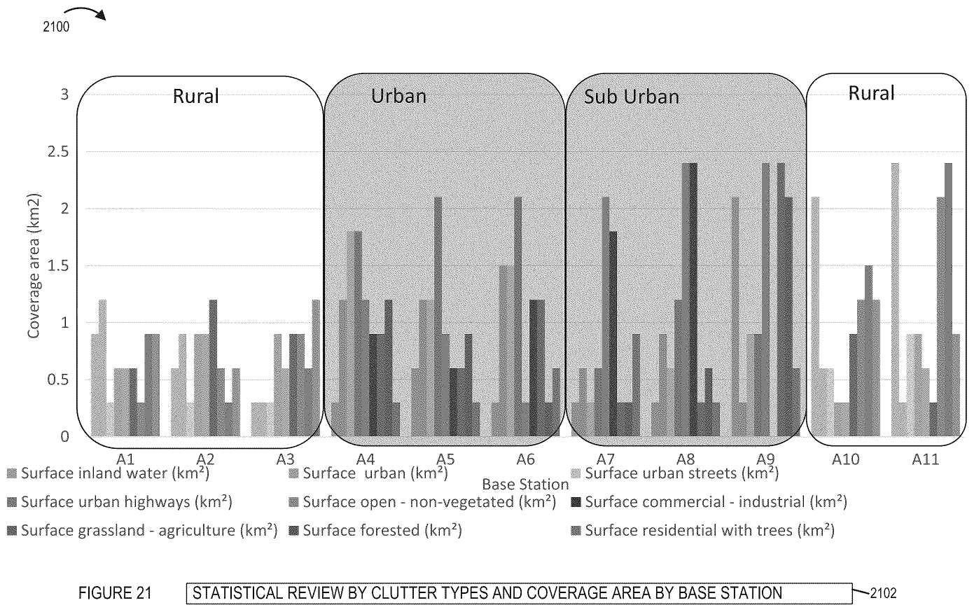

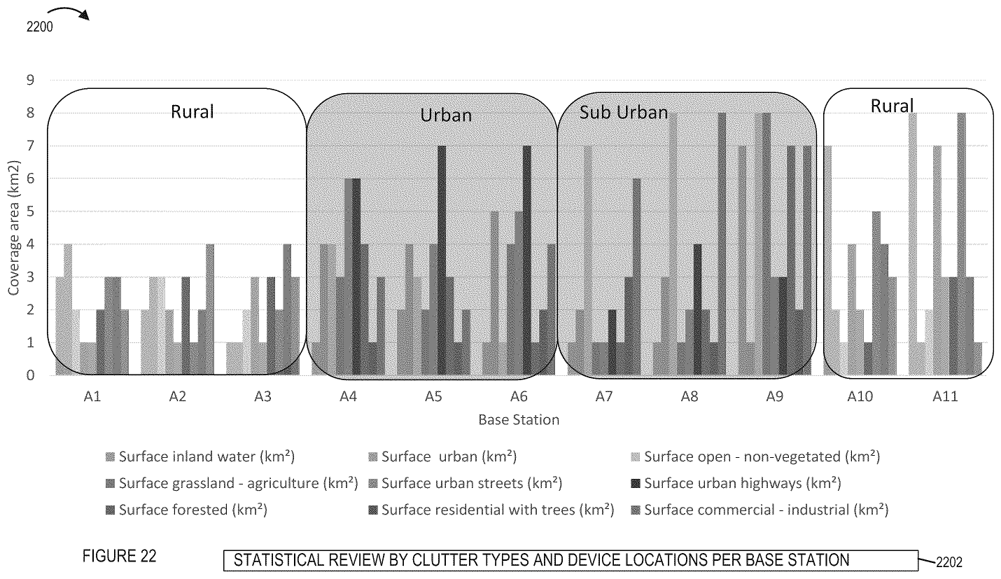

In various embodiments, the wireless base station type is generated based on clutter type information corresponding to different portions of the coverage area of the wireless base station, the density population of the user equipment devices within the different portions of the coverage area of the wireless base station, and signal strength and/or interference information determined for the different portions of the coverage area of the wireless base station (e.g., average or median signal strength (RSRP) determined for the determined portions of the coverage area of the wireless base station). The signal strength of an area such as a portion of a coverage area is in at least some embodiments an indicator of an amount and/or type of clutter in the area. Similarly, in at least some instances the user equipment device density population is an indicator of an amount and/or type(s) of clutter and/or signaling interference with respect to an area. In various embodiments, a wireless base station type for a wireless base station is determined based on a statistical analysis of clutter information for a wireless base station's coverage area (e.g., diagram 2100 of FIG. 21 titled Statistical Review By Clutter Types And Coverage Area By Base Station 2102 illustrates statistical analysis of clutter types for coverage area of wireless base stations A1, A2, A3, A4, A5, A6, A7, A8, A9, A10, and A11 and the determination of each of these base stations types as being of rural type, urban type or suburban type) and/or a statistical analysis of wireless device information such as user equipment device locations within the coverage area and corresponding clutter type for the locations at which user equipment devices are located for the wireless base station (e.g., diagram 2200 of FIG. 22 titled Statistical Review By Clutter Types And Device Locations Per Base Station 2022 illustrates statistical analysis of base station coverage area by clutter types and user device locations in the coverage area of wireless base stations A1, A2, A3, A4, A5, A6, A7, A8, A9, A10, and A11 and the determination of each of these base stations types as being of rural type, urban type or suburban type). The clutter information in various embodiments includes information for different clutter types also referred to as clutter properties. For example, FIG. 13 provides a legend 1300 of different clutter types/properties for the clutter information shown in FIG. 12 map 1200. The clutter information includes geographical information including for example, clutter type information, terrain information, and/or building information for the coverage area of the base station (e.g., for each of the sectors and/or portions of the coverage area). For example, FIG. 15 provides a legend 1500 titled Base Station And Device Locations and Clutter Height Legen 1502 for clutter heights for the heat map 1400 titled Base Station And Device Locations And Clutter Height 1402 shown in FIG. 14. The terrain information may, and in some embodiments does, include the terrain type information and terrain height information. For example, FIG. 17 illustrates a legend 1700 of terrain heights for the terrain height map 1600 illustrated in FIG. 16. The map 1600 is titled Base Station And Device Locations And Terrain Height 1602. The legend 1700 is titled Base Station And Device Locations And Terrain Height Legend 1702. The building information may, and in some embodiments does, include building dimensions (e.g., size and height information) and location information. Additionally, the user equipment device location information may, and in some embodiments does, include information on user equipment devices being located indoors (e.g., inside of buildings) or outdoors (outside of buildings).

In some embodiments, the wireless base station type is determined using base station type scoring wherein the base station type with the highest score is determined base station type. The score for each base station type being generated using numerical values. The base station type score may be, and in some embodiments is, generated by summing a set of weighted attributes and/or features represented in numerical form. The weights being numerical values which indicate the importance of the attribute and/or feature (e.g., a weight value of 0 means the attribute/feature has no importance and should not be considered and a weighted value of 1 means the attribute/feature has the highest importance and should be fully considered and weighted values between 0 and 1 allow for different levels of importance in determining the base station type's score. The set of weighted attributes and/or features for each base station type may include for example the following features: (i) the percentage of base station's coverage area being categorized and/or determined as of a particular clutter type (e.g., urban, suburban, rural), (ii) the percentage of user equipment devices being serviced by the base station located at a position or area categorized as being of a particular clutter type (e.g., urban, suburban, rural), (iii) the percentage of user equipment devices being serviced by the base station being located at position or area categorized as being indoors, or (iv) the percentage of user equipment devices being serviced by the base station being located at position or area categorized as being not indoors or outdoors.

Other attributes and/or features can include: (a) the percentage of the base station's coverage area corresponding to a particular category (e.g., urban, suburban, rural) having an average signaling strength (e.g., Reference Signal Received Power (RSRP) greater than a signal strength threshold value, (b) the percentage of the base station's coverage area corresponding to a particular category (e.g., urban, suburban, rural) that has a signaling interface value below a signal interference threshold value. The numerical values of the attribute and/or feature set may be, and sometimes are, normalized as part of generating the base station type score. As previously discussed each attribute/feature of the attribute/feature set is multiplied by a weighting factor assigned to the attribute/feature based on the features importance in determining the base station type score. The larger the numerical value of the weighting factor assigned to a feature the more important the feature is to determining the base station type score.

Below are an exemplary set of equations for determining a base station type using a base station type scoring method.
BS Type 1 (e.g., BS urban type) Score=W1 (BS feature 1 (e.g., percentage of BS coverage area categorized as type urban))+W2 (BS feature 2) (e.g., percentage of UEs being serviced by the BS located in an area categorized as type urban)+ . . . , +WX (BS feature X) (e.g., percentage of BS wireless traffic occurring with UEs located in area categorized as type urban)
BS Type 2 (e.g., BS suburban type) Score=W1 (BS feature 1 (e.g., percentage of BS coverage area categorized as type suburban))+W2 (BS feature 2) (e.g., percentage of UEs being serviced by the BS located in an area categorized as type suburban)+ . . . , +WX (BS feature X) (e.g., percentage of BS wireless traffic occurring with UEs located in area categorized as type suburban)
. . .
BS Type N (e.g., BS rural type) Score=W1 (BS feature 1 (e.g., percentage of BS coverage area categorized as type rural))+W2 (BS feature 2) (e.g., percentage of UEs being serviced by the BS located in an area categorized as type rural)+ . . . , +WX (BS feature X) (e.g., percentage of BS wireless traffic occurring with UEs located in area categorized as type rural)
Base Station type for a base station is determined as the BS Type with the highest BS type score from the set of BS type scores (BS Type 1, BS Type 2, . . . , BS Type N).
N is a positive integer greater than 2. X is a positive integer greater than 2. W1, W2, . . . , WX are weighting factors for BS attribute 1, BS attribute 2, . . . , BS attribute X. The weighting factors are numerical values with the higher the value the more important the attribute. For example, the value of each weighting factor can be a value of 0 to 1 wherein when the weighting factor value is 0, the attribute is given no weight and when the weighting factor value is 1 it is given full weight.

An exemplary use of the above equations will now be demonstrated to determine a base station type for a base station. N has a value of 3 and X has a value of 3. W1, W2, and W3 are all equal to 1 so that each of the features being considered have equal weights and are equally important. The base station type 1 is urban type. The base station type 2 is suburban type. The base station type 3 is rural type. Feature 1 is the percentage of the base station coverage area which is determined and/or categorized as being the same as the base station type. In this example, the base station's coverage area is determined and/or categorized to be 10% urban, 20% suburban, and 70% rural. Feature 2 is the percentage of UEs being serviced by the base station which are located in an area categorized as being the same type as the base station. In this example, 80% of the UEs are located in an urban area, 15% of the UEs are located in a suburban area, and 5% are located in a rural area. Feature 3 is the percentage of the base stations wireless traffic occurring with UEs located in an area categorized as being the same type as the base station. In this example, 90% of the wireless traffic is occurring with UEs located in an urban area, 9% of the wireless traffic is occurring with UEs located in a suburban area, and 1% of the wireless traffic is occurring with UEs located in a rural area. For ease of calculation the percentages have been multiplied by 100.

Base Station Type Urban Score=(1)(10)+(1)(80)+(1)(90)=180.

Base Station Type Suburban Score=(1)(20)+(1)(15)+(1)(9)=93.

Base Station Type Rural Score=(1)(70)+(1)(5)+(1)(1)=111.

Highest Base Station Type Score is the Base Station Type Urban Score of 180.

The base station's type being determined by the base station type score being the highest from the set of base station type scores which in this example is the urban base station type.

If the weighting factors of the features are changed for example if the W2 weighting factor was set to a value of 0.5 indicating that the percentage of the user equipment devices located by coverage area type is not as important as the per percentage of the coverage area being of the base station's type and the W3 weighting factor is set to a value 0.2 indicating that the traffic feature is even less important to determining the base station type then the equations would be modified as follows:

Base Station Type Urban Score=(1)(10)+(0.5)(80)+(0.2)(90)=68.

Base Station Type Suburban Score=(1)(20)+(0.5)(15)+(0.2)(9)=29.3.

Base Station Type Rural Score=(1)(70)+(0.5)(5)+(1)(0.2)=72.7.

Highest Base Station Type Score is the Base Station Type Rural Score of 72.7.

The base station's type being determined from the base station type score being the highest from the set of base station type scores which, in this example with the changed weighting factors, is the rural base station type.

As demonstrated in the above example, determining a base station type and/or the operational configuration parameters for the base station using a weighted factor scoring method is a flexible and versatile method for taking into account various differing features and/or attributes with the weight factors being used to determine importance for each of the features/attributes being considered. It also allows for the adjustment of the weights for the differing features/attributes when different base station geographical environments are encountered.

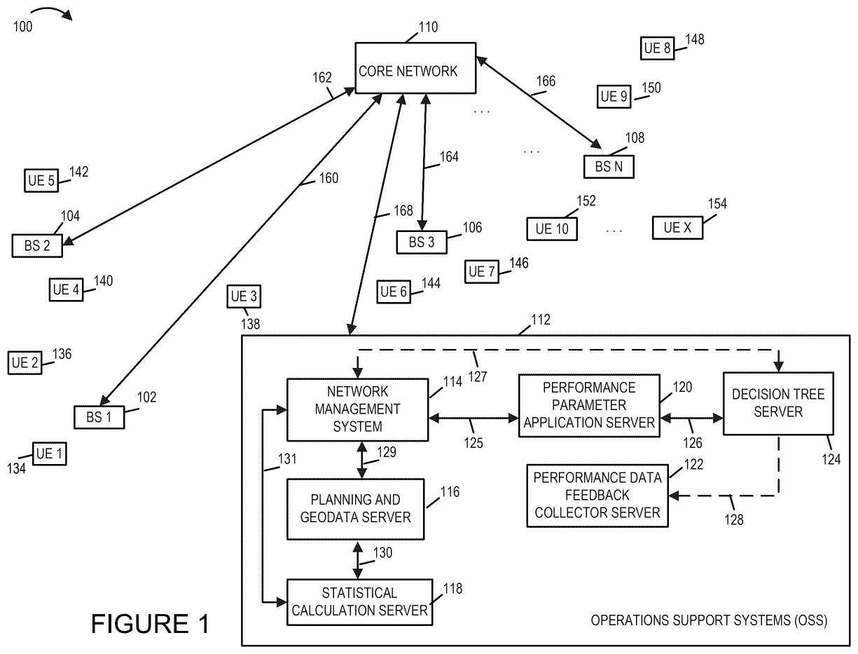

FIG. 1 illustrates elements of an exemplary system 100 in accordance with an embodiment of the present invention. System 100 includes a wireless network operated by a wireless network operator including a plurality of wireless base stations (BS 1 102, BS 2 104, BS 3 106, . . . , BS N 108, (N being a positive integer greater than 3), a core network 110, an Operations Support Systems (OSS) 112 and a plurality of user equipment devices (UE 1 134, UE 2 136, UE 3 138, UE 4 140, UE 5 142, UE 6 144, UE 7 146, UE 8 148, UE 9 150, UE 10 152, . . . , UE X 154 (X being a positive integer greater than 10)). The core network 110 is coupled and/or connected to BS 1 102, BS 2 104, BS 3 106, . . . , BS N 108 via communications links 160, 162, 164, . . . , 166 respectively. The core network 110 is coupled to the OSS 112 via communications link 168. The communications links 160, 162, 164, . . . , 166, 168 are typically high speed wired, fiber and/or optical communications links. However, in some embodiments, one or more of the communications links 160, 162, 164, . . . , 166, 168 are wireless communications links. The OSS 112 includes a Network Management System 114, a Planning and GeoData Server 116, a statistical calculation server 118, a Performance Parameter Application Server 120, a Performance Data Feedback Collector Server 122, and a Decision Tree Server 124. In some embodiments, the Network Management System 114 is implemented as a server. In some embodiments, one or more of the Network Management System 114, a Planning and GeoData Server 116, a statistical calculation server 118, a Performance Parameter Application Server 120, a Performance Data Feedback Collector Server 122, and a Decision Tree Server 124 is implemented as a function or component of the OSS 112. In some embodiments, the Performance Parameter Application Server 120, the Performance Data Feedback Collector Server 122, and/or the Decision Tree Server 124 are implemented as functions and/or components of the Network Management System 114. In some embodiments, the OSS 112 and/or one or more of the systems and/or servers of the OSS 112 are implemented in a cloud system (e.g., as functions implemented on nodes or servers of the cloud system). Exemplary communications links 125, 126, 127, 128, 129, 130 and 131 couple and/or connect the various elements of the Operations Support System 112 as shown in FIG. 1 allowing the elements to exchange information, messages, instructions and/or data. These communications links are typically high speed wire and/or fiber optic communications links.

Each of the wireless base station of the system 100 (BS 1 102, BS 2 104, BS 3 106, . . . , BS N 108) have a wireless coverage area in which the wireless base station providers wireless services to user equipment devices. The coverage area of each of the wireless base stations as will be discussed in detail below depends on a variety of factors including the frequency of the spectrum being utilized by the wireless base station for communications, the location of the base station, and environment (e.g., structures such as trees, mountains, buildings, etc.) in which the wireless base station is deployed. Exemplary wireless base stations include gNodeBs (gNBs, eNodeBs (eNBs), and Citizens Broadband Radio Service Devices (CBSDs).

The user equipment devices are typically end-point wireless devices such as for example smartphones, laptops, tablets, wireless sensors, wireless smart devices (appliances), computers, etc. which communicate using spectrum with the wireless base stations of system 100. In the exemplary system 100, UE 1 134, UE 2 136 and UE 3 138 are wirelessly coupled and/or connected to BS 1 102; UE 4 140 and UE 5 142 are wirelessly coupled and/or connected to BS 2 104; UE 6 144 and UE 7 146 are wirelessly coupled and/or connected to BS 3 106; UE 8 148, UE 9 150, UE 10 152, . . . , UE X 154 are wirelessly coupled and/or connected to BS N 108. In many systems, the spectrum utilized by a Base Station is spectrum licensed by the wireless network operator of the wireless network. In some systems, such as for example, systems utilizing Citizens Broadband Radio Service (CBRS) networks, the user equipment devices are provided wireless services by the BS to which they are coupled and/or connected using CBRS spectrum allocated to the CBSD by a Spectrum Access System which manages the use of CBRS spectrum. In some embodiments, the user equipment devices of the system also include Customer Premises Equipment (CPE) devices, wireless gateways and/or other base stations which include user equipment device emulators having receiving and transmitting circuitry allowing each of these devices to wirelessly communicate using spectrum (e.g., CBRS spectrum for a CBRS network such as PAL or GAA spectrum utilized by the wireless network operator). One or more of the user equipment devices may be, and in many embodiments are, mobile devices which receive wireless services from different wireless base stations as the user equipment devices move between different coverage areas of the different wireless base stations of system 100. While the system 100 only shows a limited number of wireless base stations and user equipment devices, this is only exemplary and for the sake of simplicity in explaining the invention. In actual implementations, there are large numbers (e.g., thousands) of base stations including micro and/or macro base stations with large numbers (e.g., thousands and/or hundreds of thousands) of user equipment devices being supported by the wireless network. In some embodiments, the wireless network is a 4G or 5G wireless network.

In an exemplary embodiment of the present invention, the following steps are performed. A base station is initially operated with a default set of operational configuration settings. A first set of metrics are collected on the operation of the base station (e.g., success and/or failure of user equipment device connection attempts, success and/or failure of handover attempts, success and/or failure of reselection attempts) while the base station operates using the default set of operational parameters (e.g., for a first period of time such as a hour, day, week or month). User equipment device location information is obtained by the network management system for the user equipment devices located within the vicinity of the base station (e.g., entering into, exiting or operating within the coverage area of the base station) and/or which connect to and/or are provided services by the base station. For example, user equipment devices which receive a reference signal from the base station and/or connect to the base station report their location their location information typically in latitude and longitude form and/or as GPS coordinates to a network management system of the wireless network via one or more base stations of the wireless network (e.g., the base station of the wireless network to which the user equipment device is connected). The network management system collects this user equipment device location information and provides it and/or inputs it to a planning and geodata server which includes a propagation component or function and geographical information for the coverage area of the wireless network including the coverage area of the base station. The geographical information includes clutter information (e.g., clutter class and type information) and terrain and building data for the coverage area of the wireless network and in particular the base station. In some embodiments, the terrain and building information is included in the clutter information. Once the user equipment location information has been provided to and/or inputted into the planning and geodata server, statistics are generated with clutter class categories for the coverage area, indoor or outdoor categories with respect to the user equipment devices with the use of buildings data, etc. Once the various areas within the base station's coverage area (determined from user equipment device location information and/or calculated coverage area based on the propagation model used by the planning and geodata server propagation component or function) are classified using the clutter information, terrain information and building information, the various areas can then be further reclassified in to three broad categories or types-urban category or type, suburban category or type, and rural category or type. The overall coverage area of the base station can then be determined based on the categorizations of the various areas within the base station's coverage area.

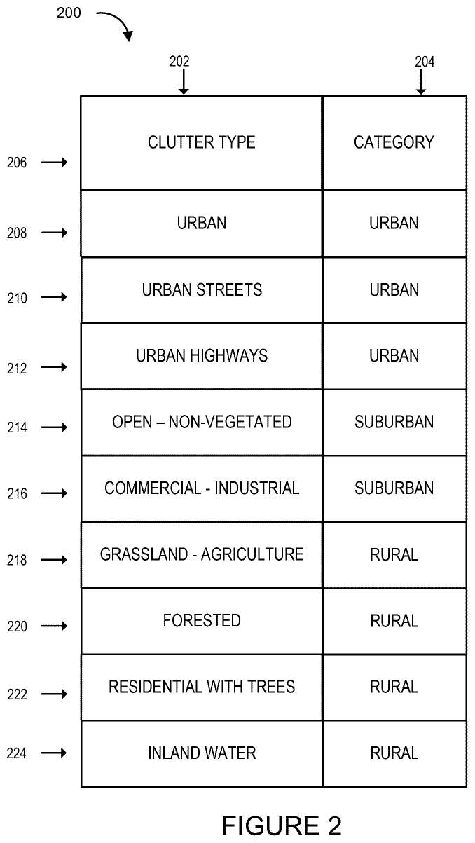

FIG. 2 illustrates a clutter type table 200 which shows an exemplary mapping of clutter types to a set of exemplary broader categories or types. The set of broader categories or types including the categories/types of: urban, suburban, and rural. The exemplary table 200 may be included in memory in one or more components in the OSS and/or in a storage device such as a data base system or data repository accessible from various nodes, devices, and/or components of the OSS. The table 200 includes columns 202 and 204 and rows 206, 208, 210, 212, 214, 216, 218, 220, 222, and 224. The entries in row 206 are labels indicating the information contained in each column. Entries in column 202 are a clutter type (entry row 206, column 202) Entries in column 204 are the broader category/type (entry row 206, column 204) which the clutter type of the same row is mapped. The clutter type urban (entry row 208, column 202) is mapped to the broader category/type urban (entry row 208, column 204). The clutter type urban streets (entry row 210, column 202) is mapped to the broader category/type urban (entry row 210, column 204). The clutter type urban highways (entry row 212, column 202) is mapped to the broader category/type urban (entry row 212, column 204). The clutter type open-nonvegetated (entry row 214, column 202) is mapped to the broader category/type suburban (entry row 214, column 204). The clutter type commercial-industrial (entry row 216, column 202) is mapped to the broader category/type suburban (entry row 216, column 204). The clutter type grassland-agriculture (entry row 218, column 202) is mapped to the broader category/type rural (entry row 218, column 204). The clutter type forested (entry row 220, column 202) is mapped to the broader category/type rural (entry row 220, column 204). The clutter type residential with trees (entry row 222, column 202) is mapped to the broader category/type rural (entry row 222, column 204). The clutter type inland water (entry row 224, column 202) is mapped to the broader category/type rural (entry row 224, column 204).

Exemplary properties of urban areas are that they generally consist of or include large and medium size buildings, are densely populated (e.g., high density of user equipment devices), experience high network congestion along with high signal interference. Exemplary properties of suburban areas are that they generally consist of or include small size buildings along with few commercial but open areas, moderate user equipment device movements, medium network congestion and less signal interference compared to urban areas. Exemplary properties of rural areas are that they generally consist of or include quite open areas including water bodies, scattered buildings with low signal penetration losses, no or low network congestion, and no or minimal signal interference (less interference than the suburban areas) due to distant sites and coverage prints. In at least some embodiments, threshold values are used to define which buildings are large, medium, or small based on a building's dimensions such as for example a building's height, length and/or width. For example, buildings whose dimensions (height multiplied by width multiplied by length) are less than a small building threshold are defined as small, buildings whose dimensions (height multiplied by width multiplied by length) are equal to or greater than the small building threshold and less than a large building threshold are defined as medium, and buildings whose dimensions (height multiplied by width multiplied by length) are greater than or equal to a large building threshold are defined as a large building.

The type of base station is then determined based on the categorization of the base station's coverage area. For example, if a base station's coverage area is determined or categorized as being rural then the base station's type is determined to be base station type rural. If a base station's coverage area is determined or categorized as being suburban then the base station's type is determined to be base station type suburban. If a base station's coverage area is determined or categorized as being suburban then the base station's type is determined to be base station type suburban.

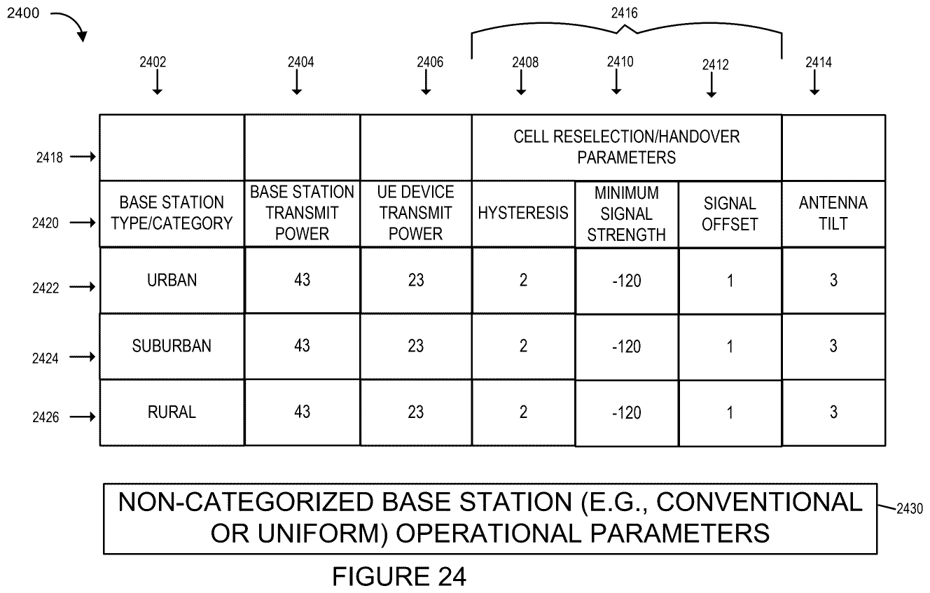

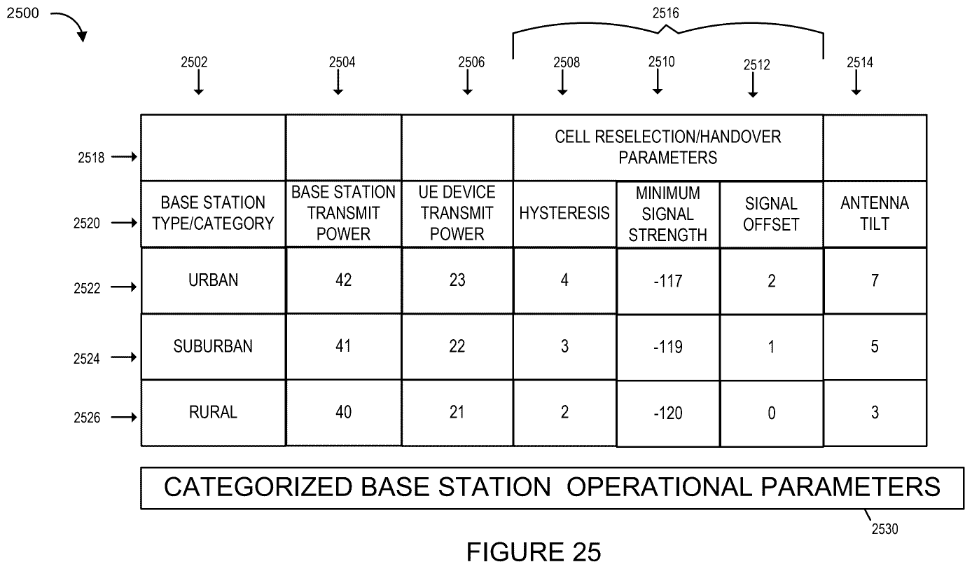

Once the base station's type has been determined, parameter profiling in implemented wherein the operational configuration parameters corresponding to the determined base station type is utilized to update the base station's operational configuration parameters from their default operational configuration settings. Exemplary operational base station parameters and the user equipment device parameters for user equipment devices which the base station services include for example, base station transmit power, user equipment device transmit power, cell reselection parameters, handover parameters, and antenna tilt parameters. Table 2400 of FIG. 24 illustrates exemplary conventional or uniform wireless base station configuration parameters which can be and sometimes are used as default operational configuration parameters when a base station first becomes operational. As seen in table 2400 the same operational configuration parameters are used regardless of the base station type. FIG. 24 is explained in additional detail below. Table 2500 of FIG. 25 illustrates exemplary categorized operational configuration parameters which different for each base station type. In this example, three base station types are being utilized urban, suburban and rural. Based on the determined base station type, the operational configuration parameters are updated in the base station and via the base station to the user equipment devices for user equipment device parameters such as UE maximum transmit power level. For example, the network management system will send the operational configuration parameters corresponding to its base station type to the base station which then updates its operational parameters from the default operational configuration parameters to the received operational configuration parameters and in turn sends updates to user equipment devices to update its configuration parameters (e.g., transmit power level). In some embodiments, one or more of the base stations in the wireless system store in memory different operational configuration profiles (e.g., urban operational configuration profile, suburban operational configuration profile, and rural operational configuration profile). Each of the different operation configuration profiles including the operational configuration parameters corresponding to the specific profile. In such, cases, the network management system in response to determining a base station is of a specific type can send instructions for the base station to update its operational configuration parameters to correspond to the determined base station type (e.g., base station is urban type update to stored operational configuration parameters corresponding to the urban operational configuration profile).

Once the updated operational configuration parameters have been implemented (e.g., by the base station and the user equipment devices being serviced by the base station), a second set of metrics are collected on the operation of the base station (e.g., success and/or failure of user equipment device connection attempts, success and/or failure of handover attempts, success and/or failure of reselection attempts) while the base station operates is using the updated set of operational parameters (e.g., for a second period of time such as a hour, day, week or month). The first set of metrics are compared to the second set of metrics (e.g., by the OSS of the wireless network) and a determination is made as to whether the performance of the base station has improved. If the performance has not improved or has become worse, the OSS will determine that the base station should restore its default operational configuration parameters. The OSS, e.g., the network management system of the OSS, will then send instructions to restore the operational parameters to the default parameter settings.

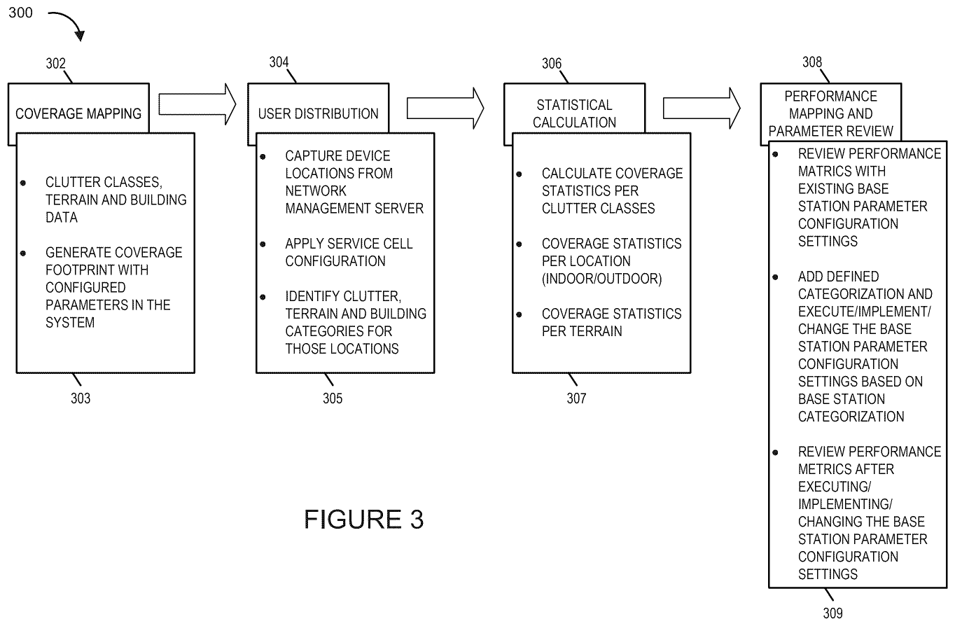

FIG. 3 illustrates an exemplary high level process flow diagram and method 300 which is used for performing categorization and parameter profiling of wireless base stations and/or user equipment devices in accordance with an embodiment of present invention.

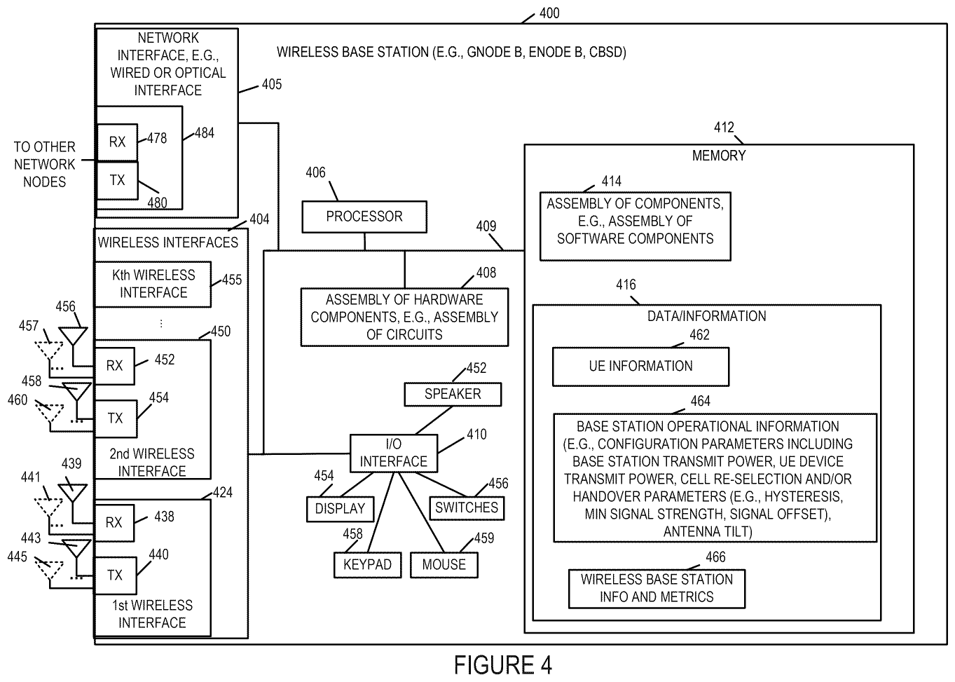

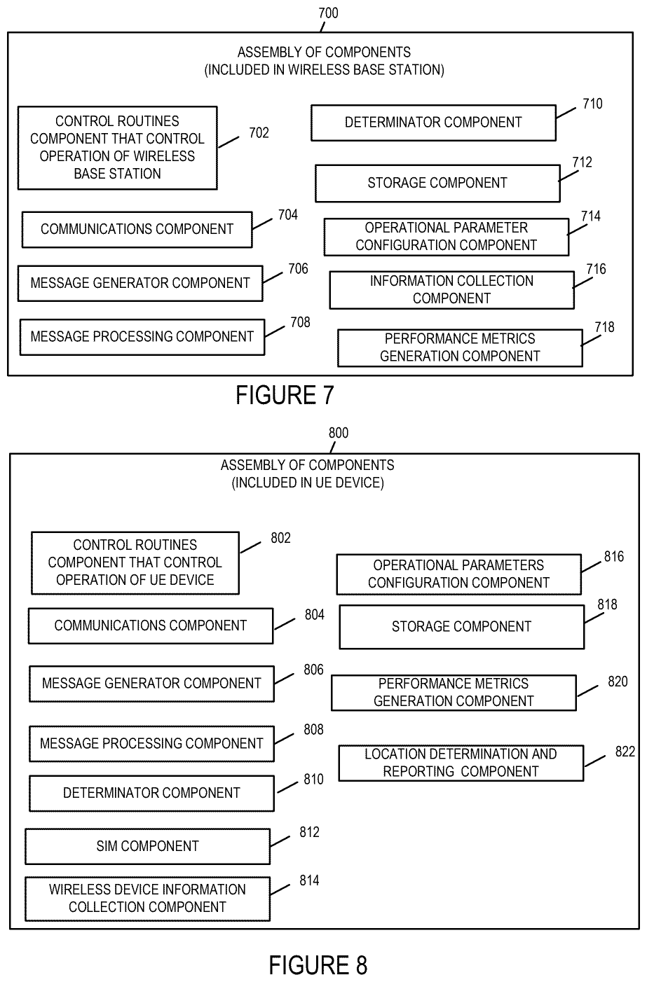

FIG. 4 is a drawing of an exemplary wireless base station 400 in accordance with an exemplary embodiment. In some embodiments, one or more of the wireless base stations of system 100 (e.g., wireless base station 1 102, wireless base station 2 104, wireless base station 3 106, . . . , wireless base station N 108) are implemented in accordance with wireless base station 400. The elements of wireless base station 400 are explained in additional detail below. FIG. 7, which is discussed in detail, below illustrates an exemplary assembly of components 700 for a wireless base station in accordance with an embodiment of the present invention.

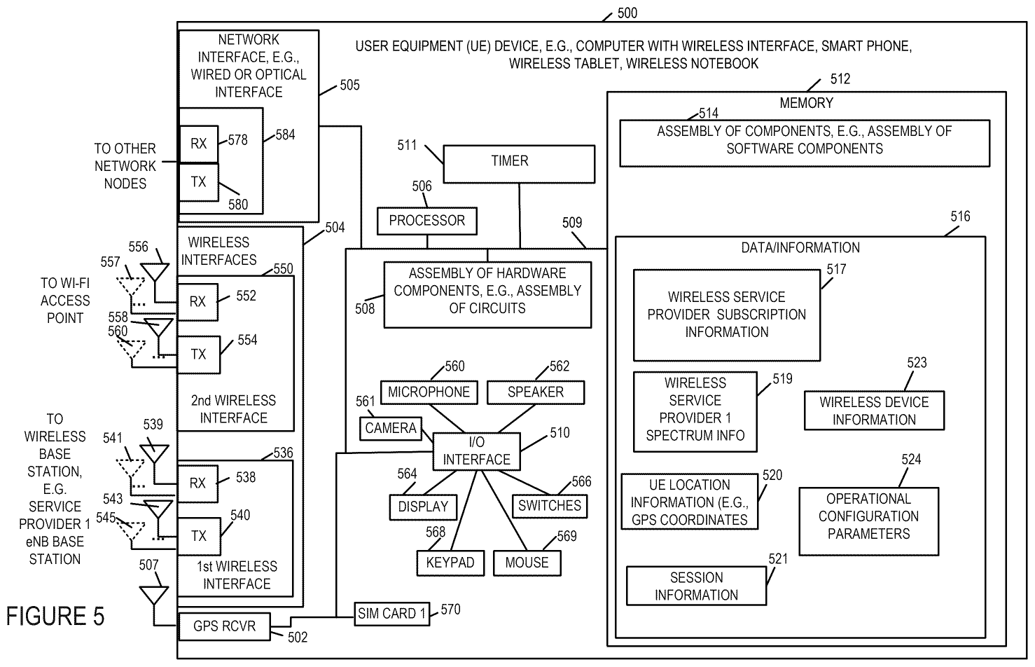

FIG. 5 is a drawing of an exemplary user equipment (UE) device 500 in accordance with an exemplary embodiment. In some embodiments, one or more of the user equipment devices of system 100 (e.g., user equipment device 1 134, user equipment device 2 136, user equipment device 3 138, user equipment device 4 140, user equipment device 5 142, user equipment device 6 144, user equipment device 7 146, user equipment device 8 148, user equipment device 9 150, user equipment device 10 152, . . . , user equipment device X 154) are implemented in accordance with user equipment device 500. The elements of user equipment device 500 are explained in additional detail below. FIG. 8, which is discussed in detail, illustrates an exemplary assembly of components 800 for a user equipment device in accordance with an embodiment of the present invention.

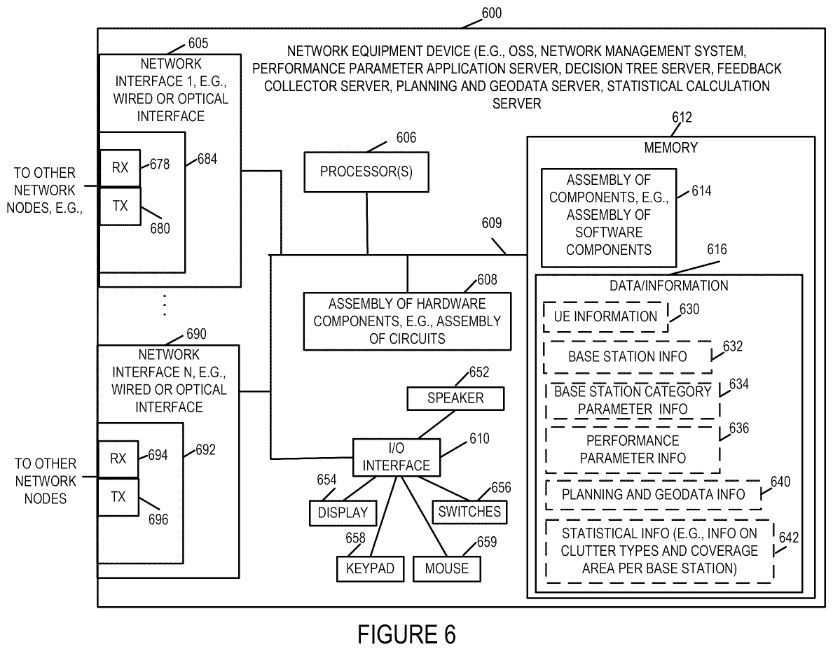

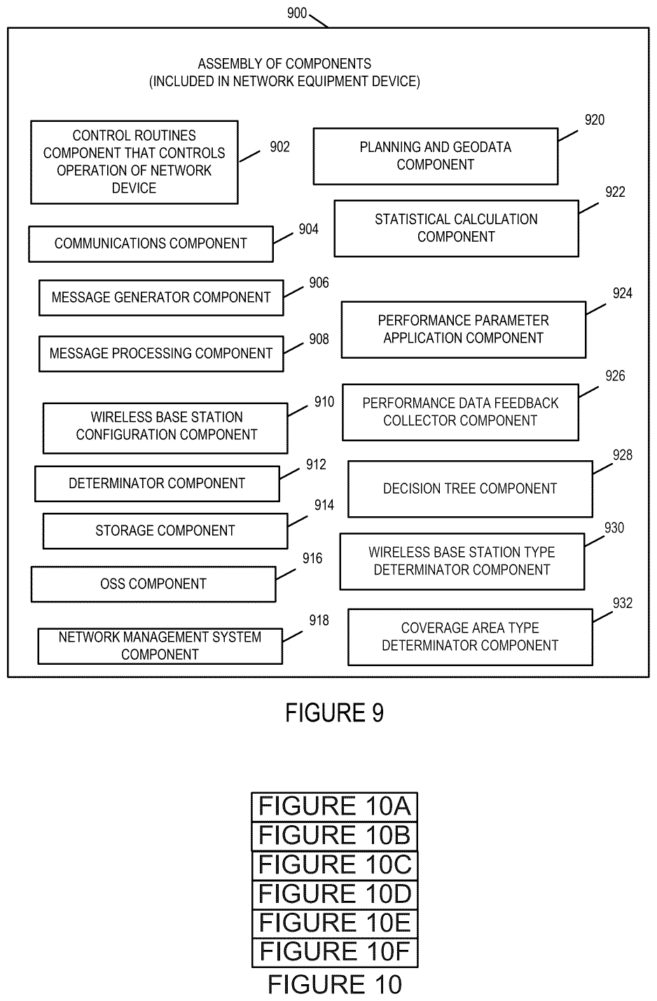

FIG. 6 illustrates details of an exemplary network equipment device, system, server or node, e.g., Operating Service Systems (OSS), Network Management System, Performance Parameter Application Server, Decision Tree Server, Planning and Geodata Server, Statistical Calculation Server, Performance Data Feedback Collector Server, core network system, in accordance with an embodiment of the present invention. FIG. 9, which is discussed in detail below, illustrates an exemplary assembly of components 900 for a network equipment device in accordance with an embodiment of the present invention.

As previously discussed, FIG. 3 illustrates an exemplary high level process flow diagram and method 300 which is used for performing categorization and parameter profiling of wireless base stations and/or user equipment devices in accordance with an embodiment of present invention. The exemplary process flow diagram and method 300 will be explained as being implemented by system 100 illustrated in FIG. 1. However, it is to be understood that the process flow diagram and method 300 is not limited to system 100 and may be implemented by a variety of different systems and system configurations other than that illustrated by system 100.

The process flow diagram and method 300 starts in step 302. In step 302, the OSS 112 performs coverage mapping operations. These coverage mapping operations include one or more of the operations listed in sub-step 303. The coverage mapping operations include inputting or obtaining geographical information (e.g., clutter class/type data, terrain data and building data) for the coverage area to mapped (e.g., the coverage area of one or more, or all of the base stations of system 100).

The coverage mapping operations are performed by the OSS for the coverage area to be mapped for the base station. The location of the base station and geographical information (e.g., clutter class/category type data, terrain data and building data is input or obtained by the OSS) corresponding to the coverage area to be mapped are obtained, inputted and/or stored in the OSS 112 (e.g., in the planning and geodata server 116 of OSS 112). In some embodiments, at least some of the geographical information is obtained from databases which include information from the United States Geological Survey on land use and land cover (e.g., USGS LULC database or USSG National Land Cover database).

The coverage mapping operations also include the planning and geodata server using the geographical information and in some embodiments a propagation model to generate a coverage area map or coverage area footprint map for the wireless network system 100 with the configured parameters in the system. Operation proceeds from step 302 to user equipment device distribution step 304. In some embodiments, one or more of the operations listed in sub-step 305 are performed as part step 304.

Operations of step 304 are performed by the OSS 112. In step 304, the coverage area information/map is updated to include information on the distribution of user equipment devices throughout the coverage area (i.e., the locations and number of user equipment devices per location within the coverage area). This includes the operations of: (i) capturing user equipment device locations from the network management system, (ii) applying and/or utilizing service cell configuration information to identify the coverage area of each of the base stations of the system, and identifying clutter, terrain and building classes/categories/types for the locations of the user equipment devices within the coverage area. The user equipment device location information is reported from the user equipment devices operating in the coverage area to the base stations of system 100 which in turn provide the information to the network management system 114 of OSS 112. The network management system 114 providing the user equipment device location information to the planning and geodata server 116. The geodata server 116 applies and/or utilizes the service cell configuration information and identifies clutter, terrain and building categories/classes/types for the identified user equipment device locations based on the geographical information and the captured user equipment device location information. Operation proceeds from step 304 to statistical calculation step 306. In some embodiments the statistical calculation step 306 includes the operations listed in sub-step 307.

In step 306, the statistical calculation server 118 of the OSS 112 performs statistical analysis and/or calculations using the base station location information, geographical information (e.g., identified clutter, terrain and building categories/classes/types), and user equipment device location information to generate and/or calculate one or more of the following: (i) statistics per clutter classes/categories/types, (ii) coverage statistics per location (indoor/outdoor-user equipment devices being indoor (e.g., within a building) or outdoor (not within a building), and (iii) coverage statistics per terrain class/category/type. Operation proceeds from step 306 to performance mapping and parameter review step 308. In some embodiments, step 308 includes one or more of the operations listed in sub-step 309.

In step 308, the OSS 112 system performs performance mapping and parameter review operations including one or more of the following operations for each base station: (i) review performance metrics with existing base station parameter configuration settings for each base station, (ii) add determined base station type categorization for each base station to system configuration tracking information, (iii) execute and/or implement operations to change and/or update each base station's parameter configuration settings based on its determined base station category/type (e.g., send instructions to each base station to implement a base station configuration parameter profile update so that its configuration parameters match its determined base station type/category (e.g., urban type, suburban type, rural type) parameters per categorization profile for each base station and execute/implement change of each base station parameter configuration settings based on base station categorization, (iv) review performance metrics after executing/implementing the change to each base station's parameter configuration settings, (v) make a decision with respect to each of the base stations as to whether to keep the base station configuration parameter changes or revert back to the prior base station configuration parameter settings, and (vi) implement the decision with respect to each of the base station by keeping the configuration parameters changes for the base stations or implement operations instructing the base station to revert back to its prior configuration parameter settings. Typically, only a single base station's configuration parameters are changed at a time and then a review of the performance metrics for the base station are analyzed in view and compared to the performance metrics for the base station prior to the change of base station configuration parameters.

If the review of the performance metrics indicates that the performance of the base station has improved, the updated base station configuration is maintained. If the review of the performance metrics indicates that the base station performance has been degraded, then the OSS commands the base station to revert back to its prior configuration settings and an indication is made of the change in the system's configuration tracking information. If the review of the performance metrics indicates that the base station's performance has remained unchanged, the OSS can leave the base station with the changed configuration settings or command the base station to revert back to its prior configuration settings and make an indication of the change in the system's configuration tracking information. The review of performance metrics in many embodiments also consider the performance of neighboring base stations to ensure that performance of the overall system has been improved as opposed to improving the performance of a single base station whose parameters have been changed while overall system's performance has been degraded due to the changes effect on neighbor's base station's performance.

The operations of collecting and reviewing performance metrics with existing base station parameter configuration settings for each base station may be, and in some embodiments is, performed by the performance parameter application server 120 of OSS 112. The operation of adding determined base station type categorization for each base station to system configuration tracking information is performed by the network management system 114 of the OSS 112. The network management system 114 also makes the determinations of base station type/category for each of the base stations. The operation of executing and/or implementing the changes and/or updates to each base station's parameter configuration settings based on its determined base station category/type is performed, in some embodiments, by the network management server 114 of the OSS 112 in combination with the performance parameter application server 120 of the OSS 112. For example, in some embodiments, the network management server 114 makes the determination of the base station type/category for a base station based on the results of the statistical analysis performed by the statistical calculation server 118 and provides this determination to the performance parameters application server 120. The performance parameters application server 120 includes a set of base station operational parameter profiles including a default base station configuration profile and a separate profile for each of base station types/categories of the set of base station types/categories (e.g., a urban base station configuration profile, a suburban base station configuration profile, and a rural base station configuration profile) with each of the profiles including the base station configuration profiles corresponding to the base station type/category. The performance parameters application server 120 retrieving the base station configuration profile corresponding to the determined base station type/category for the base station and sends it or the configuration parameters included in it to the base station which receives the information and updates it configuration using the received information (e.g., received profile and/or base station configuration parameters).

The performance data feedback collector server 122 of the OSS 112, in some embodiments, collects and reviews the performance metrics after the change to a base station's parameter configuration settings has been implemented. In some embodiments, the performance parameter application server 120 and the performance data feedback collector server 122 are a single server that performs data collection and performance analysis of base stations before and after the change of a base station's configuration parameter settings.

The decision tree server 124, in some embodiments, performs the operation of making the decision with respect to each of the base stations as to whether to keep the base station configuration parameter changes or revert back to the prior base station configuration parameter settings. This determination is made based on the performance data obtained by the performance data feedback collector server 122 after the changes to a base station's configuration parameter settings when compared to the performance of the data collected by the performance parameter application server 120 per to the base station's configuration parameter changes. The network management system 114, in some embodiments, receives the decision to keep the configuration parameters changes for a base station or revert back to the prior configuration parameter settings from the decision tree server 124 and implements the received decision. The network management server 124 may, in some embodiments, update system configuration information to indicate that the configuration parameter changes for the base station are to be keep when the decision is to keep a base station's changed configuration parameters. When the decision received by the network management server 124 is to revert the base station's changed configuration settings back to their prior settings, the network management server 124 notifies the performance parameter application server 120 to revert the changed configuration parameter settings back to their prior setting for the base station. The performance parameter application server 120 updates it information for the base station, retrieves the prior configuration parameter settings from it records for the base station and sends the retrieved parameter settings to the base station which implements the changes reverting its configuration parameters back to their prior settings. In some embodiments, the performance parameter application server 120 sends a base station type profile which matches the base station profile which was previously being used by the base station before the changes which includes the base station's prior configuration parameter settings (e.g., a default profile if the base station is to change back to default configuration setting if those are the settings it was previously using before the change).

In some embodiments, all communications with base stations of the system are communicated via the network management system 114. In such embodiments, the messages, instructions, and information communicated from the performance parameter application server 120 to the base station is communicated to the base station via the network management system 114.

In various embodiments, as each base station is activated or brought on line, the base station is categorized and/or determined to be of a default base station type/category and is configured with the default base station configuration parameters. After a period of time has occurred during which performance metrics are collected and user equipment information including location information has been collected, the method 300 is performed with respect to the base station to determine and/or categorize the base station by base station type/category and update its operational configuration parameters to improve the performance and efficiency of the base station and the system while also improving the users experience receiving services from the system (e.g., less handover failures). In various embodiments, the method 300 is performed on a regular basis for a base station (e.g., every six months or year) or when monitoring the geographical information for the base station's coverage area indicates that there has been a change in the clutter type for the coverage area of the base station (e.g., new building complex).

The following OSS 112 elements of the system 100 of FIG. 1 will now be described in further detail. The network management system 114 may be, and in some embodiments is, implemented as a server. The network management system 114 in various embodiments performs network base station configuration management, collection and/or measurements of base station performance, collection and/or measurement of system performance data, generation of counters (e.g., counters for successful handovers, counters for failed handovers) and key performance indicator metrics for base stations and the system, collection of fault management information including alarms and critical triggers. The planning and geodata server 116 has the capability to obtain and store and/or accommodate geographical data such as clutter class/category/type information, building information (e.g., building paragon information), clutter height information, terrain information including terrain class/category/type information, user equipment device distribution information. The planning and geodata server 116 can load the coverage polygon information and query the statistical results with coverage area classification, coverage by user locations classification. The statistical calculation server 118 has geo coding capability to calculate statistics and perform statistical analysis based on user locations, coverage area, etc. from the coverage layers provided by the planning and geodata server 116. The performance parameter application server 120 stores configuration parameters (e.g., base station operational parameters by category/classification/type (e.g., default, urban, suburban, rural) such as illustrated in FIGS. 25, 26 and 27. The performance parameter feedback collector server 122 monitors the performance of a base station and neighboring base stations after changes to the base station's configuration parameters and determines whether or not there has been a performance improvement. In some embodiments, performance parameter feedback collector server 122 monitors the performance of the system after given changes to the network's configuration (e.g., one or more base station configuration changes based on base station classification/categorization/type) by clutter classification category and makes necessary adjustments. The decision tree server 124 makes decisions for each of the one or more base stations for which configuration parameters changes have been made and determines whether to keep the configuration parameter changes or revert back to the prior configuration parameter settings for the base station.

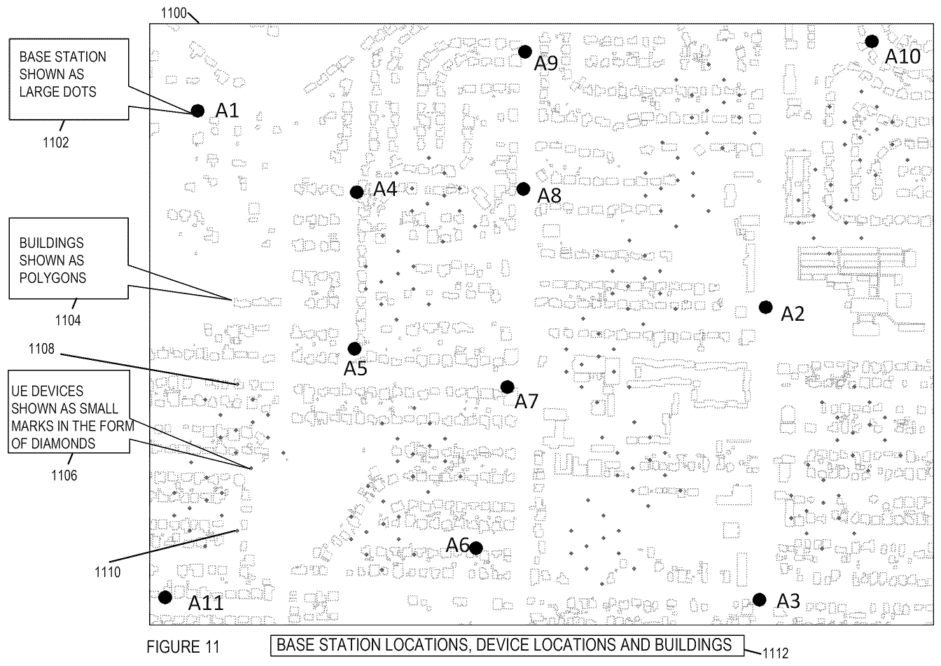

FIG. 11 illustrates an exemplary coverage area map 1100 including high-resolution building data. The title 1112 of the coverage area map is Base Station Locations, Device Locations and Buildings. The coverage area map 1100 shows building locations, base station locations, and user equipment device locations. As map legend 1102 indicates base stations in the map are shown as large black dots. The map shows the locations of 11 base stations (base station A1, base station A2, base station A3, base station A4, base station A5, base station A6, base station A7, base station A8, base station A9, base station A10 and base station A11).

The map legend 1104 indicates that buildings are shown in the map 100 as polygons with the outline of the polygon showing the building's location and footprint. The map legend 1106 indicates that user equipment devices (UEs) are shown as small marks in the form of green diamonds on the map 1100. The user equipment device 1108 is shown on the map as being indoors as its location is within a building polygon. The user equipment device 1110 is shown on the map as being outdoors as its location is not within a building polygon. The user equipment devices can be classified or categorized as indoor or outdoor user equipment devices.

From the map data, areas of the map 1100 can be classified or categorized as indoor or outdoor areas with respect to user equipment devices locations. This can be achieved by determining user equipment devices as being indoors when located within a building polygon and outdoors (or not indoors) when outside of buildings as shown in the map 1100. Most of the time indoor users will have less movements compared to outdoor users. Also, it will have building penetration losses for coverage and interference reduction. So indoor users are more susceptible to smooth handovers or cell changes if the interference is minimal.

User equipment devices are further classified in to clutter class categories based on the geographical location of the user equipment devices. There can be multiple types of clutter classes and categories defined by a geodata vendor. In table 200 of FIG. 2 described above, has nine clutter types which were mapped to three broad categories/types (urban, suburban, and rural). The 18 clutter classes shown in the heat map 1200 illustrated in FIG. 12 the legend 1300 of which is shown in FIG. 13 can also be mapped to a few clutter types/categories (e.g., urban, suburban, rural). Elements or steps with the same reference numbers used in different figures are the same or similar and those elements or steps will not be described in detail again.

With the results of the categorization of each of the base stations A1, A2, A3, A4, A5, A6, A7, A8, A9, A10, and A11 into a base station type from a set of base station types which in this example is urban base station type, suburban base station type, and rural base station type, the following exemplary configuration parameters can be adjusted for the base stations and user equipment devices operating in their respective coverage areas: (i) base station transmit power, (ii) user equipment device transmit power, (iii) cell reselection parameters, (iv) handover parameters, and (v) antenna tilt.

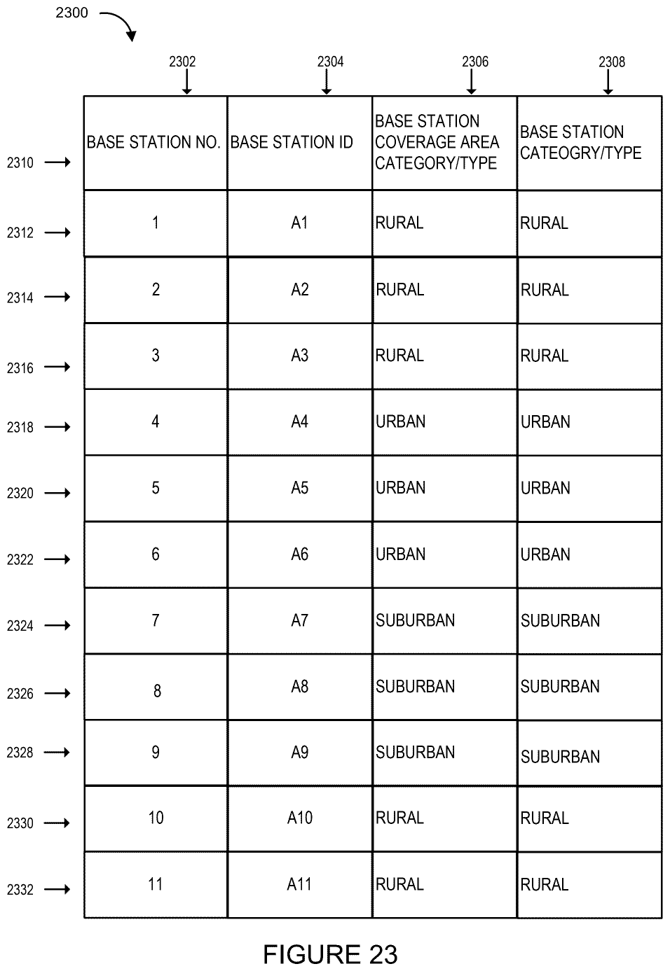

FIG. 23 illustrates an exemplary table 2300 base station coverage category/type and base station category/type for the base stations described in FIGS. 21 and 22. The table 2300 includes columns 2302, 2304, 2306 and 2308 and rows 2310, 2312, 2314, 2316, 2318, 2320, 2322, 2324, 2326, 2328, 2330, and 2332. The entries in row 2310 are labels indicating the information contained in each column. Entries in column 2302 are a base station number (entry row 2310, column 2302)/Entries in column 2304 are the base station identifier (entry row 2310, column 2304). Entries in column 2306 are the base station coverage area category/type (entry row 2310, column 2306). Entries in column 2308 are the base station category/type (entry row 2310, column 2308). The entries in each row include information corresponding to the same base station. For example, row 2312 includes information for base station number 1 (e.g., of a wireless system) (entry row 2312, column 2302). The base station number 1 has a base station identifier of A1 (entry row 2312, column 2304), a determined base station coverage area category/type of rural (entry row 2312, column 2306), and a determined base station category/type of rural (entry row 2312, column 2308). Row 2314 includes information for base station no. 2 which has a base station ID of A2, a determined base station coverage area category/type of rural, and a determined base station category type of rural. Row 2316 includes information for base station no. 3 which has a base station ID of A3, a determined base station coverage area category/type of rural, and a determined base station category type of rural. Row 2318 includes information for base station no. 4 which has a base station ID of A4, a determined base station coverage area category/type of urban, and a determined base station category type of urban. Row 2320 includes information for base station no. 5 which has a base station ID of A5, a determined base station coverage area category/type of urban, and a determined base station category type of urban. Row 2322 includes information for base station no. 6 which has a base station ID of A6, a determined base station coverage area category/type of urban, and a determined base station category type of urban. Row 2324 includes information for base station no. 7 which has a base station ID of A7, a determined base station coverage area category/type of suburban, and a determined base station category type of suburban. Row 2326 includes information for base station no. 8 which has a base station ID of A8, a determined base station coverage area category/type of suburban, and a determined base station category type of suburban. Row 2328 includes information for base station no. 9 which has a base station ID of A9, a determined base station coverage area category/type of suburban, and a determined base station category type of suburban. Row 2330 includes information for base station no. 10 which has a base station ID of A10, a determined base station coverage area category/type of rural, and a determined base station category type of rural. Row 2332 includes information for base station no. 11 which has a base station ID of A11, a determined base station coverage area category/type of rural, and a determined base station category type of rural.

Table 2400 of FIG. 24 titled Non-Categorized Base Station (e.g., Conventional or Uniform) Operational Parameters 2430 illustrates the situation in which conventional wireless base station parameter settings (uniform or default settings) are used without the use of categorization of configuration parameters or adjusts based on based on any categories/types. The table 2400 includes columns 2402, 2404, 2406, 2408, 2410, 2412, 2414 and rows 2418, 2420, 2422, 2424, 2426. The entries in row 2420 are labels indicating the information contained in each column. Entries in column 2402 are a base station type/category (entry row 2420, column 2402). Entries in column 2404 are the base station transmit power parameters (entry row 2420, column 2404). Entries in column 2406 are the UE device transmit power parameters (entry row 2420, column 2406). Entries in column 2408 are the hysteresis parameters (entry row 2420, column 2408). The entries in column 2410 are minimum signal strength parameters (entry row 2420, column 2410). The entries in column 2412 are signal offset parameters (entry row 2420, column 2412). The entries in column 2414 are antenna tilt parameters (entry row 2420, column 2414).

The entries in each row include information corresponding to the base station type/category identified in column 2402 of the row. For example, row 2422 includes information for base station type/category urban (entry row 2422, column 2402). The entries in row 2422 indicate that base station type/category urban (entry row 2422, column 2402) has the following base station configuration parameters: base station transmit power of 43 (entry row 2422, column 2404), UE device transmit power of 23 (entry row 2422, column 2406), hysteresis of 2 (entry row 2422, column 2408), minimum signal strength of −120 (entry row 2422, column 2410), signal offset of 1 (entry row 2422, column 2412), and antenna tilt of 3 (entry row 2422, column 2414). The entries in row 2424 indicate that base station type/category suburban (entry row 2424, column 2402) has the following base station configuration parameters: base station transmit power of 43 (entry row 2424, column 2404), UE device transmit power of 23 (entry row 2424, column 2406), hysteresis of 2 (entry row 2424, column 2408), minimum signal strength of −120 (entry row 2424, column 2410), signal offset of 1 (entry row 2424, column 2412), and antenna tilt of 3 (entry row 2424, column 2414). The entries in row 2426 indicate that base station type/category rural (entry row 2426, column 2402) has the following base station configuration parameters: base station transmit power of 43 (entry row 2426, column 2404), UE device transmit power of 23 (entry row 2426, column 2406), hysteresis of 2 (entry row 2426, column 2408), minimum signal strength of −120 (entry row 2426, column 2410), signal offset of 1 (entry row 2426, column 2412), and antenna tilt of 3 (entry row 2426, column 2414).

The entries in row 2418 are labels indicating that the information in columns 2408, 2410, 2412 designated as combined column 2416 are cell reselection/handover parameters (entry row 2418, combined column 2416). As previously explained, table 2400 illustrates the non-categorized base station operation parameters are the same regardless of a base station's type. Typically, such a table is not generated as the base stations are not categorized. The table 2400 is shown to explain the difference between using categorized and non-categorized sets of base station configuration parameters.

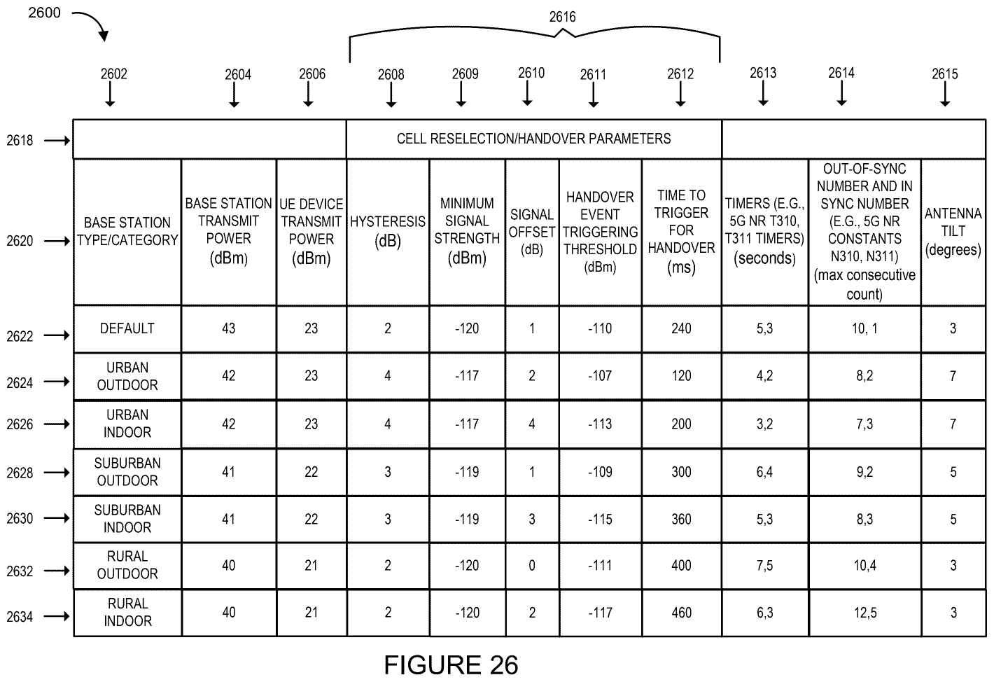

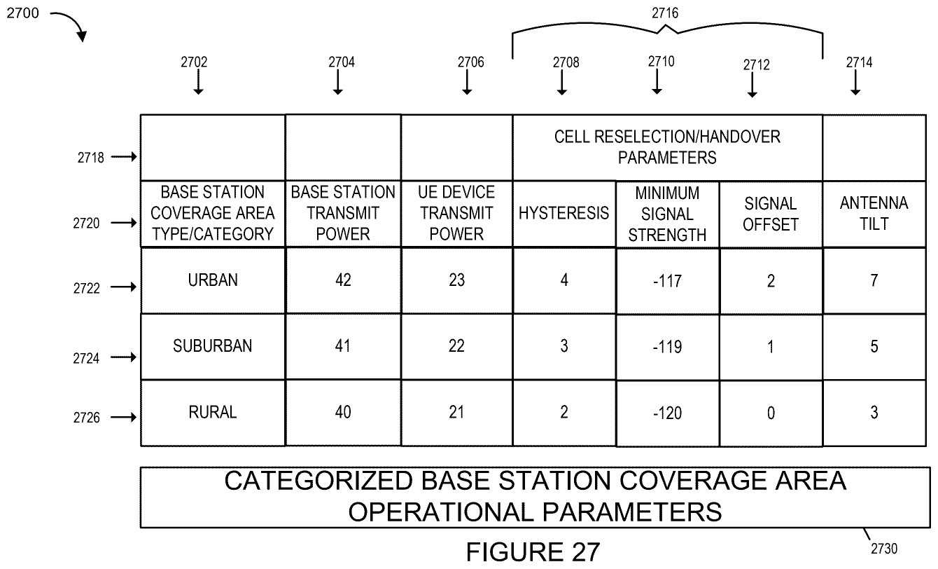

In table 2400 in FIG. 24, table 2500 in FIG. 25, table 2600 in FIG. 26, and table 2700 in FIG. 27, the units of the parameter values for base station transmit power, UE device transmit power, and minimum signal strength are decibel-milliwatts (dBms) while the parameter values for hysteresis and signal offset are decibels (dBs). The units for antenna tilt are degrees. The base station transmit power is the maximum base station transmit power. The UE device transmit power is UE device maximum transmit power.

Table 2500 of FIG. 25 titled Categorized Base Station Operational Parameters 2530 illustrates a few exemplary wireless base station configuration parameters which can be set as per base station type/category. The table 2500 includes columns 2502, 2504, 2506, 2508, 2510, 2512, 2514 and rows 2518, 2520, 2522, 2524, 2526. The entries in row 2520 are labels indicating the information contained in each column. Entries in column 2502 are a base station type/category (entry row 2520, column 2502). Entries in column 2504 are the base station transmit power parameters (entry row 2520, column 2504). Entries in column 2506 are the UE device transmit power parameters (entry row 2520, column 2506). Entries in column 2508 are the hysteresis parameters (entry row 2520, column 2508). The entries in column 2510 are minimum signal strength parameters (entry row 2520, column 2510). The entries in column 2512 are signal offset parameters (entry row 2520, column 2512). The entries in column 2514 are antenna tilt parameters (entry row 2520, column 2514).

The entries in each row include information corresponding to the base station type/category identified in column 2502 of the row. For example, row 2522 includes information for base station type/category urban (entry row 2522, column 2502). The entries in row 2522 indicate that base station type/category urban (entry row 2522, column 2502) has the following base station configuration parameters: base station transmit power of 42 (entry row 2522, column 2504), UE device transmit power of 23 (entry row 2522, column 2506), hysteresis of 4 (entry row 2522, column 2508), minimum signal strength of −117 (entry row 2522, column 2510), signal offset of 2 (entry row 2522, column 2512), and antenna tilt of 7 (entry row 2522, column 2514). The entries in row 2524 indicate that base station type/category suburban (entry row 2524, column 2502) has the following base station configuration parameters: base station transmit power of 41 (entry row 2524, column 2504), UE device transmit power of 22 (entry row 2524, column 2506), hysteresis of 3 (entry row 2524, column 2508), minimum signal strength of −119 (entry row 2524, column 2510), signal offset of 1 (entry row 2524, column 2512), and antenna tilt of 5 (entry row 2524, column 2514). The entries in row 2526 indicate that base station type/category rural (entry row 2526, column 2502) has the following base station configuration parameters: base station transmit power of 40 (entry row 2526, column 2504), UE device transmit power of 21 (entry row 2526, column 2506), hysteresis of 2 (entry row 2526, column 2508), minimum signal strength of −120 (entry row 2526, column 2510), signal offset of 0 (entry row 2526, column 2512), and antenna tilt of 3 (entry row 2526, column 2514).

The entries in row 2518 are labels indicating that the information in columns 2508, 2510, 2512 designated as combined column 2516 are cell reselection/handover parameters (entry row 2518, combined column 2516).

Base station categories/types can be defined as per base station coverage area distribution or users distribution or both along with terrain profile as discussed above. The base station categories/types can be further defined for indoor and outdoor category based on the categorization of the user equipment devices being serviced by the base station as being primarily indoors or outdoors. With this extra categorization an additional offset to the parameters in order to avoid handover ping pong is included. Table 2600 of FIG. 26 illustrates the use of additional base station types to categorize a base station taking into account user equipment device locations as being indoors or outdoors (i.e., not indoors). The table 2600 also includes additional configuration parameters including handover event triggering threshold value parameters, time to trigger for handover parameters, timer value parameters (e.g., 5G New Radio T310 timer value and T311 timer value) and maximum consecutive Out-of-Sync number parameter (e.g., 5G New Radio N310 constant) parameter and maximum consecutive In-Sync number parameter (e.g., 5G New Radio N311 constant). These additional configuration parameters are also applicable to and can be used with the base station types and base station coverage area types shown in tables 2500 and 2700. In at least one such embodiment, the exemplary parameter values for the urban outdoor type, suburban outdoor type and rural outdoor type provided in table 2600 would be used for the urban type, suburban type and rural type parameter values respectively in tables 2500 and 2700.

Table 2600 of FIG. 26 illustrates another exemplary use of categorization of configuration parameters based on wireless base station categories/types. The table 2600 includes columns 2602, 2604, 2606, 2608, 2609, 2610, 2611, 2612, 2613, 2614, 2615, and rows 2618, 2620, 2622, 2624, 2626, 2628, 2630, 2632, 2634. The entries in row 2620 are labels indicating the information contained in each column. Entries in column 2602 are a base station type/category (entry row 2620, column 2602). Entries in column 2604 are the base station transmit power parameters in dBm units (entry row 2620, column 2604). Entries in column 2606 are the UE device transmit power parameters in dBm units (entry row 2620, column 2606). Entries in column 2608 are the hysteresis parameters in dB (entry row 2620, column 2608). The entries in column 2609 are minimum signal strength parameters in dBm units (entry row 2620, column 2609). The entries in column 2610 are signal offset parameters in decibels (dBs) (entry row 2620, column 2610). Entries in column 2611 are handover event triggering threshold parameters in dBm units (entry row 2620, column 2611). The entries in column 2612 are time to trigger for handover parameters in milliseconds (ms) (entry row 2620, column 2612). Entries in column 2613 are timer parameters (e.g., 5G New Radio (NR) T310, T311 timers) in seconds (entry row 2620, column 2613). The entries in column 2614 are out-of-sync number and in-sync number parameters (e.g., 5G NR constants N310, N311) which are expressed as a max consecutive count value or number (entry row 2620, column 2614). The entries in column 2615 are antenna tilt parameters in degrees (entry row 2620, column 2615).

The entries in each row include information corresponding to the base station type/category identified in column 2602 of the row. For example, row 2622 includes information for base station type/category default (entry row 2622, column 2602). The entries in row 2622 indicate that base station type/category default (entry row 2622, column 2602) has the following base station configuration parameters: base station transmit power of 43 dBm (entry row 2622, column 2604), UE device transmit power of 23 dBm (entry row 2622, column 2606), hysteresis of 2 dB (entry row 2622, column 2608), minimum signal strength of −120 dBm (entry row 2622, column 2609), signal offset of 1 dB (entry row 2622, column 2610), handover event triggering threshold of −110 dBm (entry row 2622, column 2611), time to trigger for handover of 240 ms (entry row 2622, column 2612), timer values (e.g., 5G NR T310 timer, T311 timer) of 5 seconds and 3 seconds respectively (entry row 2622, 2613), out-of-sync number and in-synch number (e.g., 5G NR constants N310, N311) of maximum consecutive counts of 10 and 1 respectively (entry row 2622, 2614), and antenna tilt of 3 degrees (entry row 2622, column 2615). The entries in row 2624 indicate that base station type/category urban outdoor (entry row 2624, column 2602) has the following base station configuration parameters: base station transmit power of 42 dBm (entry row 2624, column 2604), UE device transmit power of 23 dBm (entry row 2624, column 2606), hysteresis of 4 dB (entry row 2624, column 2608), minimum signal strength of −117 dBm (entry row 2624, column 2609), signal offset of 2 dB (entry row 2624, column 2610), handover event triggering threshold of −107 dBm (entry row 2624, column 2611), time to trigger for handover of 120 ms (entry row 2624, column 2612), timer values (e.g., 5G NR T310 timer, T311 timer) of 4 seconds and 2 seconds respectively (entry row 2624, 2613), out-of-sync number and in-synch number (e.g., 5G NR constants N310, N311) of maximum consecutive counts of 8, 2 respectively (entry row 2624, 2614), and antenna tilt of 7 degrees (entry row 2624, column 2615). The entries in row 2626 indicate that base station type/category urban indoor (entry row 2626, column 2602) has the following base station configuration parameters: base station transmit power of 42 dBm (entry row 2626, column 2604), UE device transmit power of 23 dBm (entry row 2626, column 2606), hysteresis of 4 dB (entry row 2626, column 2608), minimum signal strength of −117 dBm (entry row 2626, column 2609), signal offset of 4 dB (entry row 2626, column 2610), handover event triggering threshold of −113 dBm (entry row 2626, column 2611), time to trigger for handover of 200 ms (entry row 2626, column 2612), timer values (e.g., 5G NR T310 timer, T311 timer) of 3 seconds and 2 seconds respectively (entry row 2626, 2613), out-of-sync number and in-synch number (e.g., 5G NR constants N310, N311) of maximum consecutive counts of 7, 3 respectively (entry row 2626, 2614), and antenna tilt of 7 degrees (entry row 2626, column 2614). The entries in row 2628 indicate that base station type/category suburban outdoor (entry row 2628, column 2602) has the following base station configuration parameters: base station transmit power of 41 dBm (entry row 2628, column 2604), UE device transmit power of 22 dBm (entry row 2628, column 2606), hysteresis of 3 dB (entry row 2628, column 2608), minimum signal strength of −119 dBm (entry row 2628, column 2609), signal offset of 1 dB (entry row 2628, column 2610), handover event triggering threshold of −109 dBm (entry row 2628, column 2611), time to trigger for handover of 300 ms (entry row 2628, column 2612), timer values (e.g., 5G NR T310 timer, T311 timer) of 6 seconds and 4 seconds respectively (entry row 2628, 2613), out-of-sync number and in-synch number (e.g., 5G NR constants N310, N311) of maximum consecutive counts of 9, 2 respectively (entry row 2628, 2614), and antenna tilt of 5 degrees (entry row 2628, column 2615). The entries in row 2630 indicate that base station type/category suburban indoor (entry row 2630, column 2602) has the following base station configuration parameters: base station transmit power of 41 dBm (entry row 2630, column 2604), UE device transmit power of 22 dB (entry row 2630, column 2606), hysteresis of 3 dB (entry row 2630, column 2608), minimum signal strength of −119 dBm (entry row 2630, column 2609), signal offset of 3 dB (entry row 2630, column 2610), handover event triggering threshold of −115 dBm (entry row 2630, column 2611), time to trigger for handover of 360 ms (entry row 2630, column 2612), timer values (e.g., 5G NR T310 timer, T311 timer) of 5 seconds and 3 seconds respectively (entry row 2630, 2613), out-of-sync number and in-synch number (e.g., 5G NR constants N310, N311) of maximum consecutive counts of 8, 3 respectively (entry row 2630, 2614), and antenna tilt of 5 degrees (entry row 2630, column 2615). The entries in row 2632 indicate that base station type/category rural outdoor (entry row 2632, column 2602) has the following base station configuration parameters: base station transmit power of 40 dBm (entry row 2632, column 2604), UE device transmit power of 21 dBm (entry row 2632, column 2606), hysteresis of 2 dB (entry row 2632, column 2608), minimum signal strength of −120 dBm (entry row 2632, column 2609), signal offset of 0 dB (entry row 2632, column 2610), handover event triggering threshold of −111 dBm (entry row 2632, column 2611), time to trigger for handover of 400 ms (entry row 2632, column 2612), timer values (e.g., 5G NR T310 timer, T311 timer) of 7 seconds and 5 seconds respectively (entry row 2632, 2613), out-of-sync number and in-synch number (e.g., 5G NR constants N310, N311) of maximum consecutive counts of 10, 4 respectively (entry row 2632, 2614), and antenna tilt of 3 degrees (entry row 2632, column 2615). The entries in row 2634 indicate that base station type/category rural indoor (entry row 2634, column 2602) has the following base station configuration parameters: base station transmit power of 40 dBm (entry row 2634, column 2604), UE device transmit power of 21 dBm (entry row 2634, column 2606), hysteresis of 2 dB (entry row 2632, column 2608), minimum signal strength of −120 dBm (entry row 2634, column 2609), signal offset of 2 dB (entry row 2634, column 2610), handover event triggering threshold of −117 dBm (entry row 2634, column 2611), time to trigger for handover of 460 ms (entry row 2634, column 2612), timer values (e.g., 5G NR T310 timer, T311 timer) of 6 seconds and 3 seconds respectively (entry row 2634, 2613), out-of-sync number and in-synch number (e.g., 5G NR constants N310, N311) of maximum consecutive counts of 12, 5 respectively (entry row 2634, 2614), and antenna tilt of 3 degrees (entry row 2634, column 2615).

The entries in row 2618 are labels indicating that the information in columns 2608, 2609, 2610, 2611, and 2612 designated as combined column 2616 are cell reselection/handover parameters (entry row 2618, combined column 2616).

Table 2700 of FIG. 27 titled Categorized Base Station Coverage Area Operational Parameters 2730 illustrates base station parameters categorized by base station coverage area type/category. In many embodiments, the base station type is the same as the base station coverage area type/category. In some embodiments, the base station type is determined based on a categorization of the base station coverage area of the base station.

The table 2700 includes columns 2702, 2704, 2706, 2708, 2710, 2712, 2714 and rows 2718, 2720, 2722, 2724, 2726. The entries in row 2720 are labels indicating the information contained in each column. Entries in column 2702 are a base station coverage area type/category (entry row 2720, column 2702). Entries in column 2704 are the base station transmit power parameters (entry row 2720, column 2704). Entries in column 2706 are the UE device transmit power parameters (entry row 2720, column 2706). Entries in column 2708 are the hysteresis parameters (entry row 2720, column 2708). The entries in column 2710 are minimum signal strength parameters (entry row 2720, column 2710). The entries in column 2712 are signal offset parameters (entry row 2720, column 2712). The entries in column 2714 are antenna tilt parameters (entry row 2720, column 2714).

The entries in each row include information corresponding to the base station coverage area type/category identified in column 2702 of the row. For example, row 2722 includes information for base station coverage area type/category urban (entry row 2722, column 2702). The entries in row 2722 indicate that base station coverage area type/category urban (entry row 2722, column 2702) has the following base station configuration parameters: base station transmit power of 42 (entry row 2722, column 2704), UE device transmit power of 23 (entry row 2722, column 2706), hysteresis of 4 (entry row 2722, column 2708), minimum signal strength of −117 (entry row 2722, column 2710), signal offset of 2 (entry row 2722, column 2712), and antenna tilt of 7 (entry row 2722, column 2714). The entries in row 2724 indicate that base station coverage area type/category suburban (entry row 2724, column 2702) has the following base station configuration parameters: base station transmit power of 41 (entry row 2724, column 2704), UE device transmit power of 22 (entry row 2724, column 2706), hysteresis of 3 (entry row 2724, column 2708), minimum signal strength of −119 (entry row 2724, column 2710), signal offset of 1 (entry row 2724, column 2712), and antenna tilt of 5 (entry row 2724, column 2714). The entries in row 2726 indicate that base station coverage area type/category rural (entry row 2726, column 2702) has the following base station configuration parameters: base station transmit power of 40 (entry row 2726, column 2704), UE device transmit power of 21 (entry row 2726, column 2706), hysteresis of 2 (entry row 2726, column 2708), minimum signal strength of −120 (entry row 2726, column 2710), signal offset of 0 (entry row 2726, column 2712), and antenna tilt of 3 (entry row 2726, column 2714).

The entries in row 2718 are labels indicating that the information in columns 2708, 2710, 2712 designated as combined column 2716 are cell reselection/handover parameters (entry row 2718, combined column 2716).

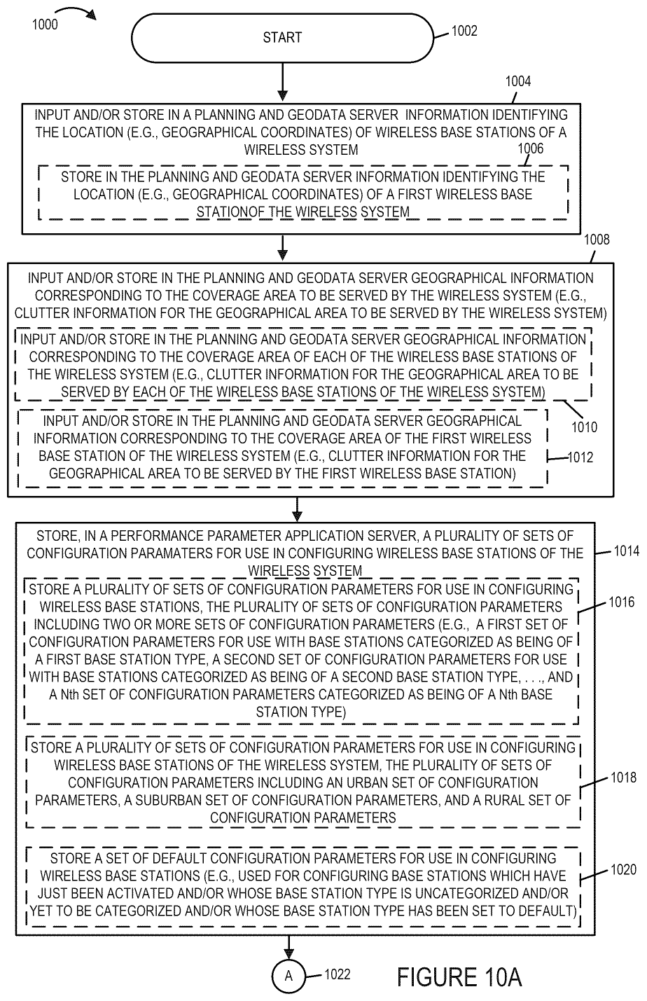

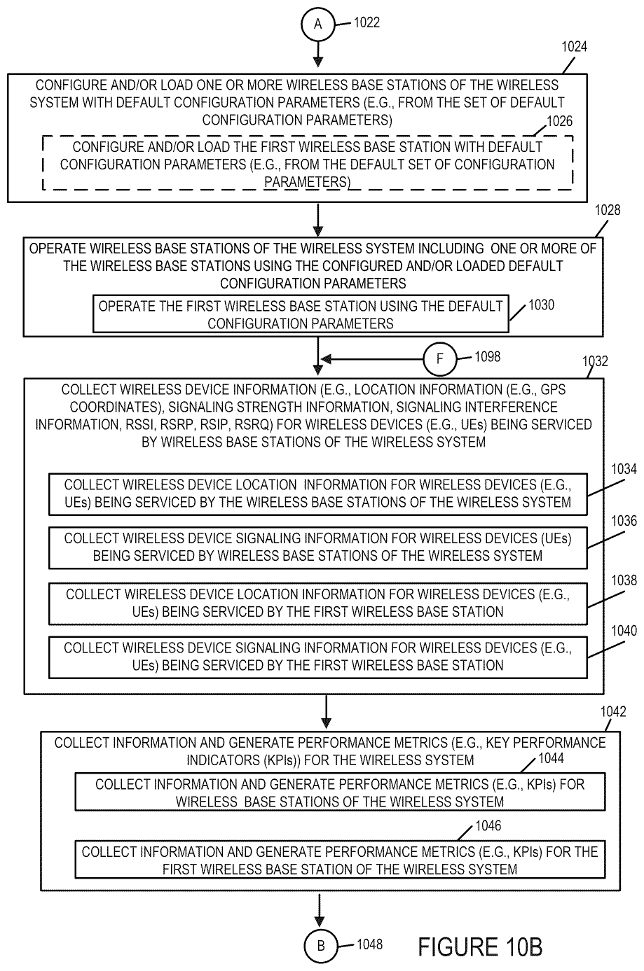

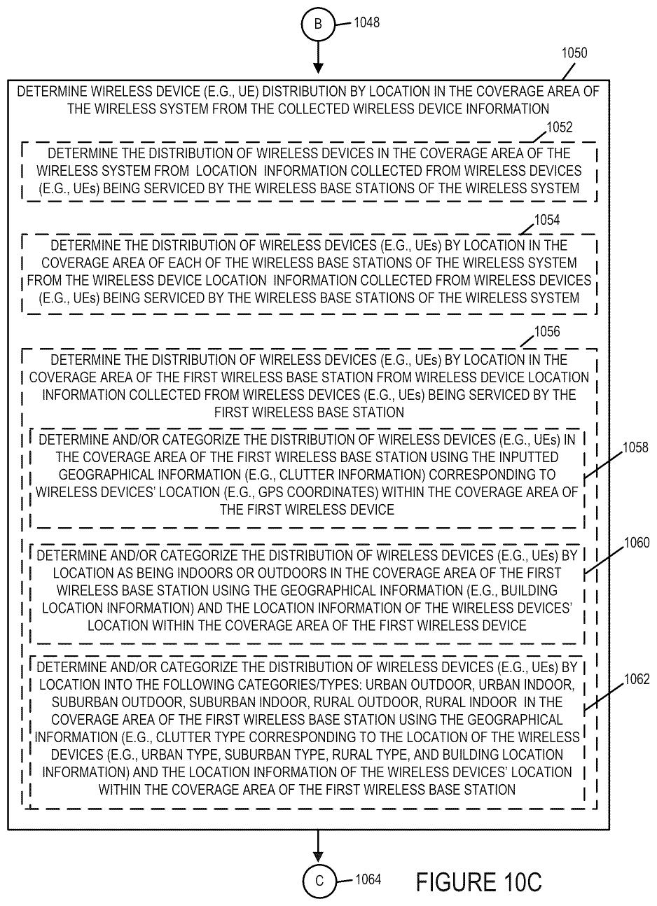

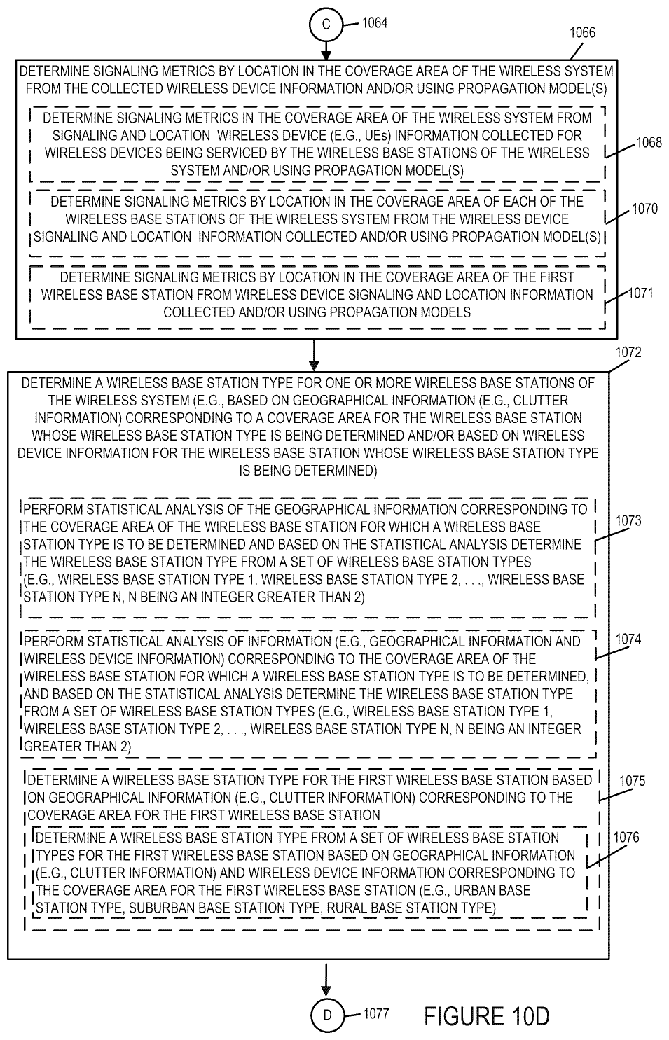

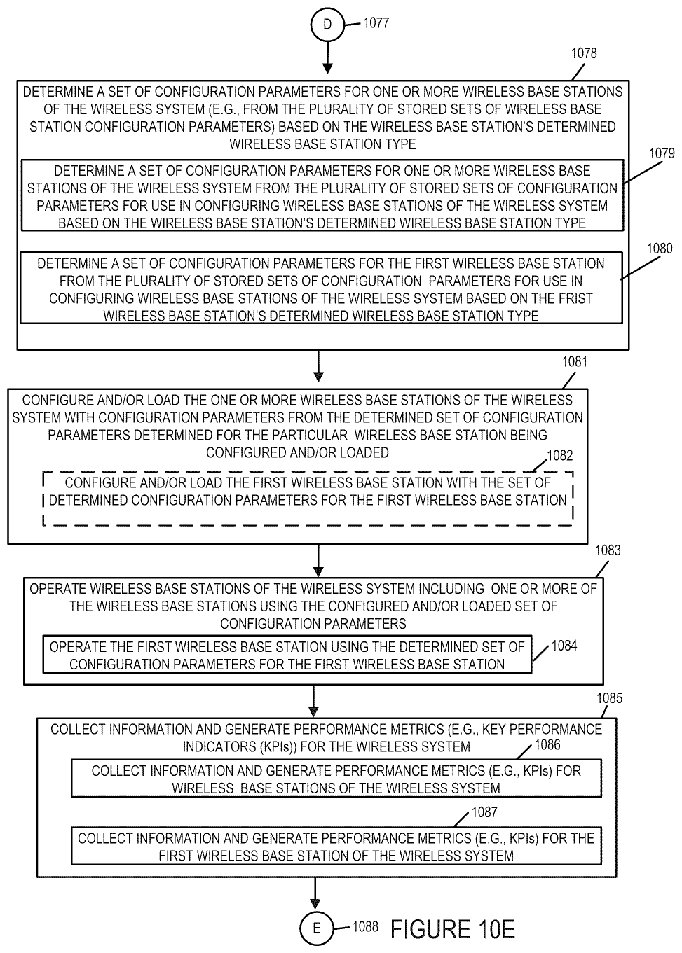

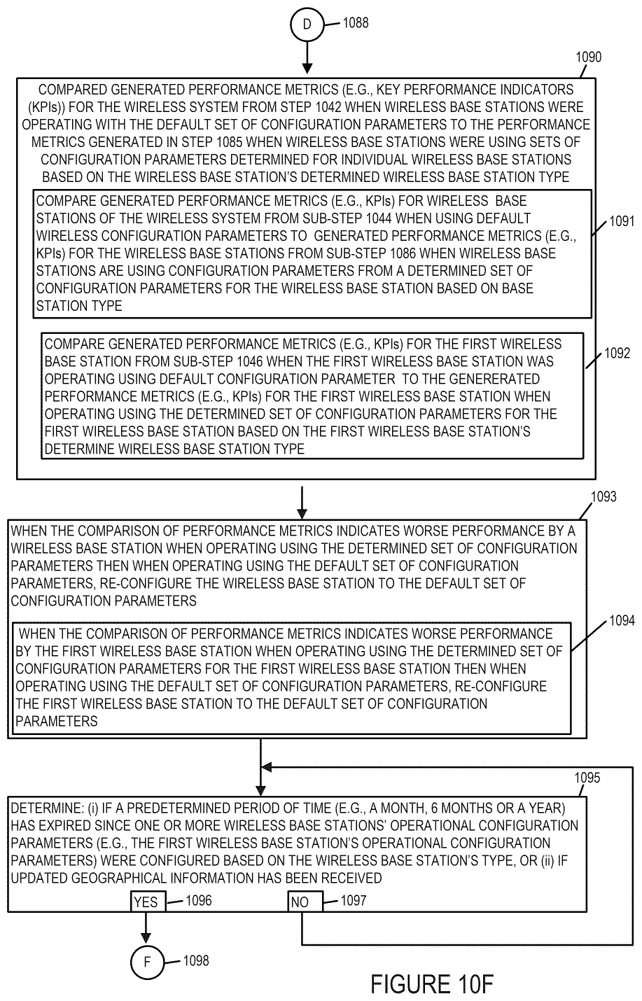

FIG. 10 comprises FIG. 10A, FIG. 10B, FIG. 10C, FIG. 10D, FIG. 10E, and FIG. 10F. FIG. 10A is the first part of a flowchart of an exemplary method 1000 in accordance with an embodiment of the present invention. FIG. 10B is the second part of a flowchart of an exemplary method 1000 in accordance with an embodiment of the present invention. FIG. 10C is the third part of a flowchart of an exemplary method 1000 in accordance with an embodiment of the present invention. FIG. 10D is the fourth part of a flowchart of an exemplary method 1000 in accordance with an embodiment of the present invention. FIG. 10E is the fifth part of a flowchart of an exemplary method 1000 in accordance with an embodiment of the present invention. FIG. 10F is the sixth part of a flowchart of an exemplary method 1000 in accordance with an embodiment of the present invention.

While it will be readily understood that additional steps are performed in connection with communicating information, data, and messages between devices, the method 1000 focuses on and discusses the steps for understanding the invention. The method 1000 will be discussed in connection with the exemplary system 100 but is not limited to being implemented on system 100 and can be implemented on other systems.

Method 1000 begins in start step 1002 shown on FIG. 10A. Operation proceeds from step 1002 to step 1004. In step 1004, information identifying the location (e.g., geographic coordinates) of wireless base stations (e.g., wireless base station 1 102, wireless base station 2 104, wireless base station 3 106, wireless base station N 108) of a wireless system (e.g., wireless system 100) is inputted and/or stored in a planning and geodata server (e.g., planning and geodata server 116 of OSS 112). In some embodiments, the wireless system 100 is implemented with N=11 wireless base stations. The N=11 wireless base stations being the wireless base stations A1, A2, A3, A4, A5, A6, A7, A8, A9, A10, and A11 shown and in map 1100 of FIG. 11 which illustrates the location of base stations, wireless devices (e.g., UEs), and buildings in the coverage area of the wireless system 100.

In some embodiments, step 1004 includes sub-step 1006. In step 1006, information identifying the location (e.g., geographical coordinates) of a first wireless base station of the wireless system is inputted and/or stored in the planning and geodata server (e.g., planning and geodata server 116 of OSS 112). Operation proceeds from step 1004 to step 1006. In some embodiments, a wireless network operator or server of the wireless system inputs the information about the locations of the wireless base stations into the planning and geodata server which stores the input information it receives in a storage device and/or memory of the planning and geodata server. Operation proceeds from step 1004 to step 1008.

In step 1008, geographical information corresponding to the coverage area to be served by the wireless system (e.g., clutter information for the geographical area to be served by the wireless system) is inputted and/or stored in the planning and geodata server which may be, and in many embodiments is, part of the OSS of the wireless system. In some embodiments, the geographical information includes the coverage area to be served by the wireless system as well as additional geographical information for areas bordering the geographical area to be served by the wireless system. In some embodiments, step 1008 includes one or more sub-steps 1010 and 1012.

In sub-step 1010, geographical information corresponding to the coverage area of each of the wireless base stations of the wireless system (e.g., clutter information for the geographical area to be served by each of the wireless base stations of the wireless system) is inputted and/or stored in the planning and geodata server of the OSS of the wireless system. In some embodiments, the geographical information includes the coverage area to be served by the wireless base stations of the wireless system as well as additional geographical information for areas bordering the geographical area to be served by the wireless base stations of the wireless system.

In sub-step 1012, geographical information corresponding to the coverage area of the first wireless base station of the wireless system (e.g., clutter information for the geographical area to be served by the first wireless base station) is inputted and/or stored in the planning and geodata server of the OSS of the wireless system. In some embodiments, the geographical information includes the coverage area to be served by the first wireless base station as well as additional geographical information for areas bordering the geographical area to be served by the first wireless base station of the wireless system.

In various embodiments, the geographical information includes clutter information such as for example information identifying areas as including clutter of a particular category, classification, property and/or type.

In some embodiments, the clutter information includes terrain information and infrastructure information corresponding to the coverage area. In some embodiments, the clutter information includes information identifying types of clutter located within the coverage area (e.g., urban clutter type, urban streets clutter type, urban highways clutter type, open-non-vegetated clutter type, commercial-industrial clutter type, grassland-agriculture clutter type, forested clutter type, residential with trees clutter type, inland water clutter type). In some embodiments, the clutter information also includes an amount of the coverage area corresponding to each type of clutter located in the coverage area. Table 200 illustrates information mapping different types of clutter shown in column 202 of table 200 have been grouped and/or categorized into three broader clutter categories/types shown in column 204 of table 200. The map 1100 of FIG. 11 illustrates geographical information including clutter information. For example, the location of buildings illustrated as polygons in map 1100 is clutter information. FIG. 12 illustrates geographical information wherein the geographical areas/locations shown on the heat map 1200 have been classified by clutter properties/types. The title 1202 of the map 1200 is Base Station Locations, Device Locations, Buildings and Clutter Types. The legend 1300 for the heat map 1200 is shown in FIG. 13. FIG. 13 includes the title Clutter Types Legend 1302. The clutter class properties/types shown on map 1200 provide geographical information via color coding. Each location of the map 1200 has been coded to include one of a set of colors with each color representing a different clutter type corresponding to the location. The map 1200 including clutter properties/types being coded by color as shown in legend 1300 and include information showing the following clutter types: 0—no data available for classification of clutter type, 1—seawater clutter type, 2—inland water cluttery type, 3—herbaceous and non-herbaceous wetland clutter type, 4—open in urban clutter type, 5—open-non-vegetated clutter type, 6—grassland-agriculture, 7-railways, 8—surface streets, 9—highways, 10—airport, 11—forested, 12—rural, 13—residential with few trees, 14—residential with trees, 15—commercial-industrial, 16—urban, 17—dense urban, 18—core urban. In some embodiments, these 18 clutter properties/types are further categorized and/or grouped into three broader categories such as for example, urban clutter type, suburban clutter type and rural clutter type. In some embodiments, these 18 clutter properties/types are further categorized and/or grouped into three broader categories such as for example, urban clutter type, suburban clutter type and rural clutter type or four broader categories such as for example dense urban clutter type, urban clutter type, suburban clutter type and rural clutter type.

In some embodiments, the geographical information includes the LULC classification of reception point environments at individual locations in the coverage area as classified in terms of the codes used in the LULC database of the United States Geological Survey. In some embodiments, the geographical information includes clutter information for the coverage area of wireless system in the form of Land Use and Land Cover (LULC) classification information and/or the regrouping of the LULC classifications as Individual Location Longley-Rice (ILLR) Clutter Categories/Types information as described in the “Establishment of a Model for Predicting Digital Broadcast Television Field Strength Received at Individual Locations; Measurement Standards for Digital Television Signals Pursuant to the Satellite Home Viewer Extension Act of 2004”, DA/FCC #FCC-10-133, which includes the Appendix B “Proposed OET Bulletin No. 73” and was released Jul. 28, 2010 and adopted Jul. 28, 2010. The “Establishment of a Model for Predicting Digital Broadcast Television Field Strength Received at Individual Locations; Measurement Standards for Digital Television Signals Pursuant to the Satellite Home Viewer Extension Act of 2004”, DA/FCC #FCC-10-133 including its Appendix A, Appendix B, and Appendix C is incorporated herein by reference in its entirety. These ILLR clutter types may then be further re-grouped into three or four broader clutter categories/types for example, urban clutter type, suburban clutter type, and rural clutter type or dense urban clutter type, urban clutter type, suburban clutter type, and rural clutter type.

In some embodiments, the geographical information includes information from the National Land Cover Database of the United States Geological Survey and the Anderson Land Use/Land Cover Classifications. In some embodiments, the geographical information includes information from Global Land Use Coverage databases such as for example, the Sentinel-2 10 meter land use/land cover time series of the world produced by Impact Observatory and Esri. The clutter types from the Global Land Use Coverage databases are typically grouped in 10 or 11 classifications which can be further re-grouped into three or four broad clutter categories/types for example, urban clutter type, suburban clutter type, and rural clutter type or dense urban clutter type, urban clutter type, suburban clutter type, and rural clutter type.

In some embodiments, the rural type or category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of 4 dBm but less than or equal to 7 dBm.

In some embodiments, the suburban type or category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of greater than 7 dBm but less than or equal to 10 dBm.

In some embodiments, the urban type or category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of greater than 10 dBm but less than or equal to 14 dBm.

Signal fade margin is the difference between a radio receiver sensitivity and the actual signal level it receives measured in dBm and is expressed as the amount by which a signal level can decrease without causing system performance to drop below a predetermined (e.g., acceptable) threshold amount.

In some embodiments, the amount of the coverage area corresponding to each type of clutter located in the coverage area (e.g., for a base station) is expressed as a percentage for each type of clutter with respect to the total coverage area (e.g., a total coverage area includes 15% type 1 clutter, 20% type 2 clutter, 65% type 3 clutter which adds up to 100%. In some embodiments, the amount of the coverage area corresponding to each type of clutter located in the coverage area (e.g., for a base station) is determined by combining for each type of clutter the size of each portion of the coverage area classified as being of that clutter type.

Operation proceeds from step 1008 to step 1014. In step 1014, a plurality of sets of configuration parameters (e.g., operational configuration parameters) for use in configuring wireless base stations of the wireless system are stored for example in the OSS of the wireless system, e.g., in the performance parameter application server and/or network management server of the OSS. In some embodiments, step 1014 includes one or more sub-steps 1016, 1018, and 1020.

In sub-step 1016, a plurality of sets of configuration parameters for use in configuring wireless base stations is stored in server of the wireless system, e.g., in the performance parameter application server of the OSS. The plurality of sets of configuration parameters include two or more sets of configuration parameters such as for example, a first set of configuration parameters for use with base stations categorized and/or determined as being of a first base station type, a second set of configuration parameters for use with base stations categorized and/or determined as being of a second base station type, . . . , and a Nth set of configuration parameters for use with base stations categorized and/or determined as being of a Nth base station type, N being an integer greater than 2. FIG. 25 illustrates a table 2500 which includes three sets of base station configuration parameters for use in configuring wireless base stations based on the base station types: urban, suburban and rural. FIG. 26 illustrates a table 2600 which includes seven sets of base station configuration parameters for use in configuring wireless base stations based on the base station types: default, urban outdoor, urban indoor, suburban outdoor, suburban indoor, rural outdoor, and rural indoor. Tables 200, 2400, 2500, 2600 and/or table 2700 may be, and in some embodiments are stored in memory and/or of a server or system of the wireless network (e.g., network management system 114 and/or performance parameters application server 120 of the OSS 112 of system 100).

In sub-step 1018, a plurality of sets of configuration parameters for use in configuring wireless base stations of the wireless system are stored in the wireless system, e.g., in the OSS of the wireless system, the plurality of sets of configuration parameters including an urban set of configuration parameters, a suburban set of configuration parameters, and a rural set of configuration parameters. In some embodiments, the plurality of sets of configuration parameters includes a default set of configuration parameters.

In sub-step 1020, a set of default configuration parameters for use in configuring wireless base stations (e.g., used for configuring base stations which have just been activated and are categorized as being of default type, and/or whose base station type is uncategorized and/or yet to be categorized and/or whose base station type has been set to be of type default).

In some embodiments, the set of categories may include one or more subcategories such as for example, an urban category which includes sub-categories of indoor and outdoor.

Exemplary wireless base station configuration parameters include base station transmit power (e.g., maximum transmit power), UE/wireless device being serviced transmit power (e.g., UE/wireless device being serviced maximum transmit power), cell reselection/handover parameters, (e.g., hysteresis, minimum signal strength, and signal offset parameters), and antenna tilt.

Exemplary cell reselection and handover process and parameters are described in the ETSI TS 138 304 V16.1.0 (2020-07) 5G entitled “NR; User Equipment (UE) procedures in idle mode and in RRC Inactive state (3GPP TS 38.304 version 16.1.0 Release 16) which is incorporated herein by reference in its entirety. See for example, Section 5.2.3.2 Cell Selection Criterion, Section 5.2.4.2 Measurement rules for cell re-selection, and Section 5.2.4.6 Intra-frequency and equal priority inter-frequency Cell Reselection criteria of the ETSI TS 138 304 V16.1.0 technical specification.

Exemplary mobility parameters are described in the technical specification ETSI TS 138 331 V17.0.0 (2022-05) 5G; NR; Radio Resource Control (RRC); Protocol specification (3GPP TS 38.331 version 17.0.0 Release 17 which is herein incorporated by reference in its entirety. For example, see section 5.5.4 Measurement report triggering; section 5.5.4.4 Event A3 (Neighbour becomes offset better than SpCell); and section 5.5.4.6 Event A5 (SpCell becomes worse than threshold1 and neighbour becomes better than threshold2) of ETSI TS 138 331 V17.0.0 (2022-05) technical specification.

Operation proceeds from step 1014 via connection node A 1022 to step 1024 shown on FIG. 10B. In step 1024, one or more of the wireless base stations of the wireless system are configured and/or loaded with default configuration parameters (e.g., from the set of default configuration parameters). In some embodiments, step 1024 includes sub-step 1026. In sub-step 1026, the first wireless base station is configured and/or loaded with default configuration parameters (e.g., from the default set of configuration parameters. Table 2400 illustrates exemplary conventional, uniform, and/or default configuration parameters for a wireless base station. Row 26222 of table 2600 of FIG. 26 illustrates exemplary default configuration parameters for a wireless base station. In some embodiments, the OSS (e.g., the network management system 114 of the OSS) configures and/or loads the default configuration parameters into the one or more wireless base stations (e.g., by retrieving the default configuration parameters from storage (e.g., in the performance parameter application server)) and communicating the retrieved default configuration parameters to the one or more wireless base stations. In some embodiments, configuration instructions are included with the default configuration parameters communicated to the one or more wireless base stations. Operations proceed from step 1024 to step 1028.

In step 1028, wireless base stations of the wireless system are operated including one or more of the one or more wireless base stations configured and/or loaded with the default configuration parameters. These wireless base stations being operated using the default configuration parameters. In some embodiments, step 1028 includes sub-step 1030. In sub-step 1030, the first wireless base station is operated using the default configuration parameters. Operation proceeds from step 1028 to step 1032.

In step 1032, wireless device information (e.g., location information such as for example GPS coordinates, signaling strength information, signaling interference information, Received Signal Strength Indicator (RSSI) information, Reference Signal Received Quality (RSRQ) information, Reference Signal Received Power (RSRP) information, Reference Signal Interference Power (RSIP), Signal-to-Interference-plus_Noise Ratio (SINR) information, wireless service usage information (e.g., type of service provided and amount of bandwidth utilized) for wireless devices (e.g., user equipment devices (UEs)) being serviced by wireless base stations of the wireless system is collected (e.g., by the network management system 114 of the OSS 112). The wireless device information is collected for a first period of time. In some embodiments, the wireless devices (e.g., UEs) of the wireless system and/or base stations perform measurements and/or generate the wireless device information (e.g., generation of GPS coordinates, signaling measurements, wireless device type of service and bandwidth usage) which is communicated and/or reported to the OSS (e.g., Network Management System 114 of OSS 112 of system 100). In some embodiments, the wireless device information includes a wireless device identifier and a timestamp indicating which wireless device the information corresponds to and the time that the wireless device information was obtained, measured, and/or generated. In some embodiments, the wireless device information collected further indicates the base station providing services to the wireless device through which wireless device information was communicated to the OSS. The timestamp can be used to determine and/or correlate the wireless device information collected and the configuration parameters for each of the wireless base stations at the time it was obtained, measured, and/or generated. For example, one or more of the wireless base stations including the first wireless base station are operating using the set of default configuration parameters. In some embodiments, step 1032 includes one or more sub-steps 1034, 1036, 1038, and 1040.

In sub-step 1034, wireless device location information for wireless devices (e.g., UEs) being serviced by the wireless base stations of the wireless system is collected for example by the OSS 112 of the wireless system 100 (e.g., for a first period of time).

In sub-step 1036, the wireless device signaling information for wireless devices (e.g., UEs) being serviced by wireless base stations of the wireless system is collected (e.g., for a first period of time).

In sub-step 1038, wireless device location information for wireless devices (e.g., UEs) being serviced by the first wireless base station is collected (e.g., for a first period of time).

In sub-step 1038, wireless device signaling information for wireless devices (e.g., UEs) being serviced by the first wireless base station is collected (e.g., for a first period of time).

Operation proceeds from step 1032 to step 1042. In step 1042, information is collected from base stations, wireless devices (e.g., user equipment devices receiving wireless services, and performance metrics (e.g., key performance indicators (KPIs)) are generated, e.g., by the OSS, from the collected information for the wireless system. In some embodiments, step 1042 includes one or more sub-steps 1044 and 1046. In sub-step 1044, information is collected and performance metrics (e.g., KPIs) are generated using the collected information for wireless base stations of the wireless system. In sub-step 1044, information is collected and performance metrics (e.g., KPIs) are generated for the first wireless base station of the wireless system. One or more of the wireless base stations for which the performance metrics are generated are operating using the default configuration parameters. The first wireless base station for which performance metrics are generated is operating using the default configuration parameters. The performance metrics generated in step 1042 provide a performance base line for the performance of the wireless system and wireless devices (e.g., UEs) such as the first wireless base station which are operating using the set of default configuration parameters. The OSS 112 in various embodiments performs the collection and/or measurements of base station performance, collection and/or measurement of system performance data, generation of counters (e.g., counters for successful handovers, counters for failed handovers) and key performance indicator metrics (e.g., number of successful handovers, percentage of successful handovers, number of failed handovers, percentage of unsuccessful handovers, number of successful connections, signal metrics such as signal interference levels, RSSI, RSRP, RSRQ, RSIP, SINR, etc.) for base stations and the system, as well as collection of fault management information including alarms and critical triggers. In some embodiments, the collection of the information is performed by the performance data feedback collector server 122 which provides the collected information to the performance parameter application server 120 which generates the performance metrics (e.g., wireless base station performance metrics) and stores the generated performance metrics in its memory along with the wireless system configuration including the configuration of the wireless base stations. In some embodiments, the operations and/or functions of the performance parameter application server 120 and performance feedback collector server 122 are performed by the network management system 114 which collects information and generates the performance metrics (e.g., wireless system performance metrics including wireless base station performance metrics). Operation proceeds from step 1042 via connection node B 1048 to step 1050 shown on FIG. 10C.

In step 1050, the distribution of wireless devices (e.g., UEs) by location in the coverage area of the wireless system is determined from the collected wireless device information. In some embodiments step 1050 includes one or more sub-steps 1052, 1054, and 1056.

In sub-step 1052, the distribution of wireless devices in the coverage area of the wireless system is determined from location information collected from wireless devices (e.g., UEs) being serviced by the wireless base stations of the wireless system.

In sub-step 1054, the distribution of wireless devices (e.g., UEs) by location in the coverage area of each of the wireless base stations of the wireless system is determined from the wireless device location information collected from wireless devices (e.g., UEs) being serviced by the wireless base stations of the wireless system.

In sub-step 1056, the distribution of wireless devices (e.g., UEs) by location in the coverage area of the first wireless base station is determined from wireless device location information (e.g., reported GPS coordinates) collected from wireless devices (e.g., UEs) being serviced by the first wireless base station. In some embodiments sub-step 1056 includes one or more sub-steps 1058, 1060 and 1062. In sub-step 1058, the distribution of wireless devices (e.g., UEs) in the coverage area of the first wireless base station is determined and/or categorized using the inputted geographical information (e.g., clutter information) corresponding to wireless devices' locations (e.g., GPS coordinates) within the coverage area of the first wireless base station. In sub-step 1060, the distribution of wireless devices (e.g., UEs) by location as being indoors or outdoors in the coverage area of the first wireless base station is determined and/or categorized using the geographical information (e.g., clutter information including building location information) and the location information of the wireless devices' location within the coverage area of the first wireless device. In sub-step 1062, the distribution of wireless devices (e.g., UEs) by location in the coverage area of the first wireless base station is determined and/or categorized into the following categories/types: urban outdoor, urban indoor, suburban outdoor, suburban indoor, rural outdoor, rural indoor using the geographical information (e.g., clutter type corresponding to the location of the wireless devices (e.g., urban type, suburban type, rural type and building location information) and the location information of the wireless devices' location within the coverage area of the first wireless base station. Map 1100 of FIG. 11 illustrates the distribution of wireless devices (UEs) by location in the coverage area of the wireless system including base station location information, device location information and building information. Map 1200 of FIG. 12 illustrates the base station locations, wireless devices' (UEs′) locations/distribution, clutter types by location and building information by location. While 18 clutter types are shown as previously discussed these 18 clutter types are re-grouped into broader clutter categories/types such as for example, urban type, suburban type and rural type. The wireless devices shown as UEs can be determined as being outdoors or indoors based on the whether the mark representing the UE is within a building polygon (i.e., located indoors) such as UE 1108 or outside of a building polygon (i.e., located outdoors) such as for example UE 1110.

Operation proceeds from step 1050 via connection node C 1064 to step 1066 shown on FIG. 10D. In step 1066, signaling metrics by location are determined in the coverage area of the wireless system form the collected wireless device information and/or using propagation model(s).).

In some embodiments, the wireless device information is received from the wireless base stations at the network management system 114 which provides it to the planning and geodata server 116 which uses it to determine signaling metrics such as average RSRP value per location in the coverage area of the wireless system. In some embodiments, one or more propagation models are used in place of and/or in combination with the collected signaling information to determine the signaling metrics per location. For example, in some embodiments received signal strength at a location within a coverage area is determined using a propagation model, a base station's signaling frequency, transmission signal strength (e.g., max transmission signal strength), the signal loss or attenuation due to the distance the signal travels to the receiving location, and signal fade resulting from the clutter in the signaling path. The signal fade being determined using the geographical information inputted into the planning and geodata server (e.g., the clutter information—digital terrain properties, clutter height, building information, clutter type information corresponding to the transmission path, etc.). In some embodiments, the statistical calculation server 118 receives the information to generate the signaling metrics from the planning and geodata server 116 and performs the statistical calculations to generate the signaling metrics. Map 1900 of FIG. 19 illustrates base station coverage by signal strength (i.e., signal strength RSRP down link levels in dBm shown using different colors). Heat map 1900 is titled Base Station Coverage By Signal Strength 1902. FIG. 20 illustrates the base station coverage by signal strength legend for the map 1900 which is a heat map. A heat map is a graphical representation of data where values are depicted by color. In some embodiments, the downlink RSRP values measured and reported by the user equipment devices at the different locations in the coverage area are used in the map 1900 with the areas for which no measurements were collected being generated using a propagation model or models (e.g., a propagation model included in the planning and geodata server 116). The downlink RSRP levels may be determined as an average of the measured or reported levels. While the map 1900 is shown for RSRP down link levels, uplink signaling strength levels by location, RSSI, RSRQ, RSIP, SNIR metrics may be, and in some embodiments are, generated for locations within the coverage areas of the wireless base stations of the wireless system.

In some embodiments, step 1066 includes one or more sub-steps 1068, 1070 and 1071. In sub-step 1068, signaling metrics (signaling strength metrics, signaling interference metrics, RSRP metrics, RSSI metrics, RSRQ metrics, RSIP metrics, SNIR metrics) by location in the coverage area of the wireless system is determined (e.g., by the OSS 112) from the collected wireless device information and/or using propagation model(s). In sub-step 1070, signaling metrics (signaling strength metrics, signaling interference metrics, RSRP metrics, RSSI metrics, RSRQ metrics, RSIP metrics, SNIR metrics) by location in the coverage area of each of the wireless base stations is determined (e.g., by the OSS 112) from the collected wireless device signaling and location information collected and/or using propagation model(s). In sub-step 1071, signaling metrics (signaling strength metrics, signaling interference metrics, RSRP metrics, RSSI metrics, RSRQ metrics, RSIP metrics, SNIR metrics) by location in the coverage area of the first wireless base station is determined (e.g., by the OSS 112) from the collected wireless device signaling and location information collected by the first wireless base station and/or using propagation model(s). In some embodiments, the generated signaling metrics by location are used as wireless system and/or base station performance metrics (e.g., signaling interference metrics are used as a KPI for the wireless system's performance and efficiency in its use of spectrum).

Operation proceeds from step 1066 to step 1072. In step 1072, one or more wireless base stations of the wireless system have their wireless base station type determined and/or categorized, e.g. based on geographical information (e.g., clutter information) corresponding to a coverage area for the wireless base station whose wireless base station type is being determined and/or based on wireless device information for the wireless base station whose wireless base station type is being determined. In some embodiments, step 1072 is performed by the Network Management System of the OSS. In some embodiments, step 1072 includes one or more of the following sub-steps: sub-step 1073, sub-step 1074, and sub-step 1075.

In sub-step 1073, statistical analysis of the geographical information corresponding to the coverage area of the wireless base station for which a wireless base station type is to be determined is performed and based on the statistical analysis, the wireless base station type is determined from a set of wireless base station types (e.g., a wireless base station type 1, wireless base station type 2, . . . , wireless base station type N, N being an integer greater than 2). In some embodiments, the statistical analysis is performed by the statistical calculation server 118 with the results being provided to the network management system 114 which makes the wireless base station type decision based on the received statistical analysis results.

FIG. 21 illustrates statistical analysis results of base station A1, A2, A3, A4, A5, A6, A7, A8, A9, A10, and A11 by geographical information corresponding to each base station's coverage area (i.e., clutter type) and the determination of the wireless base stations' types based on the clutter type information corresponding to each base station's coverage area. The wireless base stations' types are determined from the set of the following wireless base station types: urban, suburban and rural. Wireless base stations A1, A2, A3, A10 and A11 are determined to be wireless base station type rural. Wireless base stations A4, A5, and A6 are determined to be wireless base station type urban. Wireless base stations A7, A8, and A9 are determined to be wireless base station type suburban.

In sub-step 1074, statistical analysis of information (e.g., geographical information and wireless device information) corresponding to the coverage area of the wireless base station for which a wireless base station type is to be determined is performed and based on the statistical analysis, the wireless base station type is determined from a set of wireless base station types (e.g., a wireless base station type 1, wireless base station type 2, . . . , wireless base station type N, N being an integer greater than 2). In some embodiments, the statistical analysis is performed by the statistical calculation server 118 with the results being provided to the network management system 114 which makes the wireless base station type decision based on the received statistical analysis results.

FIG. 22 illustrates statistical analysis results of base station A1, A2, A3, A4, A5, A6, A7, A8, A9, A10, and A11 by geographical information corresponding to each base station's coverage area (i.e., clutter type) and the location of wireless devices (e.g., UEs) within the base station's coverage (e.g., number or population density of wireless devices in each area classified according to a clutter type) as well as the determination of the wireless base stations' types based on the location of the wireless devices and the clutter type information corresponding to each base station's coverage area. The wireless base stations' types are determined from the set of the following wireless base station types: urban, suburban and rural. Wireless base stations A1, A2, A3, A10 and A11 are determined to be wireless base station type rural. Wireless base stations A4, A5, and A6 are determined to be wireless base station type urban. Wireless base stations A7, A8, and A9 are determined to be wireless base station type suburban.

In sub-step 1075, a wireless base station type is determined for the first wireless base station based on geographical information (e.g., clutter information) corresponding to the coverage area for the first wireless base station. In some embodiments, step 1075 includes sub-step 1076. In sub-step 1076, a wireless base station type for the first wireless base station is determined, from a set of wireless base station types, based on geographical information (e.g., clutter information) and wireless device information (e.g., location of wireless devices (e.g., UEs) corresponding to the coverage area for the first wireless base station.

In some embodiments, the set of wireless base station types include: urban wireless base station type, suburban wireless base station type, rural wireless base station type. In some embodiments, the set of wireless base stations consists of or consists essentially of the following wireless base station types: urban wireless base station type, suburban wireless base station type, rural wireless base station type. FIG. 23 illustrates table 2300 with urban, suburban, and rural wireless base station types. FIG. 25 illustrates table 2500 with urban, suburban, and rural wireless base station types. In some such embodiments, the set of wireless base station types also include a default base station type which is determined for a base station when there is insufficient information to determine a wireless base station type based on the currently information available. FIG. 26 illustrates a table 2600 with a default wireless base station type. FIGS. 23, 25, and 26 are explained in further detail below.

In some embodiments, the set of wireless base station types include: urban outdoor wireless base station type, urban indoor wireless base station type, suburban outdoor wireless base station type, suburban indoor wireless base station type, rural outdoor wireless base station type, rural indoor wireless base station type. In some embodiments, the set of wireless base stations consists of or consists essentially of the following wireless base station types: urban outdoor wireless base station type (also sometimes referred to herein as urban with predominately outdoor users wireless base station type (e.g., the highest number of wireless devices (e.g., UEs) serviced by the base station are outdoors and located at a geographical location indicated and/or classified as urban)), urban indoor wireless base station type (also sometimes referred to herein as urban with predominately indoor users wireless base station type (e.g., the highest number of wireless devices (e.g., UEs) serviced by the base station are indoors and located at a geographical location indicated and/or classified as urban)), suburban outdoor wireless base station type (also sometimes referred to herein as suburban with predominately outdoor users wireless base station type (e.g., the highest number of wireless devices (e.g., UEs) serviced by the base station are outdoors and located at a geographical location indicated and/or classified as suburban)), suburban indoor wireless base station type (also sometimes referred to herein as suburban with predominately indoor users wireless base station type (e.g., the highest number of wireless devices (e.g., UEs) serviced by the base station are indoors and located at a geographical location indicated as suburban)), rural outdoor wireless base station type (also sometimes referred to herein as rural with predominately outdoor users wireless base station type (e.g., the highest number of wireless devices (e.g., UEs) serviced by the base station are outdoors and located at a geographical location indicated and/or classified as rural), rural indoor wireless base station type (also sometimes referred to herein as rural with predominately indoor users wireless base station type (e.g., highest number of wireless devices (e.g., UEs) serviced by the base station are indoors and located at a geographical location indicated and/or classified as rural)). In some such embodiments, the set of wireless base station types also include a default base station type which is determined for a base station when there is insufficient information to determine a wireless base station type based on the current information available or the geographic information for the coverage area indicates that the coverage area is approximately or substantially equally divided between geographical types (e.g., 33⅓ urban, 33⅓ suburban, and 33⅓ rural) and/or with the wireless device population density also being approximately or substantially equally divided between geographic types. FIG. 26 illustrates a table 2600 with the following wireless base station types: default wireless base station type, urban outdoor wireless base station type, urban indoor wireless base station type, suburban outdoor wireless base station type, suburban indoor wireless base station type, rural outdoor wireless base station type, rural indoor wireless base station type.

Operation proceeds from step 1072 via connection node D 1077 to step 1078 shown on FIG. 10E.

In step 1078, a set of configuration parameters for one or more wireless base stations of the wireless system is determined based on the wireless base station's determined wireless base station type. In some embodiments, step 1078 includes one or more sub-steps 1079 and 1080. In sub-step 1079, a set of configuration parameters for one or more wireless base stations of the wireless system is determined from the plurality of stored sets of configuration parameters for use in configuring wireless base stations of the wireless system based on the wireless base station's determined wireless base station type. In sub-step 1080, a set of configuration parameters for the first wireless base station is determined from the plurality of stored sets of configuration parameters for use in configuring wireless base stations of the wireless system based on the first wireless base station's determined wireless base station type. In some embodiments, step 1078 is performed by the OSS (e.g., by the network management system of the OSS). Operation proceeds from step 1078 to step 1081.

In step 1081, the one or more wireless base stations of the wireless system are configured and/or loaded with configuration parameters from the determined set of configuration parameters determined for the particular wireless base station being configured and/or loaded. In some embodiments, step 1081 includes sub-step 1082. In sub-step 1082, the first wireless base station is configured and/or loaded with the set of determined configuration parameters for the first wireless base station. In some embodiments, the OSS (e.g., the network management system of the OSS) retrieves the stored set of configuration parameters from storage and uses them to configure and/or load the one or more wireless base stations (e.g., by sending instructions with the set of configuration parameters to the wireless base station being configured). Operation proceeds from step 1081 to step 1083.

In step 1083, the one or more wireless base stations of the wireless system whose configuration parameters were changed in step 1081 are operated using the configured and/or loaded set of configuration parameters. In some embodiment step 1083 includes sub-step 1084. In sub-step 1084, the first wireless base station is operated using the determined set of configuration parameters for the first wireless base station. Operation proceeds from step 1083 to step 1085.

In step 1085, information is collected and performance metrics (e.g., key performance indicators (KPIs)) for the wireless system are generated. In some embodiments, step 1085 includes one or more sub-steps 1086 and 1087. In sub-step 1086, information is collected and performance metrics (e.g., KPIs) are generated for wireless base station of the wireless system using the collected information. In sub-step 1087, information is collected and performance metrics (e.g., KPIs) are generated for the first wireless base station of the wireless system using the collected information.

In some embodiments step 1085 is the same as or similar to step 1042 but is being performed after step 1081 and 1083 wherein the one or more of the wireless base stations have been configured and operated using a determined set of configuration parameters. In step 1085, the same and/or similar performance metrics are generated to the those in step 1042. In some embodiments, step 1042 and 1085 are implemented using a routine that called in place of step 1042 and step 1085 in the flowchart. Operation proceeds from step 1085 via connection node 1088 to step 1090 shown on FIG. 10F.

In step 1090, the generated performance metrics (e.g., KPIs) for the wireless system which were generated in step 1085 are compared to the generated performance metrics for the wireless system which were generated in step 1042. In some embodiments step 1090 includes one or more sub-steps 1091 and 1092. In sub-step 1091, the performance metrics (e.g., KPIs) generated in sub-step 1086 for wireless base stations of the wireless system are compared to the performance metrics (e.g., KPIs) generated for the same wireless base stations in sub-step 1044 (i.e., performance metrics for the same base station are compared). In sub-step 1092, the performance metrics (e.g., KPIs) generated in sub-step 1087 for the first wireless base station are compared to the performance metrics (e.g., KPIs) generated for the first wireless base station in sub-step 1046. Operation proceeds from step 1090 to step 1093.

In step 1093, when the comparison of the performance metrics indicates worse performance by a wireless base station when operating using the determined set of configuration parameters based on the determined wireless base station type then when operating using the default set of configuration parameters, re-configuring the wireless base station to use the default set of configuration parameters. In some embodiments, step 1093 includes sub-step 1094. In sub-step 1094, when the comparison of the performance metrics indicates worse performance by the first wireless base station when operating using the determined set of configuration parameters for the first wireless base station then when operating using the default set of configuration parameters, re-configuring the first wireless base station to use the default set of configuration parameters. In some embodiments, step 1093 is performed by an OSS (e.g., by the decision tree server which makes the decision based on performance metrics with the network management system re-configuring the wireless base stations as determined by the decision tree server. Operation proceeds from step 1093 to step 1095.

In step 1095, a determination is made (e.g., by the OSS) as to whether: (i) a predetermined period of time (e.g., a month, 6 months, or a year) has elapsed or expired since one or more wireless base stations' configuration parameters (e.g., the first wireless base station configuration parameters) were configured based on the wireless base station's type, or (ii) if updated geographical information has been received. Step 1095 includes sub-steps 1096 and 1097.

When in sub-step 1096, the determination is yes that the predetermined period of time has elapsed or expired operation proceeds from step 1095 via connection node F 1098 to step 1032 wherein the method 1000 continues as previously described using the updated geographical information. When in sub-step 1096, the determination is yes that updated geographical information has been received operation proceeds from step 1095 via connection node F 1098 to step 1032 wherein the method 1000 continues as previously described using the updated geographical information.

When in sub-step 1097, the determination is no that the predetermined period of time has not elapsed or expired and that no updated geographical information has been received (e.g., by the OSS) then operation remains in step 1095. Step 1095 allows the wireless system to periodically check whether the wireless device information for the coverage area of wireless base stations of the wireless system has changed which can result in a change in the wireless base station's type resulting in a change in configuration parameters for the wireless base station. Step 1095 allows the wireless system to automatically determine whether wireless base station configuration parameters should be changed when updated geographical information indicates that the coverage area of the wireless base station has changed (e.g., new building has been built in the coverage area).

In various embodiments, the OSS continuously generates performance metrics and flags wireless base station's whose performance metrics indicate worse performance than the performance metrics determined from when the wireless base station was operating using the default set of configuration parameters. Once flagged, a wireless base station's configuration parameters can be automatically re-configured to the default set of configuration parameters and performance metrics can once again be generated. The new set of performance metrics using the default set of configuration parameters can then be compared to the original performance metrics using the default set of configuration parameters and to the performance parameters using the determined set of configuration parameters. The results of these comparisons can be used to determine if there is an issue and/or problem with the wireless base station and which set of configuration parameters (e.g., the default set or the determined set) should be used for the wireless base station (e.g., whichever set is providing the better performance metrics).

It should be understood that the operation(s), step(s), and function(s) described in connection with particular servers and/or systems of the OSS, may be implemented by network entities such as network equipment device(s), network service function(s) and/or other components or systems located either in the OSS or outside of the OSS such as for example in servers or nodes of a cloud system.

As previously discussed, FIG. 4 is a drawing of an exemplary wireless base station 400 in accordance with an exemplary embodiment. The wireless base station 400 may be, and in some embodiments is an eNodeB, gNodeB, or Citizens Broadband Radio Service Device (CBSD) 400, in accordance with an exemplary embodiment. Exemplary wireless base station 400 includes wireless interfaces 404, a network interface 405, e.g., a wired or optical interface, a processor 406, e.g., a CPU, an assembly of hardware components 408, e.g., an assembly of circuits, and I/O interface 410, and memory 412 coupled together via a bus 409 over which the various elements may interchange data and information. Wireless base station 400 further includes a speaker 452, a display 454, switches 456, keypad 458 and mouse 459 coupled to I/O interface 410, via which the various I/O devices (452, 454, 456, 458, 459) may communicate with other elements (404, 405, 406, 408, 412) of the wireless base station 400. Network interface 405 includes a receiver 478 and a transmitter 480. In some embodiments, receiver 478 and transmitter 480 are part of a transceiver 484. Wireless interfaces 404 include a plurality of wireless interfaces including first wireless interface 424, second wireless interface 450, . . . , Kth wireless interface 455, K being an integer greater than 2. The wireless interfaces are used to communicate with the wireless devices, e.g., user equipment device. The first wireless interface 424 is used for example to communicate with a first user equipment device using a first spectrum band. The second wireless interface can be used to communicate with a second user equipment device using a second spectrum band. The first wireless interface 424 includes wireless receiver 438 and a wireless transmitter 440. In some embodiments, receiver 438 and transmitter 440 are part of a transceiver. In various embodiments, the first wireless interface 424 includes a plurality of wireless receivers and a plurality of wireless transmitters. Wireless receiver 438 is coupled to a plurality of receive antennas (receive antenna 1 439, . . . , receive antenna M 441), via which wireless base station 400 can receive wireless signals from other wireless communications devices including a second wireless communications device, e.g., a user equipment device. Wireless transmitter 440 is coupled to a plurality of wireless transmit antennas (transmit antenna 1 443, . . . , transmit antenna N 445) via which the wireless base station 400 can transmit signals to other wireless communications devices including a second wireless communications device, e.g., a user equipment device.

The second wireless interface 450 includes wireless receiver 452 and a wireless transmitter 454. In some embodiments, receiver 452 and transmitter 454 are part of a transceiver. In various embodiments, the second wireless interface 450 includes a plurality of wireless receivers and a plurality of wireless transmitters. Wireless receiver 452 is coupled to one or more receive antennas (receive antenna 1 456, . . . , receive antenna M 457), via which wireless base station 400 can receive wireless signals from other wireless communications devices including a second wireless communications device, e.g., a UE device, using the same or a different wireless protocol than the first wireless interface. Wireless transmitter 454 is coupled to one or more wireless transmit antennas (transmit antenna 1 458, . . . , transmit antenna N 460) via which the wireless base station 400 can transmit signals to other wireless communications devices including a second wireless communications device, e.g., UE device. The wireless base station network interface 405 may be coupled to a cable modem, a core network, other networks, e.g., internet, or other wireless base stations. In some embodiments, the wireless base station 400 includes multiple network interfaces so that it can connect to multiple networks (e.g., a cable network and a core network) via the different interfaces.

Memory 412 includes an assembly of components 414, e.g., an assembly of software components, and data/information 416. Data/information 416 includes UE information 462 (e.g., wireless device information including location information and configuration parameters, session information, reporting signaling information, reported performance metrics) for the UE devices to which it is providing services, wireless base station operational information 464 (e.g., set of configuration parameters used for operating the wireless base station including for example base station transmit power level (e.g., max power level), user equipment device transmit power level (e.g., UE max transmission power level), cell reselection and/or handover parameters (e.g., hysteresis, minimum signal strength, signal offset), and antenna tilt information, spectrum information (e.g., spectrum such as CBRS spectrum to use for wireless communications with UE devices when the wireless base station is a CBRS wireless base station). The data/information 416 also includes wireless base station information and metrics (e.g., wireless base station performance metrics collected and reported to the OSS of the wireless system such as for example successful connections, failed connections, successful handovers, failed handovers, signaling information such as signaling interference information, etc.).

While the details of the first and second wireless interfaces are shown, the other wireless interfaces of the wireless base station, e.g., wireless interface K where K is an integer greater than 2 also include multiple receivers and transmitters so that the wireless base station 400 can provide wireless services to for example a plurality of wireless devices such as user equipment devices. In some embodiments, one or more of the wireless base stations discussed and/or shown in the Figures and/or in connection with the methods discussed herein are implemented in accordance with the wireless base station 400. For example, the wireless base stations of system 100 of FIG. 1 and the wireless base stations A1, A2, A3, A4, A5, A6, A7, A8, A9, A10, A11 referenced in FIGS. 11, 12, 14, 16, 18, 19, 21, and 22 may be, and in some embodiments are, implemented in accordance with the wireless base station 400.

As previously discussed, FIG. 5 is a drawing of an exemplary user equipment (UE) device 500 in accordance with an exemplary embodiment. UE device 500 is a wireless device such as for example a Customer Premises Equipment device, a mobile device, a cell phone, a smart phone, wireless tablet or wireless notebook. UE device 500 is a wireless device that is enabled to communicate with different wireless base stations utilizing wireless spectrum and/or wireless protocols, e.g., 5G wireless protocol, CBRS wireless protocol or cellular wireless protocol. Exemplary UE device 500 includes wireless interfaces 504, a network interface 505, a processor 506, e.g., a CPU, an assembly of hardware components 508, e.g., an assembly of circuits, and I/O interface 510, a GPS receiver 502 coupled to GPS receive antenna 507, a timer 511, e.g., a reference clock, a SIM card interface 570, and memory 512 coupled together via a bus 509 over which the various elements may interchange data and information. UE device 500 further includes a microphone 560, camera 561, speaker 562, a display 564, e.g., a touch screen display, switches 566, keypad 568 and mouse 569 coupled to I/O interface 510, via which the various I/O devices (560, 561, 562, 564, 566, 568, 569) may communicate with other elements (502, 504, 505, 506, 508, 512, 570) of the UE device. Network interface 505 includes a receiver 578 and a transmitter 580. The network interface 505 can be coupled to routers within the home or customer premises or to wired (e.g., cable) or optical (e.g., fiber-optic) networks. In some embodiments, receiver 578 and transmitter 580 are part of a transceiver 584.

Wireless interfaces 504 include a plurality of wireless interfaces including first wireless interface 536 and a second wireless interface 550. The first wireless interface 536 is, e.g., used to communicate with wireless base stations in a first service provider's communications network, e.g., cellular, e.g., gNB tower base stations of the first service provider's communications network, e.g., using a first set of spectrum and a first communications protocol corresponding to the first service provider. The second wireless interface 550 is, e.g., used to communicate with a device, e.g., a Wi-Fi Access Point, or in some embodiments a second service provider's communications network. The first wireless interface 536 includes wireless receiver 538 and a wireless transmitter 540. In some embodiments, receiver 538 and transmitter 540 are part of a transceiver. In various embodiments, the first wireless interface 536 includes a plurality of wireless receivers and a plurality of wireless transmitters. Wireless receiver 538 is coupled to a plurality of receive antennas (receive antenna 1 539, . . . , receive antenna M 541, M being an integer greater than 1), via which user equipment device 500 can receive wireless signals from other wireless communications devices including a wireless base station, e.g., a cellular wireless base station of the first service provider. Wireless transmitter 540 is coupled to a plurality of wireless transmit antennas (transmit antenna 1 543, . . . , transmit antenna N 545, N being an integer greater than 1) via which the user equipment device 500 can transmit signals to other wireless communications devices including a cellular wireless base station of the first service provider. The antennas 539, . . . , 541 and 543, . . . 545 are typically mounted inside the housing of the wireless device but in some embodiments are located outside the user equipment device housing. In some embodiments the various antennas form an antenna array with the antennas pointing in different directions. In some embodiments, one or more of the antennas are included inside the housing of the user equipment device and the user equipment device includes one or more connections to which exterior antennas may be connected.

The second wireless interface 550 includes wireless receiver 552 and a wireless transmitter 554. In some embodiments, receiver 552 and transmitter 554 are part of a transceiver. In various embodiments, the second wireless interface 550 includes a plurality of wireless receivers and a plurality of wireless transmitters. Wireless receiver 552 is coupled to one or more receive antennas (receive antenna 1 556, . . . , receive antenna M 557), via which user device 500 can receive wireless signals from other wireless communications devices including, e.g. a Wi-Fi access point or a base station of a second service provider. Wireless transmitter 554 is coupled to one or more wireless transmit antennas (transmit antenna 1 558, . . . , transmit antenna N 560) via which the user equipment device 500 can transmit signals to other wireless communications devices including, a Wi-Fi access point or another user equipment device. The user equipment device network interface 505 may be coupled to LAN or WAN networks or routers so that the user equipment device can also obtain services via a hardwired connection in addition to through the wireless interfaces, e.g. when the UE device 500 is at a location where such a connection is possible.

Memory 512 includes an assembly of components 514, e.g., an assembly of software components, and data/information 516. In some embodiments, the assembly of software components 514 includes a connection manager component 574. Data/information 516 includes service provider 1 subscription information 517, e.g. credentials and NAI realm information corresponding to wireless service provide 1. Data/information 516 further includes wireless service provider 1 spectrum information 519 (e.g., spectrum on which the wireless service provider 1 operates, UE location information (e.g., GPS coordinates received from the GPS receiver) 520, session information 521 (session type, session endpoint addresses), wireless device information (e.g., signaling information, location information, usage information, connection information, handover information, reselection information, performance metrics, information collected in response to requests from the OSS or base station), operational configuration parameters including configuration parameters received from the wireless base station to which it is connected such as for example, transmit power (e.g., maximum transmission power).

While the exemplary UE device 500 is enabled to communicate with different wireless systems using different wireless spectrum and/or protocols such as for example a cellular network base station and a Wi-Fi Access Point, the UE device 500 in some embodiments is operated and/or enabled to communicate using only a single wireless protocol such as for example 5G wireless protocol.

In some embodiments, the user equipment devices discussed in the Figures and/or in connection with the embodiments of the present invention are implemented in accordance with user equipment device 500. For example, UE 1 134, UE 2 136, UE 3 138, UE 4 140, UE 5 142, UE 6 144, UE 7 146, UE 8 148, UE 9 150, UE 10 152, . . . , UE X 154 in the system shown in FIG. 1 and UE 1 134, . . . , UE X 154 shown in FIG. 2 may be, and in some embodiments are, implemented in accordance with user equipment device 500.

As previously discussed, FIG. 6 is a drawing of an exemplary network equipment device, system, server or node, e.g., FIG. 6 illustrates details of an exemplary network equipment device, system, server or node, e.g., Operating Service Systems (OSS), Network Management System, Performance Parameter Application Server, Decision Tree Server, Planning and Geodata Server, Statistical Calculation Server, Performance Data Feedback Collector Server, core network system, in accordance with an embodiment of the present invention.

The network equipment device 600 includes a plurality of network interfaces 605, . . . , 690, e.g., a wired or optical interface, a processor(s) 606 (e.g., one or more processors), e.g., a CPU, an assembly of hardware components 608, e.g., an assembly of circuits, and I/O interface 610 and memory 612 coupled together via a bus 609 over which the various elements may interchange data and information. The network equipment device 600 further includes a speaker 652, a display 654, switches 656, keypad 658 and mouse 659 coupled to I/O interface 610, via which the various I/O devices (652, 654, 656, 658, 659) may communicate with other elements (605, . . . , 690, 606, 608, 612) of the network equipment device 600. Network interface 605 includes a receiver 678 and a transmitter 680. The network interface 605 is typically used to communicate with other devices, e.g., core network equipment, OSS, databases, wireless base stations, network management system, planning and geodata server, statistical calculation server, performance parameter application server, performance data feedback collector server, decision tree server, cloud system. In some embodiments, receiver 678 and transmitter 680 are part of a transceiver 684. Network interface 690 includes a receiver 694 and a transmitter 696. The network interface 690 is typically used to communicate with other devices, e.g., network nodes in a core, wireless base stations, OSS elements, cloud system, servers, etc. In some embodiments, receiver 694 and transmitter 696 are part of a transceiver 692. Memory 612 includes an assembly of component 614, e.g., an assembly of software components, and data/information 616. Data/information 616 includes UE (or wireless device) information 630, wireless base station information 632, base station category parameter information 634, performance parameter and metrics information 636, planning and geodata server information (e.g., propagation model(s) and geographical information including clutter information) 640, statistical information (e.g., information and/or analysis of clutter types, signaling information, user equipment location/density per coverage area per base station) 642. The specific information included in data/information 616 depends on the specific network equipment device implemented. For example, planning and geodata information such as clutter type per location for the wireless system's coverage area would be included if the network equipment device was a planning and geodata server but would not be included if the network equipment device was a decision tree server.

In some embodiments, the network equipment devices discussed in the Figures and/or in connection with the embodiments of the present invention described are implemented in accordance with network equipment device 600. For example, the OSS, the network management system, performance parameter application server, decision tree server, feedback collector server, planning and geodata server, statistical calculation server in FIG. 1, may be, and in some embodiments are, implemented in accordance with the network equipment device 600.

FIG. 7 is a drawing of an exemplary assembly of components 700 which may be included in an exemplary wireless base station (e.g., exemplary wireless base station 400 of FIG. 4), in accordance with an exemplary embodiment. The components in the assembly of components 700 can, and in some embodiments are, implemented fully in hardware within a processor, e.g., processor 406, e.g., as individual circuits. The components in the assembly of components 700 can, and in some embodiments are, implemented fully in hardware within the assembly of hardware components 408, e.g., as individual circuits corresponding to the different components. In other embodiments some of the components are implemented, e.g., as circuits, within processor 406 with other components being implemented, e.g., as circuits within assembly of components 408, external to and coupled to the processor 406. As should be appreciated the level of integration of components on the processor and/or with some components being external to the processor may be one of design choice. Alternatively, rather than being implemented as circuits, all or some of the components may be implemented in software and stored in the memory 412 of the wireless base station 400, with the components controlling operation of wireless base station device 400 to implement the functions corresponding to the components when the components are executed by a processor e.g., processor 406. In some such embodiments, the assembly of components 700 is included in the memory 412 as assembly of software components 414. In still other embodiments, various components in assembly of components 700 are implemented as a combination of hardware and software, e.g., with another circuit external to the processor providing input to the processor which then under software control operates to perform a portion of a component's function.

When implemented in software the components include code, which when executed by a processor, e.g., processor 406, configure the processor to implement the function corresponding to the component. In embodiments where the assembly of components 700 is stored in the memory 412, the memory 412 is a computer program product comprising a computer readable medium comprising code, e.g., individual code for each component, for causing at least one computer, e.g., processor 406, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 7 control and/or configure the wireless base station 400 or elements therein such as the processor 406, to perform the functions of corresponding steps illustrated and/or described in the method of one or more of the flowcharts, signaling diagrams and/or described with respect to any of the Figures. Thus the assembly of components 700 includes various components that perform functions of corresponding one or more described and/or illustrated steps of an exemplary method.

Assembly of components 700 includes a control routines component 702, a communications component 704, a message generator component 706, a message processing component 708, a determinator component 710, a storage component 712, an operation parameter configuration component 714, an information collection component 716, and a performance metrics generation component 718.

The control routines component 702 is configured to control operation of the wireless base station (e.g., gNodeB, eNodeB, or a CBSD).

The communication component 704 is configured to handle communications, e.g., transmission and reception of messages, and protocol signaling for the wireless base station (e.g., communications with user equipment devices and components, functions, devices, and servers in its core network and/or OSS).

The message generator component 706 is configured to generate messages for transmission to other devices, e.g., request messages, response messages, notification messages, messages for sharing information (e.g., performance metrics, UE location information), information (e.g., UE parameter configuration messages (e.g., spectrum channels to utilize and power transmission instructions such as maximum transmission power levels), communications messages with network equipment devices, communications messages with user equipment devices. In some embodiments, the message generator component 706 is a sub-component of the communications component 704.

The message processing component 708 is configured to process messages received from other devices and implement operations in response to instructions and/or information included in the processed message, e.g., processing and implementing operations in connection with messages from user equipment devices, messages from network equipment devices. In some embodiments, the message processing component 708 is a sub-component of the communications component 704.

The determinator component 710 is configured to make determinations and decisions for the wireless base station including for example: determining what configuration parameters to utilize when operating in response to configuration instructions such as utilize use set of rural configuration parameters and determining performance metrics.

The storage component 712 is configured to manage the storage, and retrieval of data and/or instructions to/and from memory, buffers in memory, hardware buffers and/or storage device coupled and/or connected to the wireless base station such as for example, operational configuration parameters received from a network management system.

The operational parameter configuration component 716 configures the wireless base station with configuration parameters (e.g., a set of operational configuration parameters) which are either received by the wireless base station or identified in a message received by the wireless base station.

The information collection component 716 collects information and/or performance metrics (e.g., reported UE location information, reported UE signaling information (e.g., RSSI, RSRP, RSRQ, SINR), base station signaling information (e.g., signaling interference measurements), KPIs for failed connections, successful connections, failed handovers, successful handovers).

The performance metrics generation component 718 generates performance metrics (KPIs for failed connections, successful connections, failed handovers, successful handovers) for the wireless base station while tracking the specific configuration parameters with which the wireless base station is operating and reporting the performance metrics to the OSS of the wireless system.

FIG. 8 is a drawing of an exemplary assembly of components 800 which may be included in an exemplary user equipment (UE) device, e.g., UE device 500 of FIG. 5, in accordance with an exemplary embodiment. The components in the assembly of components 800 can, and in some embodiments are, implemented fully in hardware within a processor, e.g., processor 506, e.g., as individual circuits. The components in the assembly of components 800 can, and in some embodiments are, implemented fully in hardware within the assembly of hardware components 508, e.g., as individual circuits corresponding to the different components. In other embodiments some of the components are implemented, e.g., as circuits, within processor 506 with other components being implemented, e.g., as circuits within assembly of components 508, external to and coupled to the processor 506. As should be appreciated the level of integration of components on the processor and/or with some components being external to the processor may be one of design choice. Alternatively, rather than being implemented as circuits, all or some of the components may be implemented in software and stored in the memory 512 of the UE device 500, with the components controlling operation of UE device 500 to implement the functions corresponding to the components when the components are executed by a processor e.g., processor 506. In some such embodiments, the assembly of components 800 is included in the memory 512 as assembly of software components 514. In still other embodiments, various components in assembly of components 800 are implemented as a combination of hardware and software, e.g., with another circuit external to the processor providing input to the processor which then under software control operates to perform a portion of a component's function. When implemented in software the components include code, which when executed by a processor, e.g., processor 506, configure the processor to implement the function corresponding to the component. In embodiments where the assembly of components 800 is stored in the memory 512, the memory 512 is a computer program product comprising a computer readable medium comprising code, e.g., individual code for each component, for causing at least one computer, e.g., processor 506, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 8 control and/or configure the UE device 500 or elements therein such as the processor 506, to perform the functions of corresponding steps illustrated and/or described in the method of one or more of the flowcharts, signaling diagrams and/or described with respect to any of the Figures. Thus the assembly of components 800 includes various components that perform functions of corresponding one or more described and/or illustrated steps of an exemplary method.

Assembly of components 800 includes a control routines component 802, a communications component 804, a message generator component 806, a message processing component 808, a determinator component 810, a SIM component 812, a wireless device information collection component 814, an operation parameters configuration component 816, a storage component 818, and a performance metrics generation component 820, and a location determination and reporting component 822.

The control routines component 802 is configured to control operation of the UE. The communications component 804 is configured to handle communications, e.g., receipt and transmission of signals and provide protocol signal processing for one or protocols for the UE. The message generator component 806 is configured to generate messages for transmission to wireless base stations (e.g., CBSD devices, gNodeBs, eNodeBs) such as messages including request and response messages, messages providing wireless device information (e.g., UE location information, signaling information (RSSI, RSRP, RSRQ, SINR), etc. In some embodiments, the message generator component 806 is a sub-component of the communications component 804. The message processing component 808 processes received messages, e.g., requests for information. In some embodiments, the message processing component 808 is a sub-component of the communications component 804. The determinator component 810 makes determinations for the UE such as to change transmission power levels in response to receiving configuration parameters with new transmission power levels.

The SIM component 812 is configured to store Subscriber Identity Information, e.g., a first set of credentials, for obtaining access to a first service provider/operator's wireless network. The wireless device information collection component 814 is configured to collect information on the UE (e.g., UE location information, signaling information (RSSI, RSRP, RSRQ, SINR), locations and times at which different wireless base station reference signals are received and the signal strength, changes in UE location by time, successful handovers between base stations, successful connections to a base station, failures when connecting to a base station). The operational parameters component 816 configures the UE to operate using operational parameters (e.g., maximum transmission power levels, spectrum channels, etc.) received from a wireless base station. The storage component 818 is configured to perform all operations in storing and retrieving information, e.g., credential information, location information, spectrum channel grant information and transmission power level instructions, session information, from memory and/or storage devices (e.g., SIMs) located in the user equipment device.

The performance metrics component 820 is configured to generate performance metrics for the user equipment device (e.g., successful handovers between base stations, successful connections to a base station, failures when connecting to a base station). The location determination and reporting component 822 determines a UEs location (e.g., GPS coordinates) and changes in location along with a timestamp, and/or signaling information and reports it to an OSS via a wireless base station. In some embodiments, the information is stored in the UE for a period of time (e.g., a day or week) and is then reported so as to reduce network traffic due to reporting. In some embodiments, the information is reported in response to a request from a wireless base station when the wireless network traffic is low.

FIG. 9 is a drawing of an exemplary assembly of components 900 which may be included in a network equipment device 600 of FIG. 6, in accordance with an exemplary embodiment. The components in the assembly of components 900 can, and in some embodiments are, implemented fully in hardware within a processor or one or more processors, e.g., processor(s) 606, e.g., as individual circuits. The components in the assembly of components 900 can, and in some embodiments are, implemented fully in hardware within the assembly of hardware components 608, e.g., as individual circuits corresponding to the different components. In other embodiments some of the components are implemented, e.g., as circuits, within processor(s) 606 with other components being implemented, e.g., as circuits within assembly of components 608, external to and coupled to the processor(s) 606. As should be appreciated the level of integration of components on the processor and/or with some components being external to the processor may be one of design choice. Alternatively, rather than being implemented as circuits, all or some of the components may be implemented in software and stored in the memory 612 of the network equipment device 600, with the components controlling operation of the network equipment device 600 to implement the functions corresponding to the components when the components are executed by a processor e.g., processor 606. In some such embodiments, the assembly of components 900 is included in the memory 612 as assembly of software components 614. In still other embodiments, various components in assembly of components 900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 606, configure the processor(s) to implement the function corresponding to the component. In embodiments where the assembly of components 900 is stored in the memory 612, the memory 612 is a computer program product comprising a computer readable medium comprising code, e.g., individual code for each component, for causing at least one computer, e.g., processor 606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 9 control and/or configure the network equipment device 600 or elements therein such as the processor(s) 606, to perform the functions of corresponding steps illustrated and/or described in the method of one or more of the flowcharts, signaling diagrams and/or described with respect to any of the Figures. Thus the assembly of components 900 includes various components that perform functions of corresponding one or more described and/or illustrated steps of an exemplary method.

Assembly of components 900 includes a control routines component 902, a communications component 904, a message generator component 906, a message processing component 908, a wireless base station configuration component 910, a determinator component 912, a storage component 914, an OSS component 916, a network management system component 918, a planning and geodata function component 920, a statistical calculation component 922, a performance parameter application component 924, a performance data feedback collector component 926, a decision tree component 928, a wireless base station type determinator component 930, and a coverage area type determinator component 932.

The control routines component 902 is configured to control operation of the network equipment device. The communication component 904 is configured to handle communications, e.g., transmission and reception of messages, and protocol signaling for the network equipment device. The message generator component 906 is configured to generate messages for transmission to other devices. Exemplary messages which are generated include wireless base station configuration parameter instructions, requests to collect information and performance metrics, messages to share information (e.g., wireless device information, geographical information, signaling information, performance metrics, wireless base station performance metrics, UE device performance metrics). The message processing component 908 is configured to process messages and implement procedures/operations in response to messages or based on the contents of messages. This includes messages received from other devices, e.g., messages from UEs, wireless base stations, core network, OSS, geographical mapping databases, network management system, planning and geodata server, statistical calculation server, performance parameter application server, performance data feedback collector server, decision tree server.

The wireless base station configuration component 910 performs operations for determining a set of configuration parameters for a wireless base station and configuring the base station to operate using the set of configuration parameters including loading, installing and/or sending messages and/or instructions with the configuration parameters to the wireless base station to install and/or load the configuration parameters for use.

The determinator component 912 is configured to make determinations and decisions for the network equipment device including for example: determining a wireless base station's type from a set of wireless base station types, determining a wireless base station's type from geographical information corresponding the coverage area of the wireless base station and/or wireless device information corresponding to the wireless base station coverage area, determining a coverage area type for a wireless base station's coverage area, determining a set of operational configuration parameters for a wireless base station based on the determined wireless base station type and/or determined wireless base station coverage area type.

The storage component 914 is configured to manage the storage, and retrieval of data and/or instructions to/and from memory, and/or storage devices coupled and/or connected to the network equipment device, e.g., storage and retrieval of geographical information, wireless device information including for example (UE location information with time stamps, propagation models, performance metrics, information reported from user equipment devices and wireless base stations, wireless base station type determination, wireless base station coverage area determinations, sets of wireless base station configuration parameters.

The OSS component 916 is configured to provide OSS services to a wireless system including for example, network management services, planning and geodata services, statistical calculation services, performance parameter application services, performance data feedback collector services, decision tree services, information collection services, generation of performance metrics for the wireless system including individual wireless base station, determination of operational configuration parameters for wireless base stations and user equipment devices (e.g., transmission power limits). The OSS component also performs the functions and/or operations described in connection with the OSS 112 of system 100 disclosed herein.

The network management system component 918 manages the wireless system including determining wireless base station configuration parameters for wireless base station of the wireless and configuring the wireless base station via installing, loading and/or sending instructions to the wireless base station to configure itself using the provided and/or identified wireless base station configuration parameters. The network management component also performs the functions and/or operations described herein with respect to the network management system 114 of system 100 and/or methods 300 and 1000.

The planning and geodata component 920 receives and processes wireless base station location information, geographical information/data including clutter information for a coverage area of one or more wireless base stations, generates heat maps correlates areas with the clutter information, generates maps with building locations. The planning and geodata component 920 also performs the functions and/or operations described herein with respect to the planning and geodata server 116 of system 100 and/or methods 300 and 1000.

The statistical calculation component 922 receives geographical information/data and/or wireless device information/data corresponding to an area for example a wireless base station's coverage area performs statistical analysis on the received information/data such as for example shown in FIGS. 21 and 22. The statistical calculation component 922 also performs the functions and/or operations described herein with respect to the statistical calculation server 118 of system 100 and/or methods 300 and 1000.

The performance parameter application component 924 stores and maintains the performance parameters and performance metrics for wireless base stations along with the wireless base station configuration parameters corresponding to the performance metrics. The performance parameter application component 924 also stores a plurality of sets of wireless base station configuration parameters and the wireless base station type and/or wireless base station coverage area type to which each set of the wireless base configuration parameters corresponds. The performance parameter application component 924 also performs the functions and/or operations described herein with respect to the performance data feedback collector server 122 of system 100 and/or methods 300 and 1000.

The performance data feedback collector component 926 collects information and data including performance data and metrics from user equipment devices and wireless base stations via the network management system while the wireless base stations are configured with different wireless base station configuration parameters (e.g., default set of wireless base station configuration parameters, urban set of wireless base station configuration parameters, suburban set of wireless base station configuration parameters, rural set of wireless base station configuration parameters). The performance data feedback collector component 924 also generates performance metrics (e.g., KPIs from the collected data and information). The performance data feedback collector component 926 also performs the functions and/or operations described herein with respect to the performance data feedback collector server 122 of system 100 and/or methods 300 or 1000.

The decision tree component 928 determines with to utilize default configuration parameters or a determined set of configuration parameters for a wireless base station based on performance metrics collected in connection with the operation of the wireless base station. The decision tree component 928 also performs the functions and/or operations described herein with respect to the decision tree server 124 of system 100 and/or method 1000. In some embodiments, the decision tree component 928 is a sub-component of the determinator component 912.

The wireless base station type determinator component 930 determines a wireless base station's type for example from a set of wireless base station types based on geographical information and/or wireless device information. In some embodiments, the wireless base station type determinator component 930 is a sub-component of the determinator component 912.

The coverage area type determinator component 932 determines a coverage area type for a coverage area corresponding to a wireless base station for example based on geographical information and/or wireless device information corresponding the coverage area. In some embodiments, the coverage type determinator component 932 is a sub-component of the determinator component 912.

The specific components of the assembly of components 900 included in any particular network equipment device may, and typically does vary depending on the specific network equipment device and the functionality required for the device and/or the operations the network equipment device is responsible for performing.

Various exemplary numbered embodiments illustrating different features of the present invention will now be discussed. The various features discussed may be used in variety of different combinations. It should be appreciated that not necessarily all embodiments include the same features and some of the features described below are not necessary but can be desirable in some embodiments. The numbered embodiments are only exemplary and are not meant to be limiting to the scope of the invention. The various method embodiments may be, and in some embodiments are, implemented on system 100 of FIG. 1.

### LIST OF EXEMPLARY NUMBERED METHOD EMBODIMENTS

Method Embodiment 1. A method comprising: determining a wireless base station type for a first wireless base station based on geographical information corresponding to a coverage area of the first wireless base station; determining a set of operational configuration parameters for the first wireless base station based on the determined wireless base station type; and configuring the first wireless base station using said determined set of operational configuration parameters.

Method Embodiment 1A2. The method of Method Embodiment 1, wherein said geographical information includes clutter information corresponding to the coverage area of the first wireless base station, said clutter information including terrain information (e.g., elevation and type of terrain such open land, dessert, forest, trees, vegetation, water bodies (e.g., rivers, lakes, streams, ocean), farmland, cliffs, rangeland, snow, ice, etc.) and infrastructure information (e.g., information (e.g., dimensions and/or materials from which infrastructure constructed) on buildings, water towers, bridges, dams, canals, walls, roads, highways, street lamps, etc. located in the coverage area).

Method Embodiment 1A3. The method of Method Embodiment 1, wherein said geographical information includes clutter information corresponding to the coverage area of the first wireless base station, said clutter information including clutter properties corresponding to different portions and/or locations within the coverage area.

Method Embodiment 1A4. The method of Method Embodiment 1, wherein said geographical information includes clutter information corresponding to the coverage area of the first wireless base station, said clutter information including information identifying different locations within the coverage area as corresponding to a particular clutter type from a plurality of clutter types.

Method Embodiment 1A5. The method of Method Embodiment 1A2, 1A3, or 1A4, wherein determining a wireless base station type for a first wireless base station based on geographical information corresponding to the coverage area of the first wireless base station includes: using the clutter information to determine the wireless base station type from a set of wireless base station types.

Method Embodiment 1A6. The method of Method Embodiment 1A5, wherein said set of wireless base station types includes: an urban type, a suburban type and a rural type.

Method Embodiment 1A7. The method of Method Embodiment 1A5, wherein said set of wireless base station types includes: a default type, an urban type, a suburban type and a rural type.

Method Embodiment 1A8. The method of Method Embodiment 1, wherein said determining a wireless base station type for a first wireless base station based on geographical information corresponding to the coverage area of the first wireless base station includes: using the geographical information to determine the wireless base station type from a set of wireless base station types.

Method Embodiment 1A9. The Method Embodiment of Method Embodiment 1A8, wherein said set of wireless base station types include the following types: urban type, suburban type and rural type.

Method Embodiment 1A10. The method of Method Embodiment 1A8, wherein said set of wireless base station types consists essentially of the following types: urban type, suburban type and rural type.

Method Embodiment 1A11. The method of Method Embodiment 1A8, wherein said set of wireless base station types consists of the following types: urban type, suburban type and rural type.

Method Embodiment 1A12. The method of Method Embodiment 1A8, wherein said set of wireless base station types include the following types: default type, urban type, suburban type and rural type.

Method Embodiment 1A13. The method of Method Embodiment 1A8, wherein said set of wireless base station types consists essentially of the following types: default type, urban type, suburban type and rural type.

Method Embodiment 1A14. The method of Method Embodiment 1A8, wherein said set of wireless base station types consists of the following types: default type, urban type, suburban type and rural type.

Method Embodiment 1A15. The method of Method Embodiment 1, 1A2, 1A3, 1A4, 1A5, 1A6, 1A7, 1A8, 1A9, 1A10, 1A11, 1A12, 1A13, or 1A14, wherein said determining a set of operational configuration parameters for the first wireless base station based on the determined wireless base station type includes: determining a set of operational configuration parameters for the first wireless base station from a plurality of sets of wireless base station operational configuration parameters.

Method Embodiment 1A16. The method of Method Embodiment A15, wherein the plurality of sets of operational configuration parameters includes: a set of urban wireless base station operational configuration parameters, a set of suburban wireless base station operational configuration parameters, and a set of rural wireless base station operational configuration parameters.

Method Embodiment 1A17. The method of Method Embodiment 1A16, wherein the plurality of sets of operational configuration parameters further includes a set of default wireless base station configuration parameters.

Method Embodiment 1A18. The method of Method Embodiment 1A16 or 1A17, wherein said determining a set of operational configuration parameters for the first wireless base station from a plurality of sets of wireless base station operational configuration parameters includes: determining for the first wireless base station the set of urban wireless base station operational configuration parameters in response to determining that the first wireless base station type is urban type.

Method Embodiment 1A19. The method of Method Embodiment 1A16 or 1A17, wherein said determining a set of operational configuration parameters for the first wireless base station from a plurality of sets of wireless base station operational configuration parameters includes: determining for the first wireless base station the set of suburban wireless base station operational configuration parameters in response to determining that the first wireless base station type is suburban type.

Method Embodiment 1A20. The method of Method Embodiment 1A16 or 1A17, wherein said determining a set of operational configuration parameters for the first wireless base station from a plurality of sets of wireless base station operational configuration parameters includes: determining for the first wireless base station the set of rural wireless base station operational configuration parameters in response to determining that the first wireless base station type is rural type.

Method Embodiment 1A21. The method of Method Embodiment 1A16 or 1A17, wherein said determining a set of operational configuration parameters for the first wireless base station from a plurality of sets of wireless base station operational configuration parameters includes: determining for the first wireless base station the set of default wireless base station operational configuration parameters in response to determining that the first wireless base station type is default type.

Method Embodiment 1A22. The method of Method Embodiment 1, wherein said determining a set of operational configuration parameters for the first wireless base station is further based on wireless device (UE) information (e.g., wireless device location information such as the number of wireless devices being serviced by the first wireless base station in the first wireless base station coverage area being inside a building or outside of a building) corresponding to the coverage area of the first wireless base station; and wherein said determining a set of operational configuration parameters for the first wireless base station includes: determining a set of operational configuration parameters for the first wireless base station from a plurality of sets of wireless base station operational configuration parameters.

Method Embodiment 1A23. The method of Method Embodiment 1A22, wherein the plurality of sets of operational configuration parameters includes: a set of urban outdoor wireless base station operational configuration parameters (e.g., for wireless base station's with a majority of wireless devices being serviced not located within a building within a coverage area determined to be of urban type), a set of urban indoor wireless base station operational configuration parameters (e.g., for wireless base station's with a majority of wireless devices being serviced located within a building within a coverage area determined to be of urban type), a set of suburban outdoor wireless base station operational configuration parameters (e.g., for wireless base station's with a majority of wireless devices being serviced not located within a building within a coverage area determined to be of suburban type), a set of suburban indoor wireless base station operational configuration parameters (e.g., for wireless base station's with a majority of wireless devices being serviced located within a building within a coverage area determined to be of suburban type), a set of rural outdoor wireless base station operational configuration parameters (e.g., for wireless base station's with a majority of wireless devices being serviced not located within a building within a coverage area determined to be of rural type), and a set of rural indoor wireless base station operational configuration parameters (e.g., for wireless base station's with a majority of wireless devices being serviced not located within a building within a coverage area determined to be of rural type).

Method Embodiment 1A24. The method of Method Embodiment 1A23, wherein the plurality of sets of operational configuration parameters further includes a set of default wireless base station configuration parameters (e.g., for a wireless base station whose coverage area type is unknown or whose coverage area is approximately equally made of urban, suburban and rural locations).

Method Embodiment 1A25. The method of Method Embodiment 1A23, wherein said set of wireless base station types include the following types: urban outdoor type, urban indoor type, suburban outdoor type, suburban indoor type, rural outdoor type, rural indoor type.

Method Embodiment 1A26. The method of Method Embodiment 1A23, wherein said set of wireless base station types consists essentially of the following types: urban outdoor type, urban indoor type, suburban outdoor type, suburban indoor type, rural outdoor type, rural indoor type.

Method Embodiment 1A27. The method of Method Embodiment 1A23, wherein said set of wireless base station types consists of the following types: urban outdoor type, urban indoor type, suburban outdoor type, suburban indoor type, rural outdoor type, rural indoor type.

Method Embodiment 1A28. The method of Method Embodiment 1A24, wherein said set of wireless base station types include the following types: default type, urban outdoor type, urban indoor type, suburban outdoor type, suburban indoor type, rural outdoor type, rural indoor type.

Method Embodiment 1A29. The method of Method Embodiment 1A24, wherein said set of wireless base station types consists essentially of the following types: default type, urban type, suburban type and rural type.

Method Embodiment 1A30. The method of Method Embodiment 1A24, wherein said set of wireless base station types consists of the following types: default type, urban outdoor type, urban indoor type, suburban outdoor type, suburban indoor type, rural outdoor type, rural indoor type.

Method Embodiment 1A31. The method of Method Embodiment 1A22, further comprising: operating the first wireless base station using a set of default wireless base station configuration parameters, prior to determining the wireless base station type for the first wireless base station based on geographical information corresponding to the coverage area of the first wireless base station; collecting said wireless device information while operating the first wireless base station using the set of default wireless base station configuration parameters, said set of wireless device information including location information for the wireless devices being serviced by the first wireless base station; determining a geographical type from a set of geographical types (e.g., urban type, suburban type, rural type) in which a highest number of wireless devices serviced by the first wireless base station are located; and determining the wireless base station type based on said determined geographical type (e.g., determine urban wireless base station type based on a determination that the highest number of wireless devices being serviced by the first wireless base station are located in areas of urban type regardless of percentage of the coverage area being of type of urban; determine suburban wireless base station type based on a determination that the highest number of wireless devices being serviced by the first wireless base station are located in areas of suburban type regardless of percentage of the coverage area being of type of suburban; determine rural wireless base station type based on a determination that the highest number of wireless devices being serviced by the first wireless base station are located in areas of rural type regardless of percentage of the coverage area being of type of rural).

Method Embodiment 1A32. The method of Method Embodiment 1A31, wherein the plurality of sets of operational configuration parameters includes: a set of urban wireless base station operational configuration parameters (e.g., for wireless base station's with the highest number of wireless devices being serviced within a coverage area determined to be of urban type), a set of suburban wireless base station operational configuration parameters (e.g., for wireless base station's with the highest number of wireless devices being serviced within a coverage area determined to be of suburban type), a set of rural wireless base station operational configuration parameters (e.g., for wireless base station's with the highest number of wireless devices being serviced located within a coverage area determined to be of rural type).

Method Embodiment 1A33. The method of Method Embodiment 1A22, further comprising: operating the first wireless base station using a set of default wireless base station configuration parameters, prior to determining the wireless base station type for the first wireless base station based on geographical information corresponding to the coverage area of the first wireless base station; collecting said wireless device information while operating the first wireless base station using the set of default wireless base station configuration parameters, said set of wireless device information including location information for the wireless devices being serviced by the first wireless base station; determining a geographical type from a set of geographical types (e.g., urban outdoor type, urban indoor type, suburban outdoor type, suburban indoor type, rural outdoor type, rural indoor type) in which a highest number of wireless devices serviced by the first wireless base station are located; and determining the wireless base station type based on said determined geographical type (e.g., determine urban outdoor wireless base station type based on a determination that the highest number of wireless devices being serviced by the first wireless base station are located in areas of urban type outside of buildings regardless of the percentage of the coverage area being of type of urban; determine urban indoor wireless base station type based on a determination that the highest number of wireless devices being serviced by the first wireless base station are located in areas of urban type inside of buildings regardless of the percentage of the coverage area being of type of urban; determine suburban outdoor wireless base station type based on a determination that the highest number of wireless devices being serviced by the first wireless base station are located in areas of suburban type outside of buildings regardless of the percentage of the coverage area being of type of suburban; determine suburban indoor wireless base station type based on a determination that the highest number of wireless devices being serviced by the first wireless base station are located in areas of suburban type inside of buildings regardless of the percentage of the coverage area being of type of suburban; determine rural outdoor wireless base station type based on a determination that the highest number of wireless devices being serviced by the first wireless base station are located in areas of rural type outside of buildings regardless of the percentage of the coverage area being of type of rural; determine rural indoor wireless base station type based on a determination that the highest number of wireless devices being serviced by the first wireless base station are located in areas of rural type inside of buildings regardless of the percentage of the coverage area being of type of rural).

Method Embodiment 1A34. The method of Method Embodiment 1A33, wherein the plurality of sets of operational configuration parameters includes: a set of urban outdoor wireless base station operational configuration parameters (e.g., for wireless base station's with the highest number of wireless devices being serviced not located within a building within a coverage area determined to be of urban type), a set of urban indoor wireless base station operational configuration parameters (e.g., for wireless base station's with the highest number of wireless devices being serviced located within a building within a coverage area determined to be of urban type), a set of suburban outdoor wireless base station operational configuration parameters (e.g., for wireless base station's with the highest number of wireless devices being serviced not located within a building within a coverage area determined to be of suburban type), a set of suburban indoor wireless base station operational configuration parameters (e.g., for wireless base station's with the highest number of wireless devices being serviced located within a building within a coverage area determined to be of suburban type), a set of rural outdoor wireless base station operational configuration parameters (e.g., for wireless base station's with the highest number of wireless devices being serviced not located within a building within a coverage area determined to be of rural type), and a set of rural indoor wireless base station operational configuration parameters (e.g., for wireless base station's with the highest number of wireless devices being serviced not located within a building within a coverage area determined to be of rural type).

Method Embodiment 1A35. The method of Method Embodiment 1A33 and 134, further comprising: generating wireless base station performance metrics for the first wireless base station while operating the first wireless base station using the default operational configuration parameters; subsequent to configuring the first wireless base station using said determined set of operational configuration parameters, operating said first wireless base station using the determined set of operational configuration parameters; generating wireless base station performance metrics for the first wireless base station while operating the first wireless base station using the determined set of operational configuration parameters; comparing the wireless base station performance metrics for the first wireless base station generated while operating the first wireless base station using the determined set of operational configuration parameters to the wireless base station performance metrics while operating the first wireless base station using the default operational configuration parameters; and determining based on the comparison of the performance metrics whether to re-configure the first wireless base station to utilize the default set of operational configuration parameters or to continue to utilize the determined set of operational configuration parameters.

Method Embodiment 1A36. The method of Method Embodiment 1A35, wherein said determining based on the comparison of the performance metrics whether to re-configure the first wireless base station to utilize the default set of operational configuration parameters or to continue to utilize the determined set of operational configuration parameters includes: determining to re-configure the first wireless base station to utilize the default set of operational configuration parameters when the comparison of the performance metrics indicates better performance by the first wireless base station when operating using the set of default configuration parameters.

Method Embodiment 1A37. The method of Method Embodiment 1A36, wherein said determining based on the comparison of the performance metrics whether to re-configure the first wireless base station to utilize the default set of operational configuration parameters or to continue to utilize the determined set of operational configuration parameters includes: determining to continue to utilize the determined set of operational configuration parameters for the first wireless base station when the comparison of the performance metrics indicates better performance by the first wireless base station when operating using the determined set of operational configuration parameters.

Method Embodiment 1A38. The method of Method Embodiment 1A37, wherein said performance metrics include one or more of the following: number of successfully handovers, number of failed handovers, percentage of successful handovers out of total handover attempts, percentage of failed handovers out of total handover attempts, number of successful connections, number of failed connections, percentage of successful connections out of total connection attempts, percentage of failed connections out of total connection attempts, percentage of dropped connections, number of dropped connections.

Method Embodiment 1A39. The method of Method Embodiment 1A38, wherein the set of operational configuration parameters include: transmission power levels for the wireless base station, transmit power levels for wireless devices being serviced by the wireless base station, base station and/or cell reselection parameters (e.g., hysteresis, minimal signal strength, signal offset), base station and/or cell handover parameters (e.g., hysteresis, minimal signal strength, signal offset), and antenna tilt.

Method Embodiment 1A40. The method of Method Embodiment 1, further comprising: receiving updated geographical information corresponding to the coverage area of the first wireless base station; determining a wireless base station type for the first wireless base station based on the updated geographical information corresponding to the coverage area of the first wireless base station; determining an updated set of operational configuration parameters for the first wireless base station based on the determined wireless base station type for the first wireless base station based on the updated geographical information corresponding to the coverage area of the first wireless base station; and configuring the first wireless base station using said determined updated set of operational configuration parameters.

Method Embodiment 1A41. The method of Method Embodiment 1A1-1A40, wherein said steps of the method are performed by an OSS.

Method Embodiment 1A42. The method of Method Embodiment 1A41, wherein one or more steps of the method are performed by a Network Management System of the OSS.

Method Embodiment 1A43. The method of Method Embodiment 1A1-1A40, wherein the steps of the method are performed by a Network Management System.

Method Embodiment 1A44. The method of Method Embodiment 1A43, wherein the Network Management System is located in a cloud system.

Method Embodiment 1A45. The method of Method Embodiment 1A1-1A44, wherein the first wireless base station is part of a wireless system including a plurality of wireless base stations; and wherein the method is repeated for one or more additional wireless base stations of the plurality of wireless base stations of the wireless system, the method further including: determining for each of the additional wireless base stations a wireless base station type based on geographical information corresponding to a coverage area for the particular additional wireless base station; determining a set of operational configuration parameters for each of the additional wireless base stations based on the determined wireless base station type of the particular additional wireless base station; and configuring each additional wireless base station using said determined set of operational configuration parameters for the particular additional wireless base station.

Method Embodiment 1AA. The method of Method Embodiment 1, further comprising: prior to determining the wireless base station type for the first wireless base station, configuring and operating the first wireless base station using a default set of operational configuration parameters, said default set of operation configuration parameters not being based on geographical information corresponding to the coverage area of the first wireless base station.

Method Embodiment 1AA1. The method of Method Embodiment 1, further comprising: collecting over a first period of time, by the first wireless base station while operating using said default set of configuration parameters, user equipment device location information for user equipment devices which connect to the first wireless base station; reporting, by the first wireless base station, said collected user equipment device location information to a network management system of a wireless network to which the first wireless base station belongs.

Method Embodiment 1AA2. The method of Method Embodiment 1, wherein the coverage area of the first wireless base station is a geographical area in which the first wireless base station provides wireless services in response to requests from wireless devices (e.g., user equipment devices).

Method Embodiment 1AA3. The method of Method Embodiment 1, wherein the coverage area of the first wireless base station is a geographical area which is determined based on one or more of the following: (i) location information identifying geographical coordinates for the location of the first wireless base station, (ii) information provided by a propagation model, (iii) information provided by wireless devices to which the first wireless base station has provided wireless services (e.g., user equipment devices which report their Global Position System (GPS) coordinates).

Method Embodiment 1AA4. The method of Method Embodiment 1AA3, wherein the information provided by a propagation model is information predicting the geographical area in which the first wireless base station will be able to provide wireless services to wireless devices (e.g., using a signaling frequency or band of frequencies available to the first wireless base station for communicating with wireless devices).

Method Embodiment 1B. The method of Method Embodiment 1, wherein the geographical information corresponding to the coverage area of the first wireless base station includes clutter information.

Method Embodiment 1C. The method of Method Embodiment 1B, wherein said determining a wireless base station type for a first wireless base station based on geographical information corresponding to a coverage area of the first wireless base station includes: categorizing the coverage area of the first wireless base station based on the geographical information corresponding to the coverage area of the first wireless base station; and determining the first wireless base station type based on the results of the categorization of the coverage area of the first wireless base station.

Method Embodiment 1D. The method of Method Embodiment 1C, wherein categorizing the coverage area of the first wireless base station based on geographical information corresponding to the coverage area of the first wireless base station includes: determining a category from a set of categories to which the coverage area of the first wireless base station belongs, said set of categories including: urban category, suburban category, and rural category.

Method Embodiment 1D1. The method of Method Embodiment 1D, wherein said rural category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of 4 dBm but less than or equal to 7 dBm; wherein said suburban category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of greater than 7 dBm but less than or equal to 10 dBm; wherein said urban category includes any areas or locations having clutter (e.g., terrain such as for example trees, rocks, mountains, hills, shrubs, crops, plants, lakes, rivers, streams, etc. and infrastructure such as for example buildings, bridges, walls, railroads, canals) which is predicted or expected to have a signal fade margin consideration of greater than 10 dBm but less than or equal to 14 dBm.

Method Embodiment 1E. The method of Method Embodiment 1D1, where signal fade margin is the difference between a radio receiver sensitivity and the actual signal level it receives measured in dBm and is expressed as the amount by which a signal level can decrease without causing system performance to drop below a predetermined (e.g., acceptable) threshold amount.

Method Embodiment 1F. The method of Method Embodiment 1D, wherein the geographical information includes clutter information for the coverage area of the first wireless base station, said clutter information including information identifying types of clutter located within the coverage area (e.g., urban clutter type, urban streets clutter type, urban highways clutter type, open-non-vegetated clutter type, commercial-industrial clutter type, grassland-agriculture clutter type, forested clutter type, residential with trees clutter type, inland water clutter type) and an amount of the coverage area corresponding to each type of clutter located in the coverage area.

Method Embodiment 1G. The method of Method Embodiment 1F, wherein the amount of the coverage area corresponding to each type of clutter located in the coverage area is expressed as a percentage for each type of clutter with respect to the total coverage area (e.g., the total coverage area includes 15% type 1 clutter, 20% type 2 clutter, 65% type 3 clutter).

Method Embodiment 1H. The method of Method Embodiment 1F, wherein the amount of the coverage area corresponding to each type of clutter located in the coverage area is determined by combining for each type of clutter the size of each portion of the coverage area classified as being of that clutter type, said coverage area including one or more portions (typically of equal size), each portion being classified as being a particular clutter type (e.g., residential) of a set of clutter types (e.g., set of clutter types including the categories of the Individual Location Longely-Rice (ILLR) clutter categories/types which include the following clutter types: Open land (ILLR clutter category number 1), Agricultural (ILLR clutter category number 2), Rangeland (ILLR clutter category number 3), Water (ILLR clutter category number 4), Forest Land (ILLR clutter category number 5), Wetland (ILLR clutter category number 6), Residential (ILLR clutter category number 7), Mixed urban/buildings (ILLR clutter category number 8), Commercial/Industrial (ILLR clutter category number 9), Snow & ice (ILLR clutter category number 10)).

Method Embodiment 2. The method of Method Embodiment 1, wherein said determining the wireless base station type for the first wireless base station based on geographical information corresponding to the coverage area of the first wireless base station includes: determining the wireless base station type from a set of wireless base station types, said set of wireless base station types including the following types: urban type, suburban type and rural type.

Method Embodiment 2A. The method of Method Embodiment 1, wherein said determining the wireless base station type for the first wireless base station based on geographical information corresponding to the coverage area of the first wireless base station includes: determining the wireless base station type from a set of wireless base station types, said set of wireless base station types including the following types: urban with predominately outdoor users type, urban with predominately indoor users type, suburban with predominately outdoor users type, suburban with predominately indoor users type, and rural with predominately outdoor users type, rural with predominately indoor users type.

Method Embodiment 2B. The method of Method Embodiment 2A, wherein determining the wireless base station type for the first wireless base station is further based on wireless device information corresponding to the coverage area of the first wireless base station.

Method Embodiment 2C. The method of Method Embodiment 2B, wherein said wireless device information corresponding to the coverage area of the first wireless base station includes wireless device location information for wireless devices serviced by the first wireless base station; the method further comprising: collecting wireless device location information for the wireless devices (e.g., UEs) being serviced by the first wireless device; determining from the collected wireless device information whether the highest number of the wireless devices (e.g., UEs) being serviced by the first wireless base station within the first wireless base station coverage area are located at locations of the first wireless base station coverage area classified as urban, suburban, or rural; subsequent to determining from the collected wireless device information that highest number of the wireless devices (e.g., UEs) being serviced by the first wireless base station within the first wireless base station coverage area are located at locations of the first wireless base station coverage area classified as urban, determining from the collected wireless device information whether a majority of said highest number of wireless devices located in a coverage area classified as urban are located at locations which are indicated as being within a building; subsequent to determining from the collected wireless device information that the highest number of wireless devices (e.g., UEs) being serviced by the first wireless base station within the first wireless base station coverage area are located at locations of the first wireless base station coverage area classified as suburban, determining from the collected wireless base station whether a majority of said highest number of wireless devices located in a coverage area classified as suburban are located at locations which are indicated as being within a building; subsequent to determining from the collected wireless device information that the highest number of the wireless devices (e.g., UEs) being serviced by the first wireless base station within the first wireless base station coverage area are located at locations of the first wireless base station coverage area classified as rural, determining from the collected wireless base station whether a majority of said highest number of wireless devices located in a coverage area classified as rural are located at locations which are indicated as being within a building

Method Embodiment 2D. The method of Method Embodiment 2C, wherein said urban with predominately outdoor users wireless base station type corresponds to a base station with a coverage area wherein a majority of the highest number of wireless devices (e.g., UEs) being serviced by the wireless base station are located in an urban area and are not located within one or more buildings; wherein said urban with predominately indoor users wireless base station type corresponds to a base station with a coverage area wherein a majority of the highest number of wireless devices (e.g., UEs) being serviced by the wireless base station are located in an urban area and are located within one or more buildings; wherein suburban with predominately outdoor users wireless base station type corresponds to a base station with a coverage area wherein a majority of the highest number of wireless devices (e.g., UEs) being serviced by the wireless base station are located in a suburban area and are not located within one or more buildings; wherein suburban with predominately indoor users wireless base station type corresponds to a base station with a coverage area wherein a majority of the highest number of wireless devices (e.g., UEs) being serviced by the wireless base station are located in a suburban area and are located within one or more buildings; wherein rural with predominately outdoor users wireless base station type corresponds to a base station with a coverage area wherein a majority of the highest number of wireless devices (e.g., UEs) being serviced by the wireless base station are located in a rural area and are not located within one or more buildings; wherein rural with predominately indoor users wireless base station type corresponds to a base station with a coverage area wherein a majority of the highest number of wireless devices (e.g., UEs) being serviced by the wireless base station are located in a rural area and are located within one or more buildings.

Method Embodiment 3. The method of Method Embodiment 2, wherein said geographical information includes: (i) geographical information corresponding to a location of the first wireless base station, (ii) clutter type information corresponding to coverage area of the first wireless base station; and (iii) geographical information corresponding to locations of user equipment devices within the coverage area of the first wireless base station.

Method Embodiment 3A. The method of Method Embodiment 3, wherein the geographical information corresponding to locations of user equipment devices within the coverage area of the first wireless base includes information on user equipment devices being located indoors (e.g., within a building) or being located outdoors (e.g., not being located within a building).

Method Embodiment 4. The method of Method Embodiment 3, wherein said determining a wireless base station type for a first wireless base station is further based on one or more of the following: (i) population density information of user equipment devices within the coverage area of the wireless base station categorized by clutter type (e.g., urban, suburban, rural); (ii) movement information of the user equipment devices (e.g., user equipment devices entry into the first wireless base station coverage area, movement within the coverage area of the first wireless base station, and exit from the coverage area of the first wireless base station along with the types of areas (e.g., urban, suburban, rural the user equipment devices are moving between), (iii) bandwidth usage information for the user equipment devices for a first period of time (e.g., categorized by area type in which the user equipment device is operating), (iv) percentage of wireless traffic (e.g., uplink, downlink or combined uplink and downlink traffic) of the wireless base station corresponding to user equipment devices by location (e.g., area in which user equipment devices are operating) for a period of time; and (v) base station coverage area signal strength information for the first wireless base station by location (e.g., Synchronization Signal-Reference Signal Received Power (RSRP) measurements as reported by user equipment devices).

Method Embodiment 5. The method of Method Embodiment 4, wherein said determining the wireless base station type from a set of wireless base station types includes: determining a numerical base station type score for each of the wireless base station types in the set of wireless base stations based on features corresponding to the first wireless base station and/or the first wireless base station's coverage area.

Method Embodiment 6. The method of Method Embodiment 1, wherein the set of operational configuration parameters include one or more of the following: base station transmit power levels, user equipment device transmit power levels, cell reselection parameters, handover parameters, and wireless base station antenna tilt parameters; and wherein the wireless base station antenna tilt parameters include determining the tilt of the antenna of the first wireless base station base on clutter information, user equipment device population density distribution in the coverage area of the first wireless base station, and base station signal coverage information.

Method Embodiment 7. The method of each of the above Method Embodiments, wherein the first wireless base station is part of a first wireless network including a plurality of wireless base stations and an Operations Support Systems (OSS) and/or a Network Management System; wherein said determining a wireless base station type for a wireless base station is performed by the OSS and/or the Network Management System; wherein said determining a set of operational configuration parameters for the first wireless base station based on the determined wireless base station type is performed by the OSS and/or the Network Management System; and wherein said configuring the first wireless base station using said determined set of operational configuration parameters is performed by the OSS and/or the Network Management System.

### LIST OF EXEMPLARY NUMBERED SYSTEM EMBODIMENTS

System Embodiment 1. A system comprising: memory; and a network management server, said network management server including a first processor that controls the network management server to perform the following operations: determining a wireless base station type for a first wireless base station based on geographical information corresponding to a coverage area of the first wireless base station; determining a set of operational configuration parameters for the first wireless base station based on the determined wireless base station type; and configuring the first wireless base station using said determined set of operational configuration parameters.

System Embodiment 2. The system of System Embodiment 1, wherein said geographical information includes clutter information corresponding to the coverage area of the first wireless base station, said clutter information including terrain information (e.g., elevation and type of terrain such open land, dessert, forest, trees, vegetation, water bodies (e.g., rivers, lakes, streams, ocean), farmland, cliffs, rangeland, snow, ice, etc.) and infrastructure information (e.g., information (e.g., dimensions and/or materials from which infrastructure constructed) on buildings, water towers, bridges, dams, canals, walls, roads, highways, street lamps, etc. located in the coverage area).

System Embodiment 3. The system of System Embodiment 1, wherein said geographical information includes clutter information corresponding to the coverage area of the first wireless base station, said clutter information including information identifying different locations within the coverage area (e.g., different portions of the coverage area) as corresponding to a particular clutter type from a plurality of clutter types; and wherein said determining a wireless base station type for a first wireless base station based on geographical information corresponding to the coverage area of the first wireless base station includes: using the information identifying different locations within the coverage area as corresponding to a particular clutter type from a plurality of clutter types to determine the wireless base station type from a set of wireless base station types.

System Embodiment 4. The system of System Embodiment 2, wherein said determining a wireless base station type for a first wireless base station based on geographical information corresponding to a coverage area of the first wireless base station includes: categorizing the coverage area of the first wireless base station based on the geographical information corresponding to the coverage area of the first wireless base station; and determining the first wireless base station type based on the results of the categorization of the coverage area of the first wireless base station.

System Embodiment 5. The system of System Embodiment 4, wherein categorizing the coverage area of the first wireless base station based on geographical information corresponding to the coverage area of the first wireless base station includes: determining a category from a set of categories to which the coverage area of the first wireless base station belongs, said set of categories including: urban category, suburban category, and rural category.

System Embodiment 6. The system of System Embodiment 1, wherein said determining the wireless base station type for the first wireless base station based on geographical information corresponding to the coverage area of the first wireless base station includes: determining the wireless base station type from a set of wireless base station types, said set of wireless base station types including the following types: urban type, suburban type and rural type.

System Embodiment 7. The system of System Embodiment 2, wherein said determining the wireless base station type for the first wireless base station is further based on wireless device information corresponding to the coverage area of the first wireless base station, said wireless device information including location information identifying the location of wireless devices within the coverage area of the first wireless base station.

System Embodiment 8. The system of System Embodiment 7, wherein said determining the wireless base station type for the first wireless base station based on wireless device information corresponding to the coverage area of the first wireless base station includes: (i) determining a percentage or a number of wireless devices being serviced by the first wireless base station that are located inside of a building; and (ii) determining a percentage or a number of the wireless devices being serviced by the first wireless base station which are not located within a building.

System Embodiment 9. The system of System Embodiment 8, wherein said determining the wireless base station type for the first wireless base station based on geographical information corresponding to the coverage area of the first wireless base station and further based on wireless device information includes: determining the wireless base station type from a set of wireless base station types, said set of wireless base station types including the following types: urban with predominately outdoor users type, urban with predominately indoor users type, suburban with predominately outdoor users type, suburban with predominately indoor users type, rural with predominately outdoor users type, and rural with predominately indoor users type.

System Embodiment 10. The system of System Embodiment 9, wherein said urban with predominately outdoor users wireless base station type corresponds to a base station with a coverage area wherein a majority of the highest number of wireless devices (e.g., UEs) being serviced by the wireless base station are located in an urban area and are not located within one or more buildings; wherein said urban with predominately indoor users wireless base station type corresponds to a base station with a coverage area wherein a majority of the highest number of wireless devices (e.g., UEs) being serviced by the wireless base station are located in an urban area and are located within one or more buildings; wherein suburban with predominately outdoor users wireless base station type corresponds to a base station with a coverage area wherein a majority of the highest number of wireless devices (e.g., UEs) being serviced by the wireless base station are located in a suburban area and are not located within one or more buildings; wherein suburban with predominately indoor users wireless base station type corresponds to a base station with a coverage area wherein a majority of the highest number of wireless devices (e.g., UEs) being serviced by the wireless base station are located in a suburban area and are located within one or more buildings; wherein rural with predominately outdoor users wireless base station type corresponds to a base station with a coverage area wherein a majority of the highest number of wireless devices (e.g., UEs) being serviced by the wireless base station are located in a rural area and are not located within one or more buildings; wherein rural with predominately indoor users wireless base station type corresponds to a base station with a coverage area wherein a majority of the highest number of wireless devices (e.g., UEs) being serviced by the wireless base station are located in a rural area and are located within one or more buildings.

System Embodiment 11. The system of System Embodiment 1, wherein the determined set of operational configuration parameters include one or more of the following: maximum base station transmit power level parameter, a maximum user equipment device transmit power level parameter, cell reselection parameters, handover parameters, and a wireless base station antenna tilt parameter; and wherein said determining a set of operational configuration parameters for the first wireless base station based on the determined wireless base station type includes determining the set of operational configuration parameters from a plurality of sets of operational configuration parameters.

System Embodiment 12. The system of System Embodiment 11, wherein the determined set of operational configuration parameters includes at least: handover parameters, said handover parameters including a hysteresis value, a minimum signal strength value, and a signal offset value; wherein configuring the first wireless base station using said determined set of operational configuration parameters includes: sending a message to the first wireless base station indicating the first wireless base station is to operate using the determined set of operational configuration parameters.

### LIST OF EXEMPLARY NUMBERED NON-TRANSITORY COMPUTER READABLE MEDIUM EMBODIMENTS

Non-transitory Computer Readable Medium Embodiment 1. A non-transitory computer readable medium including a first set of computer executable instructions which when executed by a processor of a system cause the system to perform the steps of: determining a wireless base station type for a first wireless base station based on geographical information corresponding to a coverage area of the first wireless base station; determining a set of operational configuration parameters for the first wireless base station based on the determined wireless base station type; and configuring the first wireless base station using said determined set of operational configuration parameters.

The techniques of various embodiments may be implemented using software, hardware and/or a combination of software and hardware. Various embodiments are directed to apparatus, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements. Various embodiments are also directed to methods, e.g., method of controlling and/or operating wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements described herein are implemented using one or more components to perform the steps corresponding to one or more methods, for example, generating or creating messages, configuring wireless base stations, collecting information, generating performance metrics, message reception, message transmission, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements are configured to perform the steps of the methods described as being performed by the wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements, with a processor which includes a component corresponding to each of the steps of the various described methods performed by the device in which the processor is included. In some but not all embodiments a device, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a wireless base stations, wireless devices, mobile terminals, network equipment, eNBs, gNBs, CBSDs, smart devices, user equipment devices, user devices, computers, smartphones, subscriber devices, core network systems, OSS, network management systems, planning and geodata servers, statistical calculation servers, performance parameter application server, performance data feedback collector server, decision tree servers, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
determining a wireless base station type for a first wireless base station based on geographical information corresponding to a coverage area of the first wireless base station;
determining a set of operational configuration parameters for the first wireless base station based on the determined wireless base station type; and
configuring the first wireless base station using said determined set of operational configuration parameters.

2. The method of claim 1, wherein said geographical information includes clutter information corresponding to the coverage area of the first wireless base station, said clutter information including terrain information.

3. The method of claim 1, wherein said geographical information includes clutter information corresponding to the coverage area of the first wireless base station, said clutter information including information identifying different locations within the coverage area as corresponding to a particular clutter type from a plurality of clutter types; and
wherein determining a wireless base station type for a first wireless base station based on geographical information corresponding to the coverage area of the first wireless base station includes:
using the information identifying different locations within the coverage area as corresponding to a particular clutter type from a plurality of clutter types to determine the wireless base station type from a set of wireless base station types.

4. The method of claim 2, wherein said determining a wireless base station type for a first wireless base station based on geographical information corresponding to a coverage area of the first wireless base station includes:
categorizing the coverage area of the first wireless base station based on the geographical information corresponding to the coverage area of the first wireless base station; and
determining the first wireless base station type based on the results of the categorization of the coverage area of the first wireless base station.

5. The method of claim 4, wherein categorizing the coverage area of the first wireless base station based on geographical information corresponding to the coverage area of the first wireless base station includes: determining a category from a set of categories to which the coverage area of the first wireless base station belongs, said set of categories including: urban category, suburban category, and rural category.

6. The method of claim 1, wherein said determining the wireless base station type for the first wireless base station based on geographical information corresponding to the coverage area of the first wireless base station includes: determining the wireless base station type from a set of wireless base station types, said set of wireless base station types including the following types: urban type, suburban type and rural type.

7. The method of claim 2, wherein determining the wireless base station type for the first wireless base station is further based on wireless device information corresponding to the coverage area of the first wireless base station, said wireless device information including location information identifying the location of wireless devices within the coverage area of the first wireless base station.

8. The method of claim 7, wherein said determining the wireless base station type for the first wireless base station based on wireless device information corresponding to the coverage area of the first wireless base station includes: (i) determining a percentage or a number of wireless devices being serviced by the first wireless base station that are located inside of a building; and (ii) determining a percentage or a number of the wireless devices being serviced by the first wireless base station which are not located within a building.

9. The method of claim 8, wherein said determining the wireless base station type for the first wireless base station based on geographical information corresponding to the coverage area of the first wireless base station and further based on wireless device information includes: determining the wireless base station type from a set of wireless base station types, said set of wireless base station types including the following types: urban with predominately outdoor users type, urban with predominately indoor users type, suburban with predominately outdoor users type, suburban with predominately indoor users type, rural with predominately outdoor users type, and rural with predominately indoor users type.

10. The method of claim 9,
wherein said urban with predominately outdoor users wireless base station type corresponds to a base station with a coverage area wherein a majority of the highest number of wireless devices being serviced by the wireless base station are located in an urban area and are not located within one or more buildings;
wherein said urban with predominately indoor users wireless base station type corresponds to a base station with a coverage area wherein a majority of the highest number of wireless devices being serviced by the wireless base station are located in an urban area and are located within one or more buildings;
wherein said suburban with predominately outdoor users wireless base station type corresponds to a base station with a coverage area wherein a majority of the highest number of wireless devices being serviced by the wireless base station are located in a suburban area and are not located within one or more buildings;
wherein said suburban with predominately indoor users wireless base station type corresponds to a base station with a coverage area wherein a majority of the highest number of wireless devices being serviced by the wireless base station are located in a suburban area and are located within one or more buildings;
wherein said rural with predominately outdoor users wireless base station type corresponds to a base station with a coverage area wherein a majority of the highest number of wireless devices being serviced by the wireless base station are located in a rural area and are not located within one or more buildings; and
wherein said rural with predominately indoor users wireless base station type corresponds to a base station with a coverage area wherein a majority of the highest number of wireless devices being serviced by the wireless base station are located in a rural area and are located within one or more buildings.

11. The method of claim 1,
wherein the determined set of operational configuration parameters include one or more of the following: maximum base station transmit power level parameter, a maximum user equipment device transmit power level parameter, cell reselection parameters, handover parameters, and a wireless base station antenna tilt parameter; and
wherein said determining a set of operational configuration parameters for the first wireless base station based on the determined wireless base station type includes determining the set of operational configuration parameters from a plurality of sets of operational configuration parameters.

12. The method of claim 11,
wherein the determined set of operational configuration parameters includes at least: handover parameters, said handover parameters including a hysteresis value, a minimum signal strength value, and a signal offset value;
wherein configuring the first wireless base station using said determined set of operational configuration parameters includes: sending a message to the first wireless base station indicating the first wireless base station is to operate using the determined set of operational configuration parameters.

13. A system comprising:
memory; and
a network management server, said network management server including a first processor that controls the network management server to perform the following operations:
determining a wireless base station type for a first wireless base station based on geographical information corresponding to a coverage area of the first wireless base station;
determining a set of operational configuration parameters for the first wireless base station based on the determined wireless base station type; and
configuring the first wireless base station using said determined set of operational configuration parameters.

14. The system of claim 13, wherein said geographical information includes clutter information corresponding to the coverage area of the first wireless base station, said clutter information including terrain information.

15. The system of claim 14, wherein said determining a wireless base station type for a first wireless base station based on geographical information corresponding to a coverage area of the first wireless base station includes:
categorizing the coverage area of the first wireless base station based on the geographical information corresponding to the coverage area of the first wireless base station; and
determining the first wireless base station type based on the results of the categorization of the coverage area of the first wireless base station.

16. The system of claim 1, wherein said determining the wireless base station type for the first wireless base station based on geographical information corresponding to the coverage area of the first wireless base station includes: determining the wireless base station type from a set of wireless base station types, said set of wireless base station types including the following types: urban type, suburban type and rural type.

17. The system of claim 14, wherein determining the wireless base station type for the first wireless base station is further based on wireless device information corresponding to the coverage area of the first wireless base station, said wireless device information including location information identifying the location of wireless devices within the coverage area of the first wireless base station.

18. The system of claim 17, wherein said determining the wireless base station type for the first wireless base station based on wireless device information corresponding to the coverage area of the first wireless base station includes: (i) determining a percentage or a number of wireless devices being serviced by the first wireless base station that are located inside of a building; and (ii) determining a percentage or a number of the wireless devices being serviced by the first wireless base station which are not located within a building.

19. The system of claim 18, wherein said determining the wireless base station type for the first wireless base station based on geographical information corresponding to the coverage area of the first wireless base station and further based on wireless device information includes: determining the wireless base station type from a set of wireless base station types, said set of wireless base station types including the following types: urban with predominately outdoor users type, urban with predominately indoor users type, suburban with predominately outdoor users type, suburban with predominately indoor users type, rural with predominately outdoor users type, and rural with predominately indoor users type.

20. A non-transitory computer readable medium including a first set of computer executable instructions which when executed by a processor of a system cause the system to perform the steps of:
determining a wireless base station type for a first wireless base station based on geographical information corresponding to a coverage area of the first wireless base station;
determining a set of operational configuration parameters for the first wireless base station based on the determined wireless base station type; and
configuring the first wireless base station using said determined set of operational configuration parameters.
